(19) United States
(12) Patent Application Publication
(10) Pub. No.: US 2025/0117932 A1
(43) Pub. Date: Apr. 10, 2025

(54) FEATURE PYRAMIDING FOR IN SITU DATA VISUALIZATIONS (AKA DYNAMIC DISPLAY OF MOLECULAR INFORMATION DEPENDENT ON ZOOM LEVEL)

(71) Applicant: 10x Genomics, Inc., Pleasanton, CA (US)

(72) Inventors: Jeffrey Mellen, Martinez, CA (US); Jeffrey Peck, West Hartford, CT (US); Edward Jaesung Kim DePuy, Berkeley, CA (US); Andreas Girgensohn, Palo Alto, CA (US); Paul Ryvkin, San Francisco, CA (US); Elijah Roberts, Pleasanton, CA (US)

(21) Appl. No.: 18/907,230

(22) Filed: Oct. 4, 2024

Related U.S. Application Data
(60) Provisional application No. 63/542,976, filed on Oct. 6, 2023.

(51) Int. Cl. G06T 7/00

(52) U.S. Cl. CPC G06T 7/0012; G06T 2207/10028; G06T 2207/10148; G06T 2207/20016

(57) ABSTRACT

Feature pyramiding for in situ data visualizations is provided. In various embodiments, a point cloud is loaded. Each point within the point cloud represents a feature of a biological sample at its corresponding location. At least one tile is determined having a two-dimensional area and a zoom level. Those points having a location within the two-dimensional area are selected from the point cloud. Based on the selected points and the zoom level, a set of display points is determined, each point of the set of display point representing a feature of the biological sample at its corresponding location. The set of display points is provided for display at the zoom level.

### CROSS-REFERENCE TO RELATED APPLICATIONS

This application claims the benefit of U.S. Provisional Application No. 63/542,976, filed Oct. 6, 2023, which is hereby incorporated by reference in its entirety.

### FIELD

The present disclosure is directed to in situ visualization tools for feature data acquired from samples. The visualization tools set out herein may be used for in situ data (e.g., morphological data, nucleic acid data, protein data) generated by microscopic and immunohistochemical techniques, hybridization methods (e.g., hybridizing padlock probes with rolling circle amplification) or sequencing methods (e.g., SBS, SBL, SBB, SBH). In situ data (nucleic acid data, protein data) generated by hybridization methods (e.g., hybridizing padlock probes with rolling circle amplification) or sequencing methods (e.g., SBS, SBL, SBB, SBH). The visualization tools described herein may be used in combination with various optofluidic instruments.

### BACKGROUND

In situ detection and analysis methods are emerging from the rapidly developing field of spatial transcriptomics. The key objectives in spatial transcriptomics are to detect, quantify, and map gene activity to specific regions in a tissue sample at cellular or sub-cellular resolution. These techniques allow one to study the subcellular distribution of gene activity (as evidenced, e.g., by expressed gene transcripts), and have the potential to provide crucial insights in the fields of developmental biology, oncology, immunology, histology, etc.

For example, without being bound by theory or methodology, in situ detection and decoding is a process comprising a plurality of decoding cycles in each of which a different set of barcode probes (e.g., fluorescently-labeled oligonucleotides) is contacted with target analytes (e.g., mRNA sequences) or with target barcodes (e.g., nucleic acid barcodes) associated with the target analytes present in a sample (e.g., a tissue sample) under conditions that promote hybridization. One or more images (e.g., fluorescence images) are acquired in each decoding cycle, and the images are processed to detect the presence and locations of one or more barcode probes in each cycle. The presence and locations of one or more target analyte sequences or associated barcode sequences are then inferred from corresponding code words that are determined based on the set of, e.g., fluorescence signals detected in each decoding cycle of the decoding process.

However, tools for viewing of the large volumes of data resulting from such processes have yet to allow for interactive exploration of data overlays, representing quantitative and qualitative information, atop of images (e.g., micrographs) representing the morphological structure of the underlying biological sample. Thus, there remains an unmet need for tools and mechanisms that facilitate and accelerate user interaction with acquired data, allowing the user to navigate the extremely complex and detailed results of in situ experiments.

### SUMMARY

Aspects of the invention as provided herein include methods comprising loading a point cloud, each point within the point cloud representing a feature of a biological sample at its corresponding location; determining at least one tile having a two-dimensional area and a zoom level; selecting from the point cloud those points having a location within the two-dimensional area; based on the selected points and the zoom level, determining a set of display points, each point of the set of display points representing a feature of the biological sample at its corresponding location; providing the set of display points for display at the zoom level.

In some aspects of the invention, provided herein are systems comprising: a computing node comprising at least one computer-readable storage medium having program instructions stored thereon, the program instructions executable by at least one processor of the computing node to cause the at least one processor to perform a method comprising: loading a point cloud, each point within the point cloud representing a feature of a biological sample at its corresponding location; determining at least one tile having a two-dimensional area and a zoom level; selecting from the point cloud those points having a location within the two-dimensional area; based on the selected points and the zoom level, determining a set of display points, each point of the set of display points representing a feature of the biological sample at its corresponding location; and displaying, on a display, the set of display points at the zoom level.

In other aspects of the invention, provided herein are computer program products comprising a computer readable storage medium having program instructions embodied therewith, the program instructions executable by a processor to cause the processor to perform a method. Said methods may comprise loading a point cloud, each point within the point cloud representing a feature of a biological sample at its corresponding location; determining at least one tile having a two-dimensional area and a zoom level; selecting from the point cloud those points having a location within the two-dimensional area; based on the selected points and the zoom level, determining a set of display points, each point of the set of display points representing a feature of the biological sample at its corresponding location; displaying, on a display, the set of display points at the zoom level.

In various embodiments, a system is provided. The system may include an imaging instrument, an imaging database, and a computing node that includes at least one computer-readable storage medium having program instructions stored thereon. The program instructions may be executable by at least one processor of the computing node to cause the at least one processor to perform a method.

The system may further include a display.

In various embodiments, a computer program product that includes a computer readable storage medium having program instructions embodied therewith is provided. The program instructions may be executable by a processor to cause the processor to perform a method.

### BRIEF DESCRIPTION OF THE DRAWINGS

FIG. 1 depicts an overview of a volumetric sample imaging system and illustrates a Field of View (FOV) grid bounding the sample (e.g., hydrogel, tissue section, one or more cells, etc.) as projected onto the surface of a solid substrate supporting the sample.

FIG. 2 depicts the XZ cross-sectional view and illustrates the plurality of images in the Z dimension. The objective lens focal point is positioned to acquire an image at every Z-slice in a Z-stack. An XZ image of signal distribution within the imaging volume is shown (bottom).

FIG. 3 is an example workflow of image data acquisition from a biological sample (e.g., a cell or tissue sample) using an opto-fluidic instrument, according to various embodiments.

FIGS. 4A-4B illustrate cross-sectional views of an optics module in an imaging system, according to some embodiments.

FIG. 5 depicts a computing node according to some embodiments disclosed herein.

FIG. 6 is a flowchart illustrating a method of data visualization according to embodiments of the present disclosure.

FIG. 7 depicts an image pyramid containing a multiscale image progressively subsampled at different levels.

FIG. 8 illustrates the aggregation of data point attributes, wherein the data points within the circled region are subsampled or summarized to be a single point at the next zoom level.

FIG. 9 is a flowchart illustrating the data flow from image acquisition to the web-based viewer interface.

FIG. 10 is a view of an exemplary web-based viewer interface resulting from the data flow of FIG. 9.

FIG. 11 depicts a multi-resolution image viewer that allows for auto-levelling, uniform palette, colormaps, and preloading.

FIG. 12 shows overlays providing visualization of data features as icons (top left), ellipses (bottom left), and density/heat maps (right).

FIG. 13 depicts an exemplary visualization generated with a visualization tool disclosed herein.

FIG. 14 depicts a heat map of feature data density atop a morphological image as disclosed herein.

FIG. 15 depicts a zoomed-out image with nuclear locations represented as spots.

FIG. 16A depicts a plot of density of feature data per spatial bin, independent of cell boundaries. FIG. 16B depicts a density plot using individual markers where each icon/color combination representing a distinct gene.

FIGS. 17A-17B depict binned RNA counts per region over the same dataset, with different bin sizes.

FIG. 18 depicts an image of a biological sample wherein cells have been colored based on an attribute, where yellow is low and red is high.

FIG. 19 depicts the visualization of feature data filtered by the current focal plane (left), next to molecules on other focal planes with reduced opacity (right).

FIG. 20 depicts transcript visualization density in an image of a biological sample, wherein cells have been colored based on expression of CD24 transcript, comparing subsampling using algorithm A (left) and algorithm B (right).

FIG. 21 depicts transcript visualization density in an image of a tissue sample.

In the figures, elements and steps having the same or similar reference numeral have the same or similar attributes or description, unless explicitly stated otherwise. The patent or application file contains at least one drawing executed in color. Copies of this patent or patent application publication with color drawing(s) will be provided by the Office upon request and payment of the necessary fee.

### DETAILED DESCRIPTION

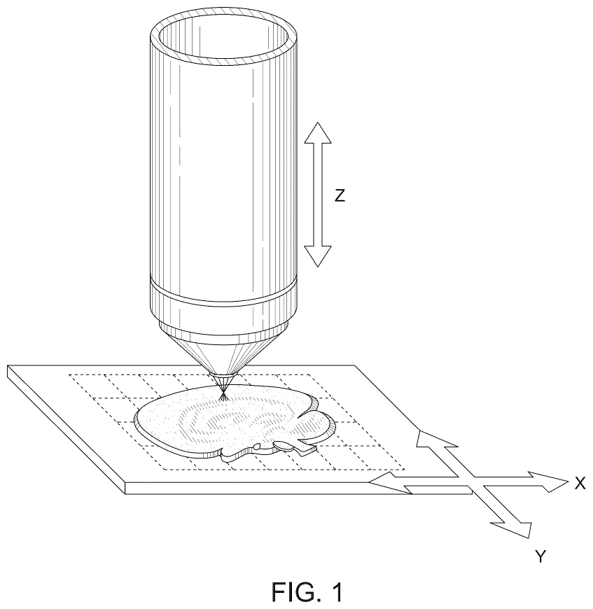

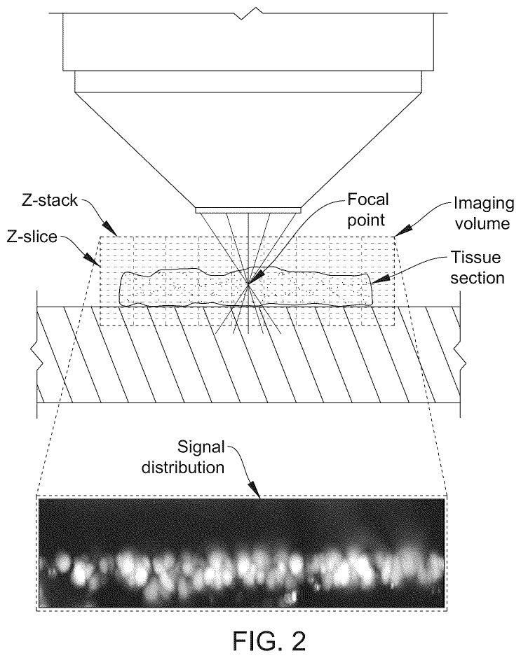

In volumetric sample imaging systems (e.g., an optofluidic instrument), a z-stack of images is obtained for each Field of View (FOV) of the objective (see FIG. 1), wherein the imaged regions contain target molecules, such as nucleic acids or proteins, and relevant feature data (e.g., morphologic and pathologic data) (see FIG. 2). The resulting datasets become exceeding large, comprising millions of data points and, therefore, become increasingly challenging to visualize for analysis.

Provided herein are approaches for representing features of in situ data (e.g., sequencing data, morphological data, and the like, typically acquired using microscopy-based methods from biological samples) that is scalable for up to any number of feature positions, by subsampling based on the current zoom level. Such an approach can be used to express hundreds of millions of points (whereas alternative approaches to statically load and render points is limited to 5 to 10 million points before it becomes unusable). The in-situ visualization application disclosed herein provides mechanisms that allow the end user to interactively explore data overlays, representing quantitative and qualitative information, atop the images representing the morphological structure of the underlying tissue sample.

For example, and without limitation, the in situ visualization tools disclosed herein may rely on cloud-hosted data storage, a server application that responds to web browser requests, and a client application that operates entirely within a web browser. In situ data may be accessed through an interactive visual interface, e.g., a standalone web browser, a desktop application, or an on-instrument interface.

The client application may first initiate a request to a running instance of the visualization server, by either entering a web address or clicking a link within a browser, or following a workflow within an instrument interface. The visualization server may then provide the browser with the client-side code to load. Depending on the parameters of the initial request, the server response may include settings or other information derived from the parameters, such as identifying information and the location of the desired dataset, the version of the client-side code to load, and other metadata. In some embodiments, the request is initiated to an application running on an instrument, or on a dedicated machine within an end-user's on-premise computing infrastructure.

Once the client-side code is loaded, the client may make requests to the visualization server for image resources, which may primarily be used to display microscopy-based morphological data. In some embodiments, images are stored in a pyramidal format, meaning that there are different files stored for different resolutions. These images may be stored in the cloud, or locally on a high-capacity computer, or within a shared networked filesystem. Said image resources may comprise multiple sets of images, each corresponding to a different wavelength, time interval, z-slice, or iteration of the in situ instrument's imaging cycle. Without being bound by theory and for exemplary purposes, these images can capture the presence or absence of proteins that can label cell boundaries, nuclear and cytoplasmic boundaries, the presence or absence of targeted proteins, or other morphological or fine-grained molecular information. In some embodiments, the image data can be 8-bit or 16-bit single channel, or 8 bpp/16 bpp multichannel RGBA images. In some embodiments, images can be stored natively in TIFF or other image formats.

In addition to underlying image data, the client application may make requests for the files that will drive data overlays atop the morphological data. For example and without limitation, such data may include quantitative per-cell information, such as the number of molecules per gene per cell, cluster membership information, per-cell protein or other gene marker statistics, cell type identification, morphological tissue boundaries, and more. Said data may also be stored in a pyramidal format to allow the client to selectively load information for a small subset of the active dataset, or as complete tracks for the entire experiment. The server and client application transform the data from its at-rest format in storage to an in-memory format suitable for the visualization tools, such as arrays of colors, polygons, or shading parameters. The visualization user interface may then be used to control, for example, which overlays are active, tuning of said overlays, and allow a user to more easily explore and characterize phenomena found in the in situ data.

### General Terminology

Specific terminology is used throughout this disclosure to explain various aspects of the methods, systems, and compositions that are described. Unless otherwise defined, all of the technical terms used herein have the same meaning as commonly understood by one of ordinary skill in the art in the field to which this disclosure belongs.

As used in this specification and the appended claims, the singular forms “a”, “an”, and “the” include plural references unless the context clearly dictates otherwise. For example, “a” or “an” means “at least one” or “one or more”. Any reference to “or” herein is intended to encompass “and/or” unless otherwise stated.

As used herein, the terms “comprising” (and any form or variant of comprising, such as “comprise” and “comprises”), “having” (and any form or variant of having, such as “have” and “has”), “including” (and any form or variant of including, such as “includes” and “include”), or “containing” (and any form or variant of containing, such as “contains” and “contain”), are inclusive or open-ended and do not exclude additional, un-recited additives, components, integers, elements or method steps.

As used herein, the term “about” a number refers to that number plus or minus 10% of that number. The term ‘about’ when used in the context of a range refers to that range minus 10% of its lowest value and plus 10% of its greatest value.

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Similarly, use of a), b), etc., or i), ii), etc. does not by itself connote any priority, precedence, or order of steps in the claims. Similarly, the use of these terms in the specification does not by itself connote any required priority, precedence, or order.

The term “platform” (or “system”) may refer to an ensemble of: (i) instruments (e.g., imaging instruments, fluid controllers, temperature controllers, motion controllers and translation stages, etc.), (ii) devices (e.g., specimen slides, substrates, flow cells, microfluidic devices, etc., which may comprise fixed and/or removable or disposable components of the platform), (iii) reagents and/or reagent kits, and (iv) software, or any combination thereof, which allows a user to perform one or more bioassay methods (e.g., analyte detection, in situ detection or sequencing, and/or nucleic acid detection or sequencing) depending on the particular combination of instruments, devices, reagents, reagent kits, and/or software utilized. As used herein, the term sequencing may include sequencing by synthesis (SBS), sequencing by hybridization (SBH), sequencing by ligation (SBL), sequencing by binding (SBB), and/or any other type of sequencing. SBS may be a DNA sequencing technique in which fluorescently labeled nucleotides are used to sequence clusters on a flow cell surface. SBH may be a DNA sequencing technique in which sets of oligonucleotides are hybridized under conditions that allow detection of complementary sequences in the target nucleic acid. SBL may be a DNA sequencing technique that uses the enzyme DNA ligase to identify the nucleotide present at a given position in a DNA sequence. SBB may be a DNA sequencing technique that involves the examination of a ternary complex that forms between a primer-template nucleic acid hybrid, polymerase and nucleotide triphosphate and acquiring signal that is used to determine nucleic acid base identity without the need for nucleotide incorporation.

The section headings used herein are for organizational purposes only and are not to be construed as limiting the subject matter described.

### Barcoding and Decoding Terminology

A “barcode” is a label, or identifier, that conveys or is capable of conveying information (e.g., information about an analyte in a sample, a cell, a bead, a location, a sample, and/or a capture probe). The term “barcode” may refer either to a physical barcode molecule (e.g., a nucleic acid barcode molecule) or to its representation in a computer-readable, digital format (e.g., as a string of characters representing the sequence of bases in a nucleic acid barcode molecule).

The phrase “barcode diversity” refers to the total number of unique barcode sequences that may be represented by a given set of barcodes.

A physical barcode molecule (e.g., a nucleic acid barcode molecule) that forms a label or identifier as described above. In some instances, a barcode can be part of an analyte, can be independent of an analyte, can be attached to an analyte, or can be attached to or part of a probe that targets the analyte. In some instances, a particular barcode can be unique relative to other barcodes.

Physical barcodes can have a variety of different formats. For example, barcodes can include polynucleotide barcodes, random nucleic acid and/or amino acid sequences, and synthetic nucleic acid and/or amino acid sequences. A physical barcode can be attached to an analyte, or to another moiety or structure, in a reversible or irreversible manner. A physical barcode can be added to, for example, a fragment of a deoxyribonucleic acid (DNA) or ribonucleic acid (RNA) sample before or during sequencing of the sample. In some instances, barcodes can allow for identification and/or quantification of individual sequencing-reads in sequencing-based methods (e.g., a barcode can be or can include a unique molecular identifier or “UMI”). Barcodes can be used to detect and spatially-resolve molecular components found in biological samples, for example, at single-cell resolution (e.g., a barcode can be, or can include, a molecular barcode, a spatial barcode, a unique molecular identifier (UMI), etc.).

In some instances, barcodes may comprise a series of two or more segments or sub-barcodes (e.g., corresponding to “letters” or “code words” in a decoded barcode), each of which may comprise one or more of the subunits or building blocks used to synthesize the physical (e.g., nucleic acid) barcode molecules. For example, a nucleic acid barcode molecule may comprise two or more barcode segments, each of which comprises one or more nucleotides. In some instances, a barcode may comprise at least 1, 2, 3, 4, 5, 6, 7, 8, 9, 10, or more than 10 segments. In some instances, each segment of a barcode molecule may comprise at least 1, 2, 3, 4, 5, 6, 7, 8, 9, 10, 12, 14, 16, 18, 20, or more than 20 subunits or building blocks. For example, each segment of a nucleic acid barcode molecule may comprise at least 1, 2, 3, 4, 5, 6, 7, 8, 9, 10, 12, 14, 16, 18, 20, or more than 20 nucleotides. In some instances, two or more of the segments of a barcode may be separated by non-barcode segments, i.e., the segments of a barcode molecule need not be contiguous.

A “digital barcode” (or “digital barcode sequence”) is a representation of a corresponding physical barcode (or target analyte sequence) in a computer-readable, digital format as described above. A digital barcode may comprise one or more “letters” (e.g., 1, 2, 3, 4, 5, 6, 7, 8, 9, 10, 12, 14, 16, 18, 20, or more than 20 letters) or one or more “code words” (e.g., 1, 2, 3, 4, 5, 6, 7, 8, 9, 10, or more than 10 code words), where a “code word” comprises, e.g., 1, 2, 3, 4, 5, 6, 7, 8, 9, 10, 12, 14, 16, 18, 20, or more than 20 letters. In some instances, the sequence of letters or code words in a digital barcode sequence may correspond directly with the sequence of building blocks (e.g., nucleotides) in a physical barcode. In some instances, the sequence of letters or code words in a digital barcode sequence may not correspond directly with the sequence of building blocks in a physical barcode, but rather may comprise, e.g., arbitrary code words that each correspond to a segment of a physical barcode. For example, in some instances, the disclosed methods for decoding and error correction may be applied directly to detecting target analyte sequences (e.g., mRNA sequences) as opposed to detecting target barcodes, and the barcode probes used to detect the target analyte sequences may correspond to letters or code words that have been assigned to specific target analyte sequences but that do not directly correspond to the target analyte sequences.

A “designed barcode” (or “designed barcode sequence”) is a barcode (or its digital equivalent; in some instances a designed barcode may comprise a series of code words that can be assigned to gene transcripts and subsequently decoded into a decoded barcode) that meets a specified set of design criteria as required for a specific application. In some instances, a set of designed barcodes may comprise at least 2, at least 5, at least 10, at least 20, at least 40, at least 60, at least 80, at least 100, at least 200, at least 400, at least 600, at least 800, at least 1,000, at least 2,000, at least 4,000, at least 6,000, at least 8,000, at least 10,000, at least 20,000, at least 40,000, at least 60,000, at least 80,000, at least 100,000, at least 200,000, at least 400,000, at least 600,000, at least 800,000, at least 1,000,000, at least 2×10⁶, at least 3×10⁶, at least 4×10⁶, at least 5×10⁶, at least 6×10⁶, at least 7×10⁶, at least 8×10⁶, at least 9×10⁶, at least 107, at least 10⁸, at least 10⁹, or more than 10⁹ unique barcodes. In some instances, a set of designed barcodes may comprise any number of designed barcodes within the range of values in this paragraph, e.g., 1,225 unique barcodes or 2.38×10⁶ unique barcodes. As noted above for barcodes in general, in some instances designed barcodes may comprise two or more segments (corresponding to two or more code words in a decode barcode). In those cases, the specified set of design criteria may be applied to the designed barcodes as a whole, or to one or more segments (or positions) within the designed barcodes.

A “decoded barcode” (or “decoded barcode sequence”) is a digital barcode sequence generated via a decoding process that ideally matches a designed barcode sequence, but that may include errors arising from noise in the synthesis process used to create barcodes and/or noise in the decoding process itself. As noted above, in some instances, the disclosed methods for decoding and error correction may be applied directly to detecting target analytes (e.g., mRNA sequences) as opposed to detecting target barcodes, and the barcode probes used to detect the target analytes may correspond to letters or code words that have been assigned to specific target analytes but that do not directly correspond to the target analytes. In these instances, a decoded barcode (i.e., a series of letters or code words) may serve as a proxy for the target analyte.

A “corrected barcode” (or “corrected barcode sequence”) is a digital barcode sequence derived from a decoded barcode sequence by applying one or more error correction methods.

### Probe Terminology

The term “probe” may refer either to a physical probe molecule (e.g., a nucleic acid probe molecule) or to its representation in a computer-readable, digital format (e.g., as a string of characters representing the sequence of bases in a nucleic acid probe molecule). A “probe” may be, for example, a molecule designed to recognize (and bind or hybridize to) another molecule, e.g., a target analyte, another probe molecule, etc.

In some instances, a physical probe molecule may comprise one or more of the following: (i) a target recognition element (e.g., an antibody capable of recognizing and binding to a target peptide, protein, or small molecule; an oligonucleotide sequence that is complementary to a target gene sequence or gene transcript; or a poly-T oligonucleotide sequence that is complementary to the poly-A tails on messenger RNA molecules), (ii) a barcode element (e.g., a molecular barcode, a cell barcode, a spatial barcode, and/or a unique molecular identifier (UMI)), (iii) an amplification and/or sequencing primer binding site, (iv) one or more linker regions, (v) one or more detectable tags (e.g., fluorophores), or any combination thereof. In some instances, each component of a probe molecule may comprise at least 1, 2, 3, 4, 5, 6, 7, 8, 9, 10, 12, 14, 16, 18, 20, or more than 20 subunits or building blocks. For example, in some instances, each component of a nucleic acid probe molecule may comprise at least 1, 2, 3, 4, 5, 6, 7, 8, 9, 10, 12, 14, 16, 18, 20, or more than 20 nucleotides.

In some instances, physical probes may bind or hybridize directly to their target. In some instances, physical probes may bind or hybridize indirectly to their target. For example, in some instances, a secondary probe may bind or hybridize to a primary probe, where the primary probe binds or hybridizes directly to the target analyte. In some instances, a tertiary probe may bind or hybridize to a secondary probe, where the secondary probe binds or hybridizes to a primary probe, and where the primary probe binds or hybridizes directly to the target analyte.

Examples of “probes” and their applications include, but are not limited to, primary probes (e.g., molecules designed to recognize and bind or hybridize to target analyte), intermediate probes (e.g., molecules designed to recognize and bind or hybridize to another molecule and provide a hybridization or binding site for another probe (e.g., a detection probe), detection probes (e.g., molecules designed to recognize and bind or hybridize to another molecule, detection probes may be labeled with a fluorophore or other detectable tag). In some instances, a probe may be designed to recognize and bind (or hybridize) to a physical barcode sequence (or segments thereof). In some instances, a probe may be used to detect and decode a barcode, e.g., a nucleic acid barcode. In some instances, a probe may bind or hybridize directly to a target barcode. In some instances, a probe may bind or hybridize indirectly to a target barcode (e.g., by binding or hybridizing to other probe molecules which itself is bound or hybridized to the target barcode).

### Nucleic Acid Molecule and Nucleotide Terminology

The terms “nucleic acid” (or “nucleic acid molecule”) and “nucleotide” are intended to be consistent with their use in the art and to include naturally-occurring species or functional analogs thereof. Particularly useful functional analogs of nucleic acids are capable of hybridizing to a nucleic acid in a sequence-specific fashion (e.g., capable of hybridizing to two nucleic acids such that ligation can occur between the two hybridized nucleic acids) or are capable of being used as a template for replication of a particular nucleotide sequence. Naturally-occurring nucleic acids generally have a backbone containing phosphodiester bonds. An analog structure can have an alternate backbone linkage including any of a variety of those known in the art. Naturally-occurring nucleic acids generally have a deoxyribose sugar (e.g., found in deoxyribonucleic acid (DNA)) or a ribose sugar (e.g. found in ribonucleic acid (RNA)).

A nucleic acid can contain nucleotides having any of a variety of analogs of these sugar moieties that are known in the art. A nucleic acid can include natural or non-natural nucleotides. In this regard, a naturally-occurring deoxyribonucleic acid can have one or more bases selected from the group consisting of adenine (A), thymine (T), cytosine (C), or guanine (G), and a ribonucleic acid can have one or more bases selected from the group consisting of uracil (U), adenine (A), cytosine (C), or guanine (G). Useful non-natural bases that can be included in a nucleic acid or nucleotide are known in the art. See, for example, Appella (2009), “Non-Natural Nucleic Acids for Synthetic Biology”, Curr Opin Chem Biol. 13(5-6): 687-696; and Duffy, et al. (2020), “Modified Nucleic Acids: Replication, Evolution, and Next-Generation Therapeutics”, BMC Biology 18:112.

### Samples:

A sample disclosed herein can be or derived from any biological sample. Methods and compositions disclosed herein may be used for analyzing a biological sample, which may be obtained from a subject using any of a variety of techniques including, but not limited to, biopsy, surgery, and laser capture microscopy (LCM), and generally includes cells and/or other biological material from the subject. In addition to the subjects described above, a biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample, a patient derived organoid (PDO) or patient derived xenograft (PDX). A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic individuals, individuals that have or are suspected of having a disease (e.g., a patient with a disease such as cancer) or a pre-disposition to a disease, and/or individuals in need of therapy or suspected of needing therapy.

The biological sample can include any number of macromolecules, for example, cellular macromolecules and organelles (e.g., mitochondria and nuclei). The biological sample can be a nucleic acid sample and/or protein sample. The biological sample can be a carbohydrate sample or a lipid sample. The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions. In some instances, the biological sample may comprise cells which are deposited on a surface.

Cell-free biological samples can include extracellular macromolecules, e.g., polynucleotides. Extracellular polynucleotides can be isolated from a bodily sample, e.g., blood, plasma, serum, urine, saliva, mucosal excretions, sputum, stool, and tears.

Biological samples can be derived from a homogeneous culture or population of the subjects or organisms mentioned herein or alternatively from a collection of several different organisms, for example, in a community or ecosystem.

Biological samples can include one or more diseased cells. A diseased cell can have altered metabolic properties, gene expression, protein expression, and/or morphologic features. Examples of diseases include inflammatory disorders, metabolic disorders, nervous system disorders, and cancer. Cancer cells can be derived from solid tumors, hematological malignancies, cell lines, or obtained as circulating tumor cells. Biological samples can also include fetal cells and immune cells.

In some instances, a substrate herein can be any support that is insoluble in aqueous liquid and which allows for positioning of biological samples, analytes, features, and/or reagents (e.g., probes) on the support. In some instances, a biological sample can be attached to a substrate. Attachment of the biological sample can be irreversible or reversible, depending upon the nature of the sample and subsequent steps in the analytical method. In certain instances, the sample can be attached to the substrate reversibly by applying a suitable polymer coating to the substrate, and contacting the sample to the polymer coating. The sample can then be detached from the substrate, e.g., using an organic solvent that at least partially dissolves the polymer coating. In some instances, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

A variety of steps can be performed to prepare or process a biological sample for and/or during an assay. Except where indicated otherwise, the preparative or processing steps described below can generally be combined in any manner and in any order to appropriately prepare or process a particular sample for and/or analysis.

### Endogenous Analytes:

In some instances, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that comprises a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments. In some instances, the analyte is inside a cell or on a cell surface, such as a transmembrane analyte or one that is attached to the cell membrane. In some instances, the analyte can be an organelle (e.g., nuclei or mitochondria). In some instances, the analyte is an extracellular analyte, such as a secreted analyte. Exemplary analytes include, but are not limited to, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, an extracellular matrix protein, a posttranslational modification (e.g., phosphorylation, glycosylation, ubiquitination, nitrosylation, methylation, acetylation or lipidation) state of a cell surface protein, a gap junction, and an adherens junction.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR. The RNA can be small (e.g., less than 200 nucleic acid bases in length) or large (e.g., RNA greater than 200 nucleic acid bases in length). Examples of small RNAs include 5.8S ribosomal RNA (rRNA), 5S rRNA, tRNA, miRNA, siRNA, snoRNAs, piRNA, tRNA-derived small RNA (tsRNA), and small rDNA-derived RNA (srRNA). The RNA can be double-stranded RNA or single-stranded RNA. The RNA can be circular RNA. The RNA can be a bacterial rRNA (e.g., 16s rRNA or 23s rRNA).

In some instances described herein, an analyte may be a denatured nucleic acid, wherein the resulting denatured nucleic acid is single-stranded. The nucleic acid may be denatured, for example, optionally using formamide, heat, or both formamide and heat. In some instances, the nucleic acid is not denatured for use in a method disclosed herein.

In certain instances, an analyte can be extracted from a live cell. Processing conditions can be adjusted to ensure that a biological sample remains live during analysis, and analytes are extracted from (or released from) live cells of the sample. Live cell-derived analytes can be obtained only once from the sample, or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any implementation described herein, the analyte comprises a target sequence. In some instances, the target sequence may be endogenous to the sample, generated in the sample, added to the sample, or associated with an analyte in the sample. In some instances, the target sequence is a single-stranded target sequence (e.g., a sequence in a rolling circle amplification product). In some instances, the analytes comprise one or more single-stranded target sequences. In one aspect, a first single-stranded target sequence is not identical to a second single-stranded target sequence. In another aspect, a first single-stranded target sequence is identical to one or more second single-stranded target sequence. In some instances, the one or more second single-stranded target sequence is comprised in the same analyte (e.g., nucleic acid) as the first single-stranded target sequence. Alternatively, the one or more second single-stranded target sequence is comprised in a different analyte (e.g., nucleic acid) from the first single-stranded target sequence.

### Labelling Agents:

In some instances, provided herein are methods and compositions for analyzing endogenous analytes (e.g., RNA, ssDNA, and cell surface or intracellular proteins and/or metabolites) in a sample using one or more labelling agents. In some instances, an analyte labelling agent may include an agent that interacts with an analyte (e.g., an endogenous analyte in a sample). In some instances, the labelling agents can comprise a reporter oligonucleotide that is indicative of the analyte or portion thereof interacting with the labelling agent. For example, the reporter oligonucleotide may comprise a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some instances, the analyte labelling agent comprises an analyte binding moiety and a labelling agent barcode domain comprising one or more barcode sequences, e.g., a barcode sequence that corresponds to the analyte binding moiety and/or the analyte. An analyte binding moiety barcode includes to a barcode that is associated with or otherwise identifies the analyte binding moiety. In some instances, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some instances, the method comprises one or more post-fixing (also referred to as post-fixation) steps after contacting the sample with one or more labelling agents.

In the methods and systems described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some instances, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may comprise a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some instances, an analyte binding moiety includes one or more antibodies or antigen binding fragments thereof. The antibodies or antigen binding fragments including the analyte binding moiety can specifically bind to a target analyte. In some instances, the analyte is a protein (e.g., a protein on a surface of the biological sample (e.g., a cell) or an intracellular protein). In some instances, a plurality of analyte labelling agents comprising a plurality of analyte binding moieties bind a plurality of analytes present in a biological sample. In some instances, the plurality of analytes includes a single species of analyte (e.g., a single species of polypeptide). In some instances in which the plurality of analytes includes a single species of analyte, the analyte binding moieties of the plurality of analyte labelling agents are the same. In some instances in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some instances, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may comprise nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2): 708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide comprising a barcode sequence that identifies the label agent. For instance, the labelling agent may be directly coupled (e.g., covalently bound) to a hybridization oligonucleotide that comprises a sequence that hybridizes with a sequence of the reporter oligonucleotide. Hybridization of the hybridization oligonucleotide to the reporter oligonucleotide couples the labelling agent to the reporter oligonucleotide. In some instances, the reporter oligonucleotides are releasable from the labelling agent, such as upon application of a stimulus. For example, the reporter oligonucleotide may be attached to the labelling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer binding sequence (such as an R1, R2, or partial R1 or R2 sequence).

In some cases, the labelling agent can comprise a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some instances, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent comprising an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

### Assays for In Situ Detection and Analysis:

Objectives for in situ detection and analysis methods include detecting, quantifying, and/or mapping analytes (e.g., gene activity) to specific regions in a biological sample (e.g., a tissue sample or cells deposited on a surface) at cellular or sub-cellular resolution. Methods for performing in situ studies include a variety of techniques, e.g., in situ hybridization and in situ sequencing techniques. These techniques allow one to study the subcellular distribution of target analytes (e.g., gene activity as evidenced, e.g., by expressed gene transcripts), and have the potential to provide crucial insights in the fields of developmental biology, oncology, immunology, histology, etc.

Various methods can be used for in situ detection and analysis of target analytes, e.g., sequencing by synthesis (SBS), sequencing by ligation (SBL), sequencing by hybridization (SBH). Non-limiting examples of in situ hybridization techniques include single molecule fluorescence in situ hybridization (smFISH) and multiplexed error-robust fluorescence in situ hybridization (MERFISH). smFISH enables in situ detection and quantification of gene transcripts in tissue samples at the locations where they reside by making use of libraries of multiple short oligonucleotide probes (e.g., approximately 20 base pairs (bp) in length), each labeled with a fluorophore. The probes are sequentially hybridized to gene sequences (e.g., DNA) or gene transcript sequences (e.g., mRNA) sequences, and visualized as diffraction-limited spots by fluorescence microscopy (Levsky, et al. (2003) “Fluorescence In situ Hybridization: Past, Present and Future”, Journal of Cell Science 116 (14): 2833-2838; Raj, et al. (2008) “Imaging Individual mRNA Molecules Using Multiple Singly Labeled Probes”, Nat Methods 5 (10): 877-879; Moor, et al. (2016), ibid.). Variations on the smFISH method include, for example, the use of combinatorial labelling schemes to improve multiplexing capability (Levsky, et al. (2003), ibid.), the use of smFISH in combination with super-resolution microscopy (Lubeck, et al. (2014) “Single-Cell In situ RNA Profiling by Sequential Hybridization”, Nature Methods 11 (4): 360-361).

MERFISH addresses two of the limitations of earlier in situ hybridization approaches, namely the limited number of target sequences that could be simultaneously identified and the robustness of the approach to readout errors caused by the stochastic nature of the hybridization process (Moor, et al. (2016), ibid.). MERFISH utilizes a binary barcoding scheme in which the probed target mRNA sequences are either fluorescence positive or fluorescence negative for any given imaging cycle (Ke, et al. (2016), ibid.; Moffitt, et al. (2016) “RNA Imaging with Multiplexed Error Robust Fluorescence In situ Hybridization”, Methods Enzymol. 572:1-49). The encoding probes that contain a combination of target-specific hybridization sequence regions and barcoded readout sequence regions are first hybridized to the target mRNA sequences. In each imaging cycle, a subset of fluorophore-conjugated readout probes is hybridized to a subset of encoding probes. Target mRNA sequences that fluoresce in a given cycle are assigned a value of “1” and the remaining target mRNA sequences are assigned a value of “0”. Between imaging cycles, the fluorescent probes from the previous cycle are photobleached. After, e.g., 14 or 16 rounds of readout probe hybridization and imaging, unique combinations of the detected fluorescence signals generate a 14-bit or 16-bit code that identifies the different gene transcripts. To address the increased error rate for correctly calling the readout codes increases as the number of hybridization and imaging cycles increases, the method may also entail the use of Hamming distances for barcode design and correction of decoding errors (see., e.g., Buschmann, et al. (2013) “Levenshtein Error-Correcting Barcodes for Multiplexed DNA Sequencing”, Bioinformatics 14:272), thereby resulting in an error-robust barcoding scheme.

Some in situ sequencing techniques generally comprise both in situ target capture (e.g., of mRNA sequences) and in situ sequencing. Non-limiting examples of in situ sequencing techniques include in situ sequencing with padlock probes (ISS-PLP), fluorescent in situ sequencing (FISSEQ), barcode in situ targeted sequencing (Barista-Seq), and spatially-resolved transcript amplicon readout mapping (STARmap) (see, e.g., Ke, et al. (2016), ibid., Asp, et al. (2020), ibid.).

Some methods for in situ detection and analysis of analytes utilize a probe (e.g., padlock or circular probe) that detects specific target analytes. The in situ sequencing using padlock probes (ISS-PLP) method, for example, combines padlock probing to target specific gene transcripts, rolling-circle amplification (RCA), and sequencing by ligation (SBL) chemistry. Within intact tissue sections, reverse transcription primers are hybridized to target sequence (e.g., mRNA sequences) and reverse transcription is performed to create cDNA to which a padlock probe (a single-stranded DNA molecule comprising regions that are complementary to the target cDNA) can bind (see, e.g., Asp, et al. (2020), ibid.). In one variation of the method, the padlock probe binds to the cDNA target with a gap remaining between the ends which is then filled in using a DNA polymerization reaction. In another variation of the method, the ends of the bound padlock probe are adjacent to each other. The ends are then ligated to create a circular DNA molecule. Target amplification using rolling-circle amplification (RCA) results in micrometer-sized RCA products (RCPs), containing a plurality of concatenated repeats of the probe sequence. In some examples, RCPs are then subjected to, e.g., sequencing-by-ligation (SBL) or sequencing-by-hybridization (SBH). In some cases, the method allows for a barcode located within the probe to be decoded.

Products of Endogenous Analytes and/or Labelling Agents:

In some instances, provided herein are methods and compositions for analyzing one or more products of an endogenous analyte and/or a labelling agent in a biological sample. In some instances, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product such as a rolling circle amplification (RCA) product) thereof is analyzed. In some instances, a labelling agent that directly or indirectly binds to an analyte in the biological sample is analyzed. In some instances, a product (e.g., a hybridization product, a ligation product, an extension product (e.g., by a DNA or RNA polymerase), a replication product, a transcription/reverse transcription product, and/or an amplification product such as a rolling circle amplification (RCA) product) of a labelling agent that directly or indirectly binds to an analyte in the biological sample is analyzed.

In some instances, the analyzing comprises using primary probes which comprise a target binding region (e.g., a region that binds to a target such as RNA transcripts) and the primary probes may contain one or more barcodes (e.g., primary barcode). In some instances, the barcodes are bound by detection primary probes, which do not need to be fluorescent, but that include a target-binding portion (e.g., for hybridizing to one or more primary probes) and one or more barcodes (e.g., secondary barcodes). In some instances, the detection primary probe comprises an overhang that does not hybridize to the target nucleic acid but hybridizes to another probe. In some examples, the overhang comprises the barcode(s). In some instances, the barcodes of the detection primary probes are targeted by detectably labeled detection oligonucleotides, such as fluorescently labeled oligos. In some instances, one or more decoding schemes are used to decode the signals, such as fluorescence, for sequence determination. Various probes and probe sets can be used to hybridize to and detect an endogenous analyte and/or a sequence associated with a labelling agent. In some instances, these assays may enable multiplexed detection, signal amplification, combinatorial decoding, and error correction schemes. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set. The specific probe or probe set design can vary.

### Hybridization and Ligation:

Various probes and probe sets can be hybridized to an endogenous analyte and/or a labelling agent and each probe may comprise one or more barcode sequences. The specific probe or probe set design can vary. In some instances, the hybridization of a primary probe or probe set (e.g., a circularizable probe or probe set) to a target nucleic acid analyte and may lead to the generation of a rolling circle amplification (RCA) template. In some instances, the assay uses or generates a circular nucleic acid molecule which can be the RCA template.

In some instances, a product of an endogenous analyte and/or a labelling agent is a ligation product. In some instances, the ligation product is formed from circularization of a circularizable probe or probe set upon hybridization to a target sequence. In some instances, the ligation product is formed between two or more endogenous analytes. In some instances, the ligation product is formed between an endogenous analyte and a labelling agent. In some instances, the ligation product is formed between two or more labelling agent. In some instances, the ligation product is an intramolecular ligation of an endogenous analyte. In some instances, the ligation product is an intramolecular ligation of a labelling agent, for example, the circularization of a circularizable probe or probe set upon hybridization to a target sequence. The target sequence can be comprised in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some instances, provided herein is a probe or probe set capable of DNA-templated ligation, such as from a cDNA molecule. See, e.g., U.S. Pat. No. 8,551,710, which is hereby incorporated by reference in its entirety. In some instances, provided herein is a probe or probe set capable of RNA-templated ligation. See, e.g., U.S. Pat. Pub. 2020/0224244 which is hereby incorporated by reference in its entirety. In some instances, the probe set is a SNAIL probe set. See, e.g., U.S. Pat. Pub. 20190055594, which is hereby incorporated by reference in its entirety. In some instances, provided herein is a multiplexed proximity ligation assay. See, e.g., U.S. Pat. Pub. 20140194311 which is hereby incorporated by reference in its entirety. In some instances, provided herein is a probe or probe set capable of proximity ligation, for instance a proximity ligation assay for RNA (e.g., PLAYR) probe set. See, e.g., U.S. Pat. Pub. 20160108458, which is hereby incorporated by reference in its entirety. In some instances, a circular probe can be indirectly hybridized to the target nucleic acid. In some instances, the circular construct is formed from a probe set capable of proximity ligation, for instance a proximity ligation in situ hybridization (PLISH) probe set. See, e.g., U.S. Pat. Pub. 2020/0224243 which is hereby incorporated by reference in its entirety.

In some instances, the ligation involves chemical ligation. In some instances, the ligation involves template dependent ligation. In some instances, the ligation involves template independent ligation. In some instances, the ligation involves enzymatic ligation.

In some instances, the enzymatic ligation involves use of a ligase. In some aspects, the ligase used herein comprises an enzyme that is commonly used to join polynucleotides together or to join the ends of a single polynucleotide. An RNA ligase, a DNA ligase, or another variety of ligase can be used to ligate two nucleotide sequences together. Ligases comprise ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases comprise bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some instances, the ligase is a T4 RNA ligase. In some instances, the ligase is a splintR ligase. In some instances, the ligase is a single stranded DNA ligase. In some instances, the ligase is a T4 DNA ligase. In some instances, the ligase is a ligase that has an DNA-splinted DNA ligase activity. In some instances, the ligase is a ligase that has an RNA-splinted DNA ligase activity.

In some instances, the ligation herein is a direct ligation. In some instances, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some instances, said ends are not ligated directly to each other, but instead occurs either via the intermediacy of one or more intervening (so-called “gap” or “gap-filling” (oligo) nucleotides) or by the extension of 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo) nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific implementations, the gap may be a gap of about 1, 2, 3, 4, 5, 6, 7, 8, 9 or 10 or more nucleotides, of any integer (or range of integers) of nucleotides in between the indicated values. In some instances, the gap between said terminal regions may be filled by a gap oligonucleotide or by extending 3′ end of a polynucleotide. In some cases, ligation involves ligating the ends of the probe to at least one gap (oligo) nucleotide, such that the gap (oligo) nucleotide becomes incorporated into the resulting polynucleotide. In some instances, the ligation herein is preceded by gap filling. In other implementations, the ligation herein does not require gap filling.

In some instances, ligation of the polynucleotides produces polynucleotides with melting temperature higher than that of un-ligated polynucleotides. Thus, in some aspects, ligation stabilizes the hybridization complex containing the ligated polynucleotides prior to subsequent steps, comprising amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tm) of the DNA strands. This selectively reduces the concentration of annealed mismatched substrates (expected to have a slightly lower Tm around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some instances, the ligation herein is a proximity ligation of ligating two (or more) nucleic acid sequences that are in proximity with each other, e.g., through enzymatic means (e.g., a ligase). In some instances, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification:

In some instances, the hybridization of a primary probe or probe set (e.g. a circularizable probe or probe set) to a target analyte and may lead to the generation of an extension or amplification product. In some instances, a product is a primer extension product of an analyte, a labelling agent, a probe or probe set bound to the analyte (e.g., a circularizable probe bound to genomic DNA, mRNA, or cDNA), or a probe or probe set bound to the labelling agent (e.g., a circularizable probe bound to one or more reporter oligonucleotides from the same or different labelling agents.

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some instances, a product of an endogenous analyte and/or a labelling agent is an amplification product of one or more polynucleotides, for instance, a circular probe or circularizable probe or probe set. In some instances, the disclosed methods may comprise the use of a rolling circle amplification (RCA) technique to amplify signal. Rolling circle amplification is an isothermal, DNA polymerase-mediated process in which long single-stranded DNA molecules are synthesized on a short circular single-stranded DNA template using a single DNA primer (Zhao, et al. (2008), “Rolling Circle Amplification: Applications in Nanotechnology and Biodetection with Functional Nucleic Acids”, Angew Chem Int Ed Engl. 47(34): 6330-6337; Ali, et al. (2014), “Rolling Circle Amplification: A Versatile Tool for Chemical Biology, Materials Science and Medicine”, Chem Soc Rev. 43(10): 3324-3341). The RCA product is a concatemer containing tens to hundreds of tandem repeats that are complementary to the circular template, and may be used to develop sensitive techniques for the detection of a variety of targets, including nucleic acids (DNA, RNA), small molecules, proteins, and cells (Ali, et al. (2014), ibid.). In some implementations, a primer that hybridizes to the circular probe or circularized probe is added and used as such for amplification. In some instances, the RCA comprises a linear RCA, a branched RCA, a dendritic RCA, or any combination thereof.

In some instances, the amplification is performed at a temperature between or between about 20° C. and about 60° C. In some instances, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some instances, upon addition of a DNA polymerase in the presence of appropriate dNTP precursors and other cofactors, a primer is elongated to produce multiple copies of the circular template. This amplification step can utilize isothermal amplification or non-isothermal amplification. In some instances, after the formation of the hybridization complex and association of the amplification probe, the hybridization complex is rolling-circle amplified to generate a cDNA nanoball (i.e., amplicon) containing multiple copies of the cDNA. Techniques for rolling circle amplification (RCA) are known in the art such as linear RCA, a branched RCA, a dendritic RCA, or any combination thereof. (See, e.g., Baner et al, Nucleic Acids Research, 26:5073-5078, 1998; Lizardi et al, Nature Genetics 19:226, 1998; Mohsen et al., Acc Chem Res. 2016 Nov. 15; 49(11): 2540-2550; Schweitzer et al. Proc. Natl Acad. Sci. USA 97:101 13-1 19, 2000; Faruqi et al, BMC Genomics 2:4, 2000; Nallur et al, Nucl. Acids Res. 29: el 18, 2001; Dean et al. Genome Res. 1 1:1095-1099, 2001; Schweitzer et al, Nature Biotech. 20:359-365, 2002; U.S. Pat. Nos. 6,054,274, 6,291,187, 6,323,009, 6,344,329 and 6,368,801). Exemplary polymerases for use in RCA comprise DNA polymerase such phi29 (φ29) polymerase, Klenow fragment, Bacillus stearothermophilus DNA polymerase (BST), T4 DNA polymerase, T7 DNA polymerase, or DNA polymerase I. In some aspects, DNA polymerases that have been engineered or mutated to have desirable characteristics can be employed. In some instances, the polymerase is phi29 DNA polymerase.

In some aspects, during the amplification step, modified nucleotides can be added to the reaction to incorporate the modified nucleotides in the amplification product (e.g., nanoball). Exemplary of the modified nucleotides comprise amine-modified nucleotides. In some aspects of the methods, for example, for anchoring or cross-linking of the generated amplification product (e.g., nanoball) to a scaffold, to cellular structures and/or to other amplification products (e.g., other nanoballs). In some aspects, the amplification products comprises a modified nucleotide, such as an amine-modified nucleotide. In some instances, the amine-modified nucleotide comprises an acrylic acid N-hydroxysuccinimide moiety modification. Examples of other amine-modified nucleotides comprise, but are not limited to, a 5-Aminoallyl-dUTP moiety modification, a 5-Propargylamino-dCTP moiety modification, a N6-6-Aminohexyl-dATP moiety modification, or a 7-Deaza-7-Propargylamino-dATP moiety modification.

In some instances, the RCA template may comprise the target analyte, or a part thereof, where the target analyte is a nucleic acid, or it may be provided or generated as a proxy, or a marker, for the analyte. In some instances, the RCA template may comprise a sequence of the probes and probe sets hybridized to an endogenous analyte and/or a labelling agent. In some instances, the amplification product can be generated as a proxy, or a marker, for the analyte. As noted above, many assays are known for the detection of numerous different analytes, which use a RCA-based detection system, e.g., where the signal is provided by generating a RCP from a circular RCA template which is provided or generated in the assay, and the RCP is detected to detect the analyte. The RCP may thus be regarded as a reporter which is detected to detect the target analyte. However, the RCA template may also be regarded as a reporter for the target analyte; the RCP is generated based on the RCA template, and comprises complementary copies of the RCA template. The RCA template determines the signal which is detected, and is thus indicative of the target analyte. As will be described in more detail below, the RCA template may be a probe, or a part or component of a probe, or may be generated from a probe, or it may be a component of a detection assay (i.e. a reagent in a detection assay), which is used as a reporter for the assay, or a part of a reporter, or signal-generation system. The RCA template used to generate the RCP may thus be a circular (e.g. circularized) reporter nucleic acid molecule, namely from any RCA-based detection assay which uses or generates a circular nucleic acid molecule as a reporter for the assay. Since the RCA template generates the RCP reporter, it may be viewed as part of the reporter system for the assay.

In some instances, an assay may detect a product herein that includes a molecule or a complex generated in a series of reactions, e.g., hybridization, ligation, extension, replication, transcription/reverse transcription, and/or amplification (e.g., rolling circle amplification), in any suitable combination. For example, a product comprising a target sequence for a probe disclosed herein (e.g., a bridge probe or L-probe) may be a hybridization complex formed of a cellular nucleic acid in a sample and an exogenously added nucleic acid probe. The exogenously added nucleic acid probe may comprise an overhang that does not hybridize to the cellular nucleic acid but hybridizes to another probe (e.g., a detection probe). The exogenously added nucleic acid probe may be optionally ligated to a cellular nucleic acid molecule or another exogenous nucleic acid molecule. In other examples, a product comprising a target sequence for a probe disclosed herein (e.g., an anchor probe) may be an RCP of a circularizable probe or probe set which hybridizes to a cellular nucleic acid molecule (e.g., genomic DNA or mRNA) or product thereof (e.g., a transcript such as cDNA, a DNA-templated ligation product of two probes, or an RNA-templated ligation product of two probes). In other examples, a product comprising a target sequence for a probe disclosed herein (e.g., a bridge probe or L-probe) may be a probe hybridizing to an RCP. The probe may comprise an overhang that does not hybridize to the RCP but hybridizes to another probe (e.g., a detection probe).

### Signal Amplification Methods:

In some instances, a method disclosed herein may also comprise one or more signal amplification components and detecting such signals. In some instances, the present disclosure relates to the detection of nucleic acid sequences in situ using probe hybridization and generation of amplified signals associated with the probes. In some instances, the target nucleic acid of a nucleic acid probe comprises multiple target sequences for nucleic acid probe hybridization, such that the signal corresponding to a barcode sequence of the nucleic acid probe is amplified by the presence of multiple nucleic acid probes hybridized to the target nucleic acid. For example, multiple sequences can be selected from a target nucleic acid such as an mRNA, such that a group of nucleic acid probes (e.g., 20-50 nucleic acid probes) hybridize to the mRNA in a tiled fashion. In another example, the target nucleic acid can be an amplification product (e.g., an RCA product) comprising multiple copies of a target sequence (e.g., a barcode sequence of the RCA product).

Alternatively or additionally, amplification of a signal associated with a barcode sequence of a nucleic acid probe can be amplified using one or more signal amplification strategies off of an oligonucleotide probe that hybridizes to the barcode sequence. In some aspects, amplification of the signal associated with the oligonucleotide probe can reduce the number of nucleic acid probes needed to hybridize to the target nucleic acid to obtain a sufficient signal-to-noise ratio. For example, the number of nucleic acid probes to tile a target nucleic acid such as an mRNA can be reduced. In some aspects, reducing the number of nucleic acid probes tiling a target nucleic acid enables detection of shorter target nucleic acids, such as shorter mRNAs. In some instances, no more than one, two, three, 4, 5, 6, 7, 8, 9, 10, 11, 12, 13, 14, 15, 16, 17, 18. 19, or 20 nucleic acid probes may be hybridized to the target nucleic acid. In instances wherein the target nucleic acid is an amplification product, signal amplification off of the oligonucleotide probes may reduce the number of target sequences required for detection (e.g., the length of the RCA product can be reduced).

Exemplary signal amplification methods include targeted deposition of detectable reactive molecules around the site of probe hybridization, targeted assembly of branched structures (e.g., bDNA or branched assay using locked nucleic acid (LNA)), programmed in situ growth of concatemers by enzymatic rolling circle amplification (RCA) (e.g., as described in US 2019/0055594 incorporated herein by reference), hybridization chain reaction, assembly of topologically catenated DNA structures using serial rounds of chemical ligation (clampFISH), signal amplification via hairpin-mediated concatemerization (e.g., as described in US 2020/0362398 incorporated herein by reference), e.g., primer exchange reactions such as signal amplification by exchange reaction (SABER) or SABER with DNA-Exchange (Exchange-SABER). In some instances, a non-enzymatic signal amplification method may be used.

The detectable reactive molecules may comprise tyramide, such as used in tyramide signal amplification (TSA) or multiplexed catalyzed reporter deposition (CARD)-FISH. In some instances, the detectable reactive molecule may be releasable and/or cleavable from a detectable label such as a fluorophore. In some instances, a method disclosed herein comprises multiplexed analysis of a biological sample comprising consecutive cycles of probe hybridization, fluorescence imaging, and signal removal, where the signal removal comprises removing the fluorophore from a fluorophore-labeled reactive molecule (e.g., tyramide). Exemplary detectable reactive reagents and methods are described in U.S. Pat. No. 6,828,109, US 2019/0376956, WO 2019/236841, WO 2020/102094, WO 2020/163397, and WO 2021/067475, all of which are incorporated herein by reference in their entireties.

In some instances, hybridization chain reaction (HCR) can be used for signal amplification. HCR is an enzyme-free nucleic acid amplification based on a triggered chain of hybridization of nucleic acid molecules starting from HCR monomers, which hybridize to one another to form a nicked nucleic acid polymer. This polymer is the product of the HCR reaction which is ultimately detected in order to indicate the presence of the target analyte. HCR is described in detail in Dirks and Pierce, 2004, PNAS, 101(43), 15275-15278 and in U.S. Pat. Nos. 7,632,641 and 7,721,721 (see also US 2006/00234261; Chemeris et al, 2008 Doklady Biochemistry and Biophysics, 419, 53-55; Niu et al, 2010, 46, 3089-3091; Choi et al, 2010, Nat. Biotechnol. 28(11), 1208-1212; and Song et al, 2012, Analyst, 137, 1396-1401). HCR monomers typically comprise a hairpin, or other metastable nucleic acid structure. In the simplest form of HCR, two different types of stable hairpin monomer, referred to here as first and second HCR monomers, undergo a chain reaction of hybridization events to form a long nicked double-stranded DNA molecule when an “initiator” nucleic acid molecule is introduced. The HCR monomers have a hairpin structure comprising a double stranded stem region, a loop region connecting the two strands of the stem region, and a single stranded region at one end of the double stranded stem region. The single stranded region which is exposed (and which is thus available for hybridization to another molecule, e.g. initiator or other HCR monomer) when the monomers are in the hairpin structure may be known as the “toehold region” (or “input domain”). The first HCR monomers each further comprise a sequence which is complementary to a sequence in the exposed toehold region of the second HCR monomers. This sequence of complementarity in the first HCR monomers may be known as the “interacting region” (or “output domain”). Similarly, the second HCR monomers each comprise an interacting region (output domain), e.g. a sequence which is complementary to the exposed toehold region (input domain) of the first HCR monomers. In the absence of the HCR initiator, these interacting regions are protected by the secondary structure (e.g. they are not exposed), and thus the hairpin monomers are stable or kinetically trapped (also referred to as “metastable”), and remain as monomers (e.g. preventing the system from rapidly equilibrating), because the first and second sets of HCR monomers cannot hybridize to each other. However, once the initiator is introduced, it is able to hybridize to the exposed toehold region of a first HCR monomer, and invade it, causing it to open up. This exposes the interacting region of the first HCR monomer (e.g. the sequence of complementarity to the toehold region of the second HCR monomers), allowing it to hybridize to and invade a second HCR monomer at the toehold region. This hybridization and invasion in turn opens up the second HCR monomer, exposing its interacting region (which is complementary to the toehold region of the first HCR monomers), and allowing it to hybridize to and invade another first HCR monomer. The reaction continues in this manner until all of the HCR monomers are exhausted (e.g. all of the HCR monomers are incorporated into a polymeric chain). Ultimately, this chain reaction leads to the formation of a nicked chain of alternating units of the first and second monomer species. The presence of the HCR initiator is thus required in order to trigger the HCR reaction by hybridization to and invasion of a first HCR monomer. The first and second HCR monomers are designed to hybridize to one another are thus may be defined as cognate to one another. They are also cognate to a given HCR initiator sequence. HCR monomers which interact with one another (hybridize) may be described as a set of HCR monomers or an HCR monomer, or hairpin, system.

An HCR reaction could be carried out with more than two species or types of HCR monomers. For example, a system involving three HCR monomers could be used. In such a system, each first HCR monomer may comprise an interacting region which binds to the toehold region of a second HCR monomer; each second HCR may comprise an interacting region which binds to the toehold region of a third HCR monomer; and each third HCR monomer may comprise an interacting region which binds to the toehold region of a first HCR monomer. The HCR polymerization reaction would then proceed as described above, except that the resulting product would be a polymer having a repeating unit of first, second and third monomers consecutively. Corresponding systems with larger numbers of sets of HCR monomers could readily be conceived. Branching HCR systems have also been devised and described (see, e.g., WO 2020/123742 incorporated herein by reference), and may be used in the methods herein.

In some instances, similar to HCR reactions that use hairpin monomers, linear oligo hybridization chain reaction (LO-HCR) can also be used for signal amplification. In some instances, provided herein is a method of detecting an analyte in a sample comprising: (i) performing a linear oligo hybridization chain reaction (LO-HCR), wherein an initiator is contacted with a plurality of LO-HCR monomers of at least a first and a second species to generate a polymeric LO-HCR product hybridized to a target nucleic acid molecule, wherein the first species comprises a first hybridization region complementary to the initiator and a second hybridization region complementary to the second species, wherein the first species and the second species are linear, single-stranded nucleic acid molecules; wherein the initiator is provided in one or more parts, and hybridizes directly or indirectly to or is comprised in the target nucleic acid molecule; and (ii) detecting the polymeric product, thereby detecting the analyte. In some instances, the first species and/or the second species may not comprise a hairpin structure. In some instances, the plurality of LO-HCR monomers may not comprise a metastable secondary structure. In some instances, the LO-HCR polymer may not comprise a branched structure. In some instances, performing the linear oligo hybridization chain reaction comprises contacting the target nucleic acid molecule with the initiator to provide the initiator hybridized to the target nucleic acid molecule. In any of the instances herein, the target nucleic acid molecule and/or the analyte can be an RCA product.

In some instances, detection of nucleic acids sequences in situ includes combination of the sequential decoding methods described herein with an assembly for branched signal amplification. In some instances, the assembly complex comprises an amplifier hybridized directly or indirectly (via one or more oligonucleotides) to a sequence of an oligonucleotide probe described herein. In some instances, the assembly includes one or more amplifiers each including an amplifier repeating sequence. In some aspects, the one or more amplifiers is labeled. Described herein is a method of using the aforementioned assembly, including for example, using the assembly in multiplexed error-robust fluorescent in situ hybridization (MERFISH) applications, with branched DNA amplification for signal readout. In some instances, the amplifier repeating sequence is about 5-30 nucleotides, and is repeated N times in the amplifier. In some instances, the amplifier repeating sequence is about 20 nucleotides, and is repeated at least two times in the amplifier. In some aspects, the one or more amplifier repeating sequence is labeled. For exemplary branched signal amplification, see e.g., U.S. Pat. Pub. No. US20200399689A1 and Xia et al., Multiplexed Detection of RNA using MERFISH and branched DNA amplification. Scientific Reports (2019), each of which is fully incorporated by reference herein.

In some instances, an oligonucleotide probe described herein can be associated with an amplified signal by a method that comprises signal amplification by performing a primer exchange reaction (PER). In various instances, a primer with domain on its 3′ end binds to a catalytic hairpin, and is extended with a new domain by a strand displacing polymerase. For example, a primer with domain 1 on its 3′ ends binds to a catalytic hairpin, and is extended with a new domain 1 by a strand displacing polymerase, with repeated cycles generating a concatemer of repeated domain 1 sequences. In various instances, the strand displacing polymerase is Bst. In various instances, the catalytic hairpin includes a stopper which releases the strand displacing polymerase. In various instances, branch migration displaces the extended primer, which can then dissociate. In various instances, the primer undergoes repeated cycles to form a concatemer primer (see e.g., U.S. Pat. Pub. No. US20190106733, which is incorporated herein by reference, for exemplary molecules and PER reaction components).

### Barcoded Analytes and Detection:

A target sequence for a probe disclosed herein may be comprised in any analyte disclose herein, including an endogenous analyte (e.g., a viral or cellular nucleic acid), a labelling agent, or a product generated in the biological sample using an endogenous analyte and/or a labelling agent.

In some aspects, one or more of the target sequences includes or is associated with one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode comprises about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some instances, a barcode includes two or more sub-barcodes that together function as a single barcode. For example, a polynucleotide barcode can include two or more polynucleotide sequences (e.g., sub-barcodes) that are separated by one or more non-barcode sequences. In some instances, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In any of the preceding implementations, barcodes (e.g., primary and/or secondary barcode sequences) can be analyzed (e.g., detected or sequenced) using any suitable method or technique, including those described herein, such as sequencing by synthesis (SBS), sequencing by ligation (SBL), or sequencing by hybridization (SBH). In some instances, barcoding schemes and/or barcode detection schemes as described in RNA sequential probing of targets (RNA SPOTs), single-molecule fluorescent in situ hybridization (smFISH), multiplexed error-robust fluorescence in situ hybridization (MERFISH) or sequential fluorescence in situ hybridization (seqFISH+) can be used. In any of the preceding implementations, the methods provided herein can include analyzing the barcodes by sequential hybridization and detection with a plurality of labelled probes (e.g., detection probes (e.g., detection oligos) or barcode probes). In some instances, the barcode detection steps can be performed as described in hybridization-based in situ sequencing (HybISS). In some instances, probes can be detected and analyzed (e.g., detected or sequenced) as performed in fluorescent in situ sequencing (FISSEQ), or as performed in the detection steps of the spatially-resolved transcript amplicon readout mapping (STARmap) method. In some instances, signals associated with an analyte can be detected as performed in sequential fluorescent in situ hybridization (seqFISH).

In some instances, in a barcode-based detection method, barcode sequences are detected for identification of other molecules including nucleic acid molecules (DNA or RNA) longer than the barcode sequences themselves, as opposed to direct sequencing of the longer nucleic acid molecules. In some instances, a N-mer barcode sequence comprises 4N complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (4⁵=1024), whereas 8 nucleotide barcodes can be used to identify up to 65,536 molecular species, a number greater than the total number of distinct genes in the human genome. In some instances, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Sequential Hybridization:

In some instances, the present disclosure relates to methods and compositions for encoding and detecting analytes in a temporally sequential manner for in situ analysis of an analyte in a biological sample, e.g., a target nucleic acid in a cell in an intact tissue. In some aspects, provided herein is a method for detecting the detectably-labeled probes, thereby generating a signal signature. In some instances, the signal signature corresponds to an analyte of the plurality of analytes. In some instances, the methods described herein are based, in part, on the development of a multiplexed biological assay and readout, in which a sample is first contacted with a plurality of nucleic acid probes comprising one or more probe types (e.g., labelling agent, circularizable probe, circular probe, etc.), allowing the probes to directly or indirectly bind target analytes, which may then be optically detected (e.g., by detectably-labeled probes) in a temporally-sequential manner. In some instances, the probes or probe sets comprising various probe types may be applied to a sample simultaneously. In some instances, the probes or probe sets comprising various probe types may be applied to a sample sequentially. In some aspects, the method comprises sequential hybridization of labelled probes to create a spatiotemporal signal signature or code that identifies the analyte.

In some aspects, provided herein is a method involving a multiplexed biological assay and readout, in which a sample is first contacted with a plurality of nucleic acid probes, allowing the probes to directly or indirectly bind target analytes, which may then be optically detected (e.g., by detectably-labeled probes) in a temporally sequential manner. The plurality of nucleic acid probes themselves may be detectably-labeled and detected; in other words, the nucleic acid probes themselves serve as the detection probes. In other implementations, a nucleic acid probe itself is not directly detectably-labeled (e.g., the probe itself is not conjugated to a detectable label); rather, in addition to a target binding sequence (e.g., a sequence binding to a barcode sequence in an RCA product), the nucleic acid probe further comprises a sequence for detection which can be recognized by one or more detectably-labeled detection probes. In some instances, the probes or probe sets comprising various probe types may be applied to a sample simultaneously. In some instances, the probes or probe sets comprising various probe types may be applied to a sample sequentially. In some instances, the method comprises detecting a plurality of analytes in a sample.

In some instances, the method presented herein comprises contacting the sample with a plurality of probes comprising one or more probes having distinct labels and detecting signals from the plurality of probes in a temporally sequential manner, wherein said detection generates signal signatures each comprising a temporal order of signal or absence thereof, and the signal signatures correspond to said plurality of probes that identify the corresponding analytes. In some instances, the temporal order of the signals or absence thereof corresponding to the analytes can be unique for each different analyte of interest in the sample. In some instances, the plurality of probes hybridize to an endogenous molecule in the sample, such as a cellular nucleic acid molecule, e.g., genomic DNA, RNA (e.g., mRNA), or cDNA. In some instances, the plurality of probes hybridize to a product of an endogenous molecule in the sample (e.g., directly or indirectly via an intermediate probe). In some instances, the plurality of probes hybridize to labelling agent that binds directly or indirectly to an endogenous molecule in the sample or a product thereof. In some instances, the plurality of probes hybridize to a product (e.g., an RCA product) of a labelling agent that binds directly or indirectly to an endogenous molecule in the sample or a product thereof.

In any of the implementations disclosed herein, the detection of signals can be performed sequentially in cycles, one for each distinct label. In any of the implementations disclosed herein, signals or absence thereof from detectably-labeled probes targeting an analyte in a particular location in the sample can be recorded in a first cycle for detecting a first label, and signals or absence thereof from detectably-labeled probes targeting the analyte in the particular location can be recorded in a second cycle for detecting a second label distinct from the first label. In any of the implementations disclosed herein, a unique signal signature can be generated for each analyte of the plurality of analytes. In any of the implementations disclosed herein, one or more molecules comprising the same analyte or a portion thereof can be associated with the same signal signature.

In some instances, the in situ assays employ strategies for optically encoding the spatial location of target analytes (e.g., mRNAs) in a sample using sequential rounds of fluorescent hybridization. Microcopy may be used to analyze 4 or 5 fluorescent colors indicative of the spatial localization of a target, followed by various rounds of hybridization and stripping, in order to generate a large set of unique optical signal signatures assigned to different analytes. These methods often require a large number of hybridization rounds, and a large number of microscope lasers (e.g., detection channels) to detect a large number of fluorophores, resulting in a one to one mapping of the lasers to the fluorophores. Specifically, each detectably-labeled probe comprises one detectable moiety, e.g., a fluorophore.

In some aspects, provided herein is a method for analyzing a sample using a detectably-labeled set of probes. In some instances, the method comprises contacting the sample with a first plurality of detectably-labeled probes for targeting a plurality of analytes; performing a first detection round comprising detecting signals from the first plurality of detectably-labeled probes; contacting the sample with a second plurality of detectably-labeled probes for targeting the plurality of analytes; performing a second detection round of detecting signals from the second plurality of detectably-labeled probes, thereby generating a signal signature comprising a plurality of signals detected from the first detection round and second detection round, wherein the signal signature corresponds to an analyte of the plurality of analytes.

In some instances, detection of an optical signal signature comprises several rounds of detectably-labeled probe hybridization (e.g., contacting a sample with detectably-labeled probes), detectably-labeled probe detection, and detectably-labeled probe removal. In some instances, a sample is contacted with plurality first detectably-labeled probes, and said probes are hybridized to a plurality of nucleic acid analytes within the sample in decoding hybridization round 1. In some instances, a first detection round is performed following detectably-labeled probe hybridization. After hybridization and detection of a first plurality of detectably-labeled probes, probes are removed, and a sample may be contacted with a second plurality round of detectably-labeled probes targeting the analytes targeted in decoding hybridization round 1. The second plurality of detectably-labeled probes may hybridize to the same nucleic acid(s) as the first plurality of detectably-labeled probes (e.g., hybridize to an identical or hybridize to new nucleic acid sequence within the same nucleic acid), or the second plurality of detectably-labeled probes may hybridize to different nucleic acid(s) compared to the first plurality of detectably-labeled probes. Following m rounds of contacting a sample with a plurality of detectably-labeled probes, probe detection, and probe removal, ultimately a unique signal signature to each nucleic acid is produced that may be used to identify and quantify said nucleic acids and the corresponding analytes (e.g., if the nucleic acids themselves are not the analytes of interest and each is used as part of a labelling agent for one or more other analytes such as protein analytes and/or other nucleic acid analytes).

In some instances, after hybridization of a detectably-labeled probes (e.g., fluorescently labeled oligonucleotide) that detects a sequence (e.g., barcode sequence on a secondary probe or a primary probe), and optionally washing away the unbound molecules of the detectably-labeled probe, the sample is imaged and the detection oligonucleotide or detectable label is inactivated and/or removed. In some instances, removal of the signal associated with the hybridization between rounds can be performed by washing, heating, stripping, enzymatic digestion, photo-bleaching, displacement (e.g., displacement of detectably-labeled probes with another reagent or nucleic acid sequence), cleavage, quenching, chemical degradation, bleaching, oxidation, or any combinations thereof.

In some examples, removal of a probe (e.g., un-hybridizing the entire probe), signal modifications (e.g., quenching, masking, photo-bleaching, signal enhancement (e.g., via FRET), signal amplification, etc.), signal removal (e.g., cleaving off or permanently inactivating a detectable label) can be performed. Inactivation may be caused by removal of the detectable label (e.g., from the sample, or from the probe, etc.), and/or by chemically altering the detectable label in some fashion, e.g., by photobleaching the detectable label, bleaching or chemically altering the structure of the detectable label, e.g., by reduction, etc.). In some instances, the fluorescently labeled oligonucleotide and/or the intermediate probe hybridized to the fluorescently labeled oligonucleotide (e.g., bridge probe or L-probe) can be removed. In some instances, a fluorescent detectable label may be inactivated by chemical or optical techniques such as oxidation, photobleaching, chemically bleaching, stringent washing or enzymatic digestion or reaction by exposure to an enzyme, dissociating the detectable label from other components (e.g., a probe), chemical reaction of the detectable label (e.g., to a reactant able to alter the structure of the detectable label) or the like. For instance, bleaching may occur by exposure to oxygen, reducing agents, or the detectable label could be chemically cleaved from the nucleic acid probe and washed away via fluid flow.

In some instances, removal of a signal comprises displacement of probes with another reagent (e.g., probe) or nucleic acid sequence. For example, a given probe (e.g., detectably-labeled probes and/or the intermediate probe hybridized to the fluorescently labeled oligonucleotide (e.g., bridge probe or L-probe)) may be displaced by a subsequent probe that hybridizes to an overlapping region shared between the binding sites of the probes. In some cases, a displacement reaction can be very efficient, and thus allows for probes to be switched quickly between cycles, without the need for chemical stripping (or any of the damage to the sample that is associated therewith). In some instances, a sequence for hybridizing the subsequent or displacer probe (i.e. a toehold sequence) may be common across a plurality of probes capable of hybridizing to a given binding site. In some aspects, a single displacement probe can be used to simultaneously displace detection probes bound to an equivalent barcode position from all of the RCPs within a given sample simultaneously (with the displacement mediated by the subsequent detection probes). This may further increase efficiency and reduce the cost of the method, as fewer different probes are required.

After a signal is inactivated and/or removed, then the sample is re-hybridized in a subsequent round with a subsequent fluorescently labeled oligonucleotide, and the oligonucleotide can be labeled with the same color or a different color as the fluorescently labeled oligonucleotide of the previous cycle. In some instances, as the positions of the analytes, probes, and/or products thereof can be fixed (e.g., via fixing and/or crosslinking) in a sample, the fluorescent spot corresponding to an analyte, probe, or product thereof remains in place during multiple rounds of hybridization and can be aligned to read out a string of signals associated with each target analyte.

### Decoding:

A “decoding process” is a process comprising a plurality of decoding cycles in which different sets of barcode probes are contacted with target analytes (e.g., mRNA sequences) or target barcodes (e.g., barcodes associated with target analytes) present in a sample, and used to detect the target sequences or associated target barcodes, or segments thereof. In some instances, the decoding process comprises acquiring one or more images (e.g., fluorescence images) for each decoding cycle. Decoded barcode sequences are then inferred based on a set of physical signals (e.g., fluorescence signals) detected in each decoding cycle of a decoding process. In some instances, the set of physical signals (e.g., fluorescence signals) detected in a series of decoding cycles for a given target barcode (or target analyte sequence) may be considered a “signal signature” for the target barcode (or target analyte sequence). In some instances, a decoding process may comprise, e.g., 1, 2, 3, 4, 5, 6, 7, 8, 9, 10, or more than 10 decoding cycles. In some instances, each decoding cycle may comprise contacting a plurality of target sequences or target barcodes with 1, 2, 3, 4, 5, 6, 7, 8, 9, 10, or more than 10 barcode probes (e.g., fluorescently-labeled barcode probes) that are configured to hybridize or bind to specific target sequences or target barcodes, or segments thereof. In some instances, a decoding process may comprise performing a series of in situ barcode probe hybridization steps and acquiring images (e.g., fluorescence images) at each step. Systems and methods for performing multiplexed fluorescence in situ hybridization and imaging are described in, for example, WO 2021/127019 A1; U.S. Pat. No. 11,021,737; and PCT/EP2020/065090 (WO2020240025A1), each of which is incorporated herein by reference in its entirety.

### Anchor Probes:

In some instances, the present methods may further involve contacting the target analyte, e.g., a nucleic acid molecule, or proxy thereof with an anchor probe. In some instances, the anchor probe comprises a sequence complementary to an anchor probe binding region, which is present in all target nucleic acid molecules (e.g., in primary or secondary probes), and a detectable label. The detection of the anchor probe via the detectable label confirms the presence of the target nucleic acid molecule. The target nucleic acid molecule may be contacted with the anchor probe prior to, concurrently with, or after being contacted with the first set of detection probes. In some instances, the target nucleic acid molecule may be contacted with the anchor probe during multiple decoding cycles. In some instances, multiple different anchor probes comprising different sequences and/or different reporters may be used to confirm the presence of multiple different target nucleic acid molecules. The use of multiple anchor probes is particularly useful when detection of a large number of target nucleic acid molecules is required, as it allows for optical crowding to be reduced and thus for detected target nucleic acid molecules to be more clearly resolved

Described herein is a method applying the aforementioned techniques to reduce optical crowding in an assay. In some instances, a method can include analyzing a biological sample, by contacting the biological sample with a first number of primary probe(s) configured to hybridize to a first target nucleic acid and a second number of primary probes configured to hybridize to a second target nucleic acid, each primary probe including a target-hybridizing region configured to hybridize to a different target region in the corresponding target nucleic acid, and a barcode region, and the first number is 1 or more, and the second number is greater than the first number, contacting the biological sample with a plurality of detectable probes, wherein each detectable probe is configured to hybridize to a barcode sequence in the barcode regions of the first number of primary probe(s) and/or the second number of primary probes, or a complement of the barcode sequence, detecting a signal associated with the plurality of detectable probes or absence thereof at one or more locations in the biological sample, and contacting the biological sample with a subsequent plurality of detectable probes, wherein each detectable probe in the subsequent plurality is configured to hybridize to a subsequent barcode sequence in the barcode regions of the first number of primary probe(s) and/or the second number of primary probes, or a complement of the subsequent barcode sequence. In some instances, wherein the second number is greater than the first number, the difference is based on absolute or relative numbers of the first target nucleic acid and second target nucleic acid in a sample. In some instances, the difference between second and first number is linearly or non-linearly proportional to absolute or relative numbers of the first target nucleic acid and second target nucleic acid in a sample. In some instances, the difference is inversely proportional, where the first number is for first target nucleic acid present in greater amounts (i.e., abundant), and the greater second number is for second target nucleic acid present in lesser amounts.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Target molecules (e.g., nucleic acids, proteins, antibodies, etc.) can be detected in biological samples (e.g., one or more cells or a tissue sample) using an instrument having integrated optics and fluidics modules (an “opto-fluidic instrument” or “opto-fluidic system”). In an opto-fluidic instrument, the fluidics module is configured to deliver one or more reagents (e.g., fluorescent probes) to the biological sample and/or remove spent reagents therefrom. Additionally, the optics module is configured to illuminate the biological sample with light having one or more spectral emission curves (over a range of wavelengths) and subsequently capture one or more images of emitted light signals from the biological sample during one or more probing cycles. In various embodiments, the captured images may be processed in real time and/or at a later time to determine the presence of the one or more target molecules in the biological sample, as well as three-dimensional position information associated with each detected target molecule. Additionally, the opto-fluidics instrument includes a sample module configured to receive (and, optionally, secure) one or more biological samples. In some instances, the sample module includes an X-Y stage configured to move the biological sample along an X-Y plane (e.g., perpendicular to an objective lens of the optics module).

In various embodiments, the opto-fluidic instrument is configured to analyze one or more target molecules in their naturally occurring place (i.e., in situ) within the biological sample. For example, an opto-fluidic instrument may be an in-situ analysis system used to analyze a biological sample and detect target molecules including but not limited to DNA, RNA, proteins, antibodies, and/or the like.

A sample disclosed herein can be or be derived from any biological sample. Biological samples may be obtained from any suitable source using any of a variety of techniques including, but not limited to, biopsy, surgery, and laser capture microscopy (LCM), and generally includes cells, tissues, and/or other biological material from the subject. A biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample from a mammal. A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic subjects, subjects that have or are suspected of having a disease (e.g., an individual with a disease such as cancer) or a pre-disposition to a disease, and/or subjects in need of therapy or suspected of needing therapy.

The biological sample can include any number of macromolecules, for example, cellular macromolecules and organelles (e.g., mitochondria and nuclei). The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions.

In some embodiments, the biological sample may comprise cells or a tissue sample which are deposited on a substrate. As described herein, a substrate can be any support that is insoluble in aqueous liquid and allows for positioning of biological samples, analytes, features, and/or reagents on the support. In some embodiments, a biological sample is attached to a substrate. In some embodiments, the substrate is optically transparent to facilitate analysis on the opto-fluidic instruments disclosed herein. For example, in some instances, the substrate is a glass substrate (e.g., a microscopy slide, cover slip, or other glass substrate). Attachment of the biological sample can be irreversible or reversible, depending upon the nature of the sample and subsequent steps in the analytical method. In certain embodiments, the sample can be attached to the substrate reversibly by applying a suitable polymer coating to the substrate and contacting the sample to the polymer coating. The sample can then be detached from the substrate, e.g., using an organic solvent that at least partially dissolves the polymer coating. Hydrogels are examples of polymers that are suitable for this purpose. In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

It is to be noted that, although the above discussion relates to an opto-fluidic instrument that can be used for in situ target molecule detection via probe hybridization, the discussion herein equally applies to any opto-fluidic instrument that employs any imaging or target molecule detection technique. That is, for example, an opto-fluidic instrument may include a fluidics module that includes fluids needed for establishing the experimental conditions required for the probing of target molecules in the sample. Further, such an opto-fluidic instrument may also include a sample module configured to receive the sample, and an optics module including an imaging system for illuminating (e.g., exciting one or more fluorescent probes within the sample) and/or imaging light signals received from the probed sample. The in-situ analysis system may also include other ancillary modules configured to facilitate the operation of the opto-fluidic instrument, such as, but not limited to, cooling systems, motion calibration systems, etc.

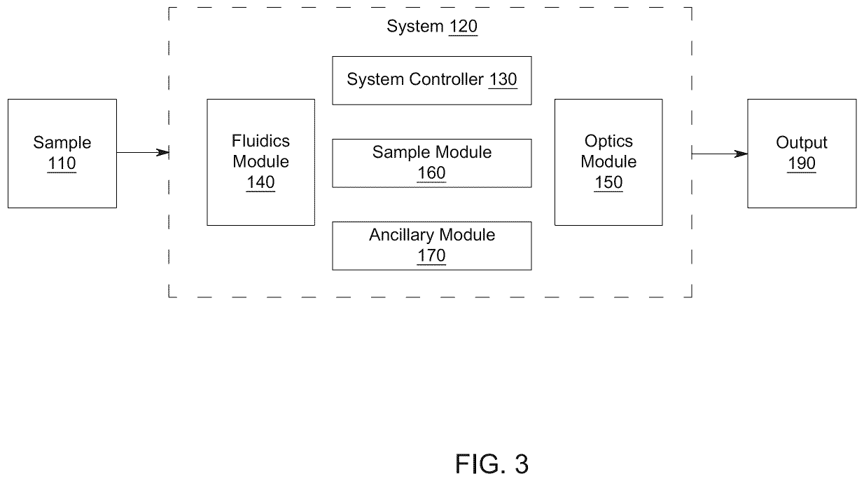

FIG. 3 shows an example workflow of analysis of a biological sample 110 (e.g., cell or tissue sample) using an opto-fluidic instrument 120, according to various embodiments. In various embodiments, the sample 110 can be a biological sample (e.g., a tissue) that includes molecules such as DNA, RNA, proteins, antibodies, etc. For example, the sample 110 can be a sectioned tissue that is treated to access the RNA thereof for labeling with circularizable DNA probes. Ligation of the probes may generate a circular DNA probe which can be enzymatically amplified and bound with fluorescent oligonucleotides, which can create bright signal that is convenient to image and has a high signal-to-noise ratio.

In various embodiments, the sample 110 may be placed in the opto-fluidic instrument 120 for analysis and detection of the molecules in the sample 110. In various embodiments, the opto-fluidic instrument 120 can be a system configured to facilitate the experimental conditions conducive for the detection of the target molecules. For example, the opto-fluidic instrument 120 can include a fluidics module 140, an optics module 150, a sample module 160, and an ancillary module 170, and these modules may be operated by a system controller 130 to create the experimental conditions for the probing of the molecules in the sample 110 by selected probes (e.g., circularizable DNA probes), as well as to facilitate the imaging of the probed sample (e.g., by an imaging system of the optics module 150). In various embodiments, the various modules of the opto-fluidic instrument 120 may be separate components in communication with each other, or at least some of them may be integrated together.

In various embodiments, the sample module 160 may be configured to receive the sample 110 into the opto-fluidic instrument 120. For instance, the sample module 160 may include a sample interface module (SIM) that is configured to receive a sample device (e.g., cassette) onto which the sample 110 can be deposited. That is, the sample 110 may be placed in the opto-fluidic instrument 120 by depositing the sample 110 (e.g., the sectioned tissue) on a sample device that is then inserted into the SIM of the sample module 160. In some instances, the sample module 160 may also include an X-Y stage onto which the SIM is mounted. The X-Y stage may be configured to move the SIM mounted thereon (e.g., and as such the sample device containing the sample 110 inserted therein) in perpendicular directions along the two-dimensional (2D) plane of the opto-fluidic instrument 120.

The experimental conditions that are conducive for the detection of the molecules in the sample 110 may depend on the target molecule detection technique that is employed by the opto-fluidic instrument 120. For example, in various embodiments, the opto-fluidic instrument 120 can be a system that is configured to detect molecules in the sample 110 via hybridization of probes. In such cases, the experimental conditions can include molecule hybridization conditions that result in the intensity of hybridization of the target molecule (e.g., nucleic acid) to a probe (e.g., oligonucleotide) being significantly higher when the probe sequence is complementary to the target molecule than when there is a single-base mismatch. The hybridization conditions include the preparation of the sample 110 using reagents such as washing/stripping reagents, hybridizing reagents, etc., and such reagents may be provided by the fluidics module 140.

In various embodiments, the fluidics module 140 may include one or more components that may be used for storing the reagents, as well as for transporting said reagents to and from the sample device containing the sample 110. For example, the fluidics module 140 may include reservoirs configured to store the reagents, as well as a waste container configured for collecting the reagents (e.g., and other waste) after use by the opto-fluidic instrument 120 to analyze and detect the molecules of the sample 110. Further, the fluidics module 140 may also include pumps, tubes, pipettes, etc., that are configured to facilitate the transport of the reagent to the sample device (e.g., and as such the sample 110). For instance, the fluidics module 140 may include pumps (“reagent pumps”) that are configured to pump washing/stripping reagents to the sample device for use in washing/stripping the sample 110 (e.g., as well as other washing functions such as washing an objective lens of the imaging system of the optics module 150).

In various embodiments, the ancillary module 170 can be a cooling system of the opto-fluidic instrument 120, and the cooling system may include a network of coolant-carrying tubes that are configured to transport coolants to various modules of the opto-fluidic instrument 120 for regulating the temperatures thereof. In such cases, the fluidics module 140 may include coolant reservoirs for storing the coolants and pumps (e.g., “coolant pumps”) for generating a pressure differential, thereby forcing the coolants to flow from the reservoirs to the various modules of the opto-fluidic instrument 120 via the coolant-carrying tubes. In some instances, the fluidics module 140 may include returning coolant reservoirs that may be configured to receive and store returning coolants, i.e., heated coolants flowing back into the returning coolant reservoirs after absorbing heat discharged by the various modules of the opto-fluidic instrument 120. In such cases, the fluidics module 140 may also include cooling fans that are configured to force air (e.g., cool and/or ambient air) into the returning coolant reservoirs to cool the heated coolants stored therein. In some instance, the fluidics module 140 may also include cooling fans that are configured to force air directly into a component of the opto-fluidic instrument 120 so as to cool said component. For example, the fluidics module 140 may include cooling fans that are configured to direct cool or ambient air into the system controller 130 to cool the same.

As discussed above, the opto-fluidic instrument 120 may include an optics module 150 which include the various optical components of the opto-fluidic instrument 120, such as but not limited to a camera, an illumination module (e.g., light source such as LEDs), an objective lens, and/or the like. The optics module 150 may include a fluorescence imaging system that is configured to image the fluorescence emitted by the probes (e.g., oligonucleotides) in the sample 110 after the probes are excited by light from the illumination module of the optics module 150.

In some instances, the optics module 150 may also include an optical frame onto which the camera, the illumination module, and/or the X-Y stage of the sample module 160 may be mounted.

In various embodiments, the system controller 130 may be configured to control the operations of the opto-fluidic instrument 120 (e.g., and the operations of one or more modules thereof). In some instances, the system controller 130 may take various forms, including a processor, a single computer (or computer system), or multiple computers in communication with each other. In various embodiments, the system controller 130 may be communicatively coupled with data storage, set of input devices, display system, or a combination thereof. In some cases, some or all of these components may be considered to be part of or otherwise integrated with the system controller 130, may be separate components in communication with each other, or may be integrated together. In other examples, the system controller 130 can be, or may be in communication with, a cloud computing platform.

In various embodiments, the opto-fluidic instrument 120 may analyze the sample 110 and may generate the output 190 that includes indications of the presence of the target molecules in the sample 110. For instance, with respect to the example embodiment discussed above where the opto-fluidic instrument 120 employs a hybridization technique for detecting molecules, the opto-fluidic instrument 120 may cause the sample 110 to undergo successive rounds of fluorescent probe hybridization (using two or more sets of fluorescent probes, where each set of fluorescent probes is excited by a different color channel) and be imaged to detect target molecules in the probed sample 110. In such cases, the output 190 may include optical signatures (e.g., a codeword) specific to each gene, which allow the identification of the target molecules.

In some instances, an assembly for transilluminating a substrate can include a sample carrier device (e.g., a microfluidic chip or glass slide), a thermal control module configured to control the temperature of the sample carrier device (e.g., a thermoelectric module), and a light source configured to illuminate the sample carrier device. In some instances, the assembly includes a heat exchanger (e.g., a fluid block having a cooling fluid flowing therethrough). In some instances, an assembly for transilluminating can include sample carrier device (e.g., a sample substrate), an optically transparent substrate, a light source configured to illuminate the optically transparent substrate, a light scattering layer configured to scatter light from the light source, and/or a thermal control module configured to control the temperature of the sample carrier device and/or optically transparent substrate.

In some embodiments, the sample carrier device (e.g., a cassette) can be configured to receive a sample. In some embodiments, the sample carrier device can include one or more microfluidic channels, e.g., sample chambers or microfluidic channels etched into a planar substrate or chambers within a flow cell or microfluidic device.

A sample carrier device for the systems disclosed herein can include, but is not limited to, a substrate configured to receive a sample, a microscope slide and/or an adapter configured to mount microscope slides (with or without coverslips) on a microscope stage or automated stage (e.g., an automated translation or rotational stage), a substrate, and/or an adapter configured to mount slides on a microscope stage or automated stage, a substrate comprising etched sample containment chambers (e.g., chambers open to the environment) and/or an adapter configured to mount such substrates on a microscope stage or automated stage, a flow cell and/or an adapter configured to mount flow cells on a microscope stage or automated stage, or a microfluidic device and/or an adapter configured to mount microfluidic devices on a microscope stage or automated stage. In some embodiments, the sample carrier device further includes a cassette configured to secure a substrate (e.g., a glass slide). In some embodiments, the cassette includes two or more components (e.g., a top half and a bottom half) into which the substrate is secured.

In some instances, the one or more sample carrier devices can be designed for performing a variety of chemical analysis, biochemical analysis, nucleic acid analysis, cell analysis, or tissue analysis applications. In some instances, for example, the sample carrier device (e.g., flow cells and microfluidic devices) may comprise a sample, e.g., a tissue sample. In some instances, the sample carrier device (e.g., flow cells and microfluidic devices) may comprise a sample, e.g., a tissue sample, placed in contact with, e.g., a substrate (e.g., a surface of the flow cell or microfluidic device).

The sample carrier devices for the disclosed systems (e.g., microscope slides, substrates comprising one or more etched microfluidic channel, flow cells or microfluidic devices comprising one or more microfluidic channels, etc.) can be fabricated from any of a variety of materials known to those of skill in the art including, but not limited to, glass (e.g., borosilicate glass, soda lime glass, etc.), fused silica (quartz), silicon, polymer (e.g., polystyrene (PS), macroporous polystyrene (MPPS), polymethylmethacrylate (PMMA), polycarbonate (PC), polypropylene (PP), polyethylene (PE), high density polyethylene (HDPE), cyclic olefin polymers (COP), cyclic olefin copolymers (COC), polyethylene terephthalate (PET), polydimethylsiloxane (PDMS), etc.), polyetherimide (PEI) and perfluoroelastomer (FFKM) as more chemically inert alternatives, or any combination thereof. FFKM is also known as Kalrez.

The one or more materials used to fabricate sample carrier devices for the disclosed systems (e.g., substrates configured to receive a sample, microscope slides, substrates comprising one or more etched microfluidic channels, flow cells or microfluidic devices comprising one or more microfluidic channels or sample chambers, etc.) can be optically transparent to facilitate use with spectroscopic or imaging-based detection techniques. In some instances, the entire sample carrier device can be optically transparent. Alternatively, in some instances, only a portion of the sample carrier device (e.g., an optically transparent “window”) can be optically transparent.

The sample carrier devices for the disclosed systems (e.g., substrates configured to receive a sample, microscope slides, substrates comprising one or more etched microfluidic channels, flow cells or microfluidic devices comprising one or more microfluidic channels or sample chambers, etc.) can be fabricated using any of a variety of techniques known to those of skill in the art, where the choice of fabrication technique is often dependent on the choice of material used, and vice versa. Examples of suitable sample carrier device fabrication techniques include, but are not limited to, extrusion, drawing, precision computer numerical control (CNC) machining and boring, laser photoablation, photolithography in combination with wet chemical etching, deep reactive ion etching (DRIE), micro-molding, embossing, 3D-printing, thermal bonding, adhesive bonding, anodic bonding, and the like (see, e.g., Gale, et al. (2018), “A Review of Current Methods in Microfluidic Device Fabrication and Future Commercialization Prospects”, Inventions 3, 60, 1-25, which is hereby incorporated by reference in its entirety).

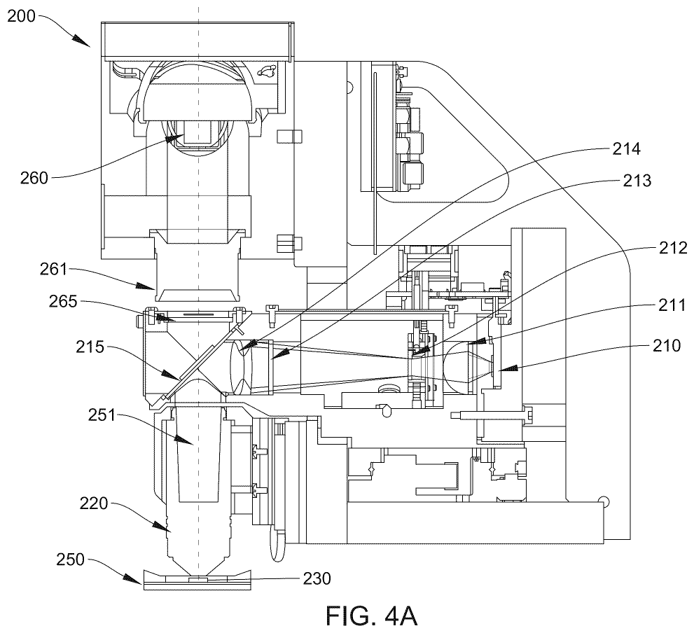

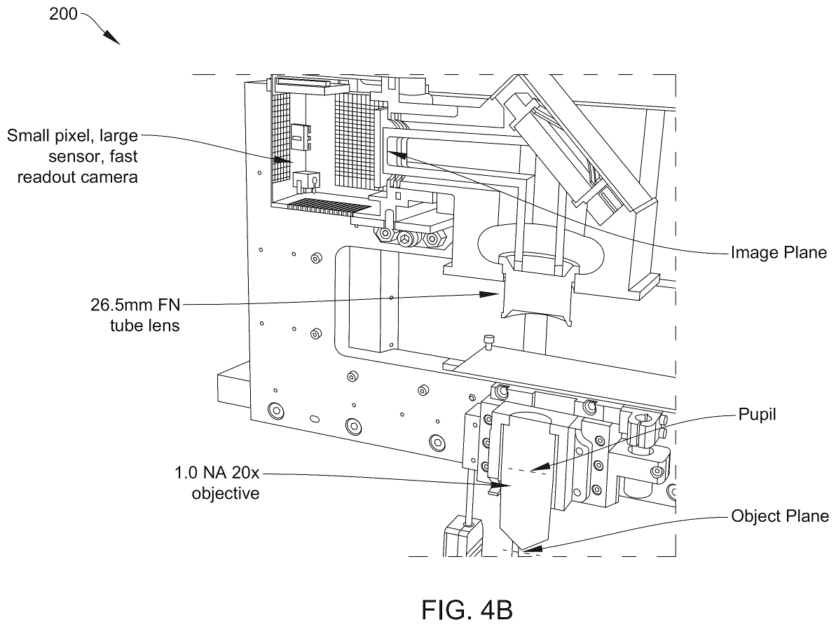

FIG. 4A illustrates a cross-sectional view of an optics module 200 in an imaging system. One or more illumination sources 210, e.g., one or more light emitting diodes (LEDs), provides light through one or more optical components and an objective lens 220 to thereby illuminate a sample 250. In various embodiments, the optical components include a collimator 211. In various embodiments, the optical components include a field stop 212. In various embodiments, the optical components include one or more excitation filters 213. In various embodiments, the one or more excitation filters 213 are configured to filter light from the illumination source(s) 210 for a predetermined range of wavelengths (e.g., each filter has one or more blocking band(s) and/or transmission band(s) that may be different or may overlap at least in part) and each excitation filter 213 is aligned with appropriate illumination sources (e.g., blue LEDs, green LEDs, yellow LEDs, red LEDs, ultraviolet LEDs, etc.). In various embodiments, the optical components include a condenser 214. In various embodiments, the optical components include a beam splitter 215. An optical axis 251 is illustrated extending through the center of the optical surfaces in the objective lens 220 and its path includes an image plane, a focal plane, and input/output pupils (illustrated in FIG. 4B).

A sensor array 260 (e.g., CMOS sensor) receives light signals from the sample 250. In various embodiments, the optical components include one or more emission filters 265. In various embodiments, the one or more emission filters 265 are configured to filter light from the sample (e.g., emitted from one or more fluorophores, autofluorescence, etc.) for a predetermined range of wavelengths (e.g., each filter has one or more blocking band(s) and/or transmission band(s) that may be different or may overlap at least in part). In various embodiments, the emission filters 265 align (e.g., via motorized translation) with optics and/or the sensor array. In various embodiments, the sample 250 is probed with fluorescent probes configured to bind to a target (e.g., DNA or RNA) that, when illuminated with a particular wavelength (or range of wavelengths) of light, emit light signals that can be detected by the sensor array 260. In various embodiments, the sample 250 is repeatedly probed with two or more (e.g., two, three, four, five, six, etc.) different sets of probes. In various embodiments, each set of probes corresponds to a specific color (e.g., blue, green, yellow, or red) such that, when illuminated by that color, probes bound to a target emit light signals. In some embodiments, the sensor array 260 is aligned with the optical axis 251 of the objective lens 220 (i.e., the optical axis of the camera is coincident with and parallel to the optical axis of the objective lens 220). In various embodiments, the sensor array 260 is positioned perpendicularly to the objective lens 220 (i.e., the optical axis of the camera is perpendicular to and intersects the optical axis of the objective lens 220). In various embodiments, a tube lens 261 is mounted in the optical path to focus light on the sensor array 260 thereby allowing for image formation with infinity-corrected objectives. Descriptions of optical modules and illumination assemblies for use in opto-fluidic instruments can be found in U.S. provisional patent application No. 63/427,282, filed on Nov. 22, 2022, titled “Systems and Methods for Illuminating a Sample” and U.S. provisional patent application No. 63/427,360, file on Nov. 22, 2022, titled “Systems and Methods for Imaging Samples,” each of which is incorporated by reference in its entirety.

In various embodiments, the sample is illuminated with one or more wavelengths configured to induce fluorescence in the sample. In various embodiments, the sample is probed during one or more probing cycles with one or more fluorescent probes configured to bind to one or more target analytes. In various embodiments, the one or more wavelengths are selected to induce fluorescence in a subset of the one or more fluorescent probes. In various embodiments, each probing cycle includes illumination with two or more (e.g., four) colors of light. In various embodiments, the sample is treated with a fluorescent stain configured to illuminate one or more structures within the sample. In various embodiments, the sample is contacted with a nuclear stain. In various embodiments, the sample is contacted with 4′,6-diamidino-2-phenylindole (“DAPI”) configured to bind to adenine-thymine-rich regions in DNA. In various embodiments, illumination of the sample causes autofluorescence of the sample. In various embodiments, autofluorescence is the natural emission of light by biological structures when they have absorbed light, and may be used to distinguish the light originating from artificially added fluorescent markers. In various embodiments, fluorescence of the sample through fluorescent probes, autofluorescence, and/or a fluorescent stain can be used with the methods described herein to determine one or more focus metrics of a tissue sample.

In various embodiments, the sample is illuminated via edge lighting or transillumination along one or more edges of the sample and/or sample substrate. In various embodiments, the edge lighting provides dark-field illumination of the sample. In various embodiments, edge lighting is provided by one or more light sources positioned to provide light substantially perpendicular to a normal of the substrate surface on which the sample is disposed. In various embodiments, the substrate is a glass slide. In various embodiments, the substrate is configured as a wave guide to thereby guide light emitted from the edge lighting towards the sample. In various embodiments, illumination of the sample via edge lighting can be used with the methods described herein to determine one or more focus metrics of a tissue sample.

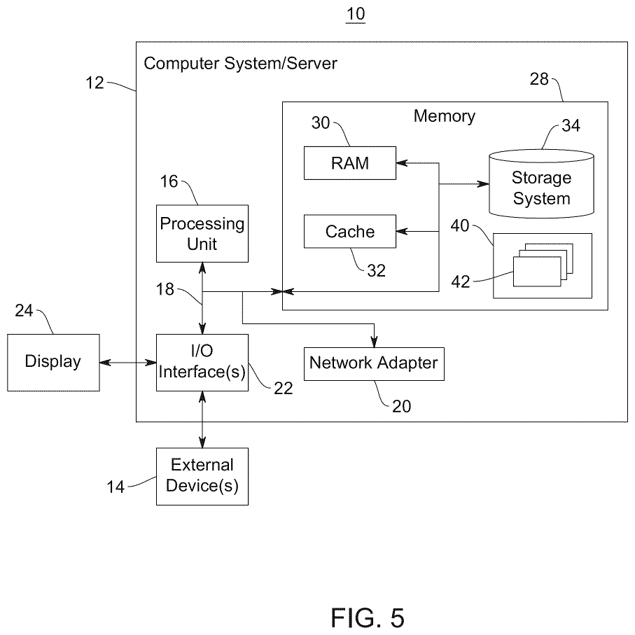

Referring now to FIG. 5, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

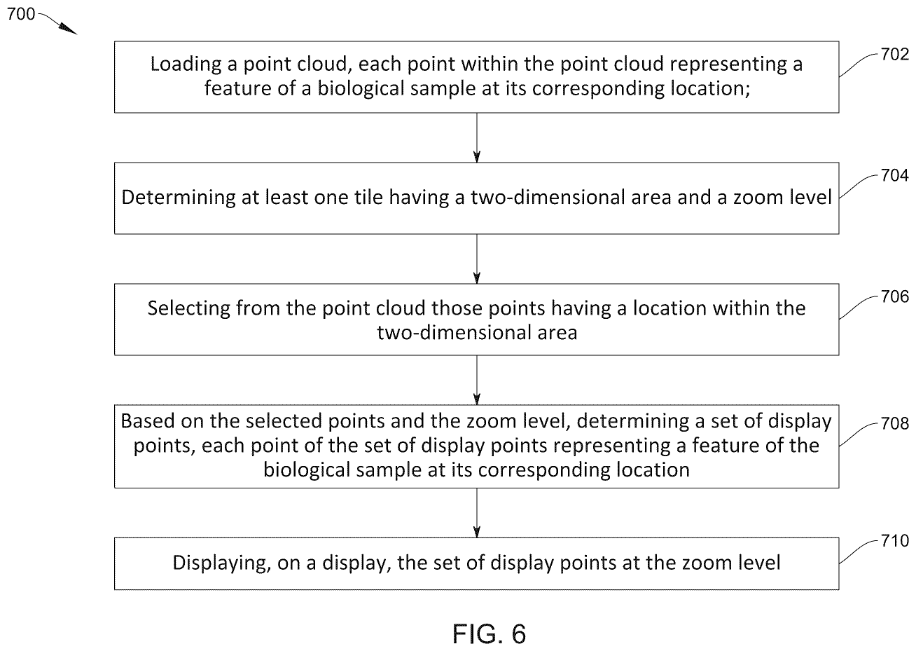

Referring to FIG. 6, an exemplary method 700 of data visualization according to embodiments of the present disclosure is illustrated. In some aspects, provided herein are methods comprising: 702, loading a point cloud, wherein each point within the point cloud representing a feature of a biological sample at its corresponding location; 704, determining at least one tile having a two-dimensional area and a zoom level; 706, selecting from the point cloud those points having a location within the two-dimensional area; 708, based on the selected points and the zoom level, determining a set of display points, each point of the set of display points representing a feature of the biological sample at its corresponding location; and, 710, providing the set of display points for display at the zoom level.

In some embodiments, the points having a location within the two-dimensional area are further filtered based on a user input. For example, a user may select one or more gene of interest, and the points may be filtered to those representing the one or more gene of interest. In some embodiments, each of the set of display points is assigned an icon. For example, the icon may be assigned based on properties of the points such as the genes that they represent.

In some embodiments, determining the set of display points comprises randomly subsampling the selected points based on the zoom level. In some such embodiments, randomly subsampling the selected points comprises removing approximately half of the selected points. Random subsampling of the selected points may comprise removing a portion of the selected points proportionate to the zoom level.

In some embodiments, determining the set of display points comprises clustering the selected points based on the zoom level, yielding a plurality of clusters; and defining a display point for each of the plurality of clusters. Clustering of the selected points may be done by means known in the art, and may comprise performing DBSCAN clustering, OPTICS clustering, K-Means clustering, or the like.

In some embodiments of the invention, defining each point comprises determining a summary statistic for the corresponding cluster. Such summary statistics may comprise a count of the points within the corresponding cluster. In some such embodiments, each display point has a visual attribute corresponding to the summary statistic. Said visual attribute may be a size or color.

Embodiments of the invention disclosed herein further comprise displaying the set of display points on a display. In some such embodiments, displaying the set of display points comprises superimposing the set of display points on an image of the biological sample. Said superimposing may comprise registering the set of display points to the image of the biological sample.

In some embodiments, the set of display points is determined at a server side in response to a request from a remote client, and wherein providing the set of display points for display comprises sending the display points from the server to the remote client.

In some embodiments, wherein the at least one tile comprises a plurality of tiles together defining a display port on a GUI.

The invention disclosed herein, may further comprise receiving an adjusted zoom level; based on the adjusted zoom level, determining at least one additional tile having an adjusted two-dimensional area at the adjusted zoom level; selecting from the point cloud those points having a location within the adjusted two-dimensional area; based on the selected points having a location within the adjusted two-dimensional area and the adjusted zoom level, determining an adjusted set of display points, each point of the adjusted set of display points representing a feature of the biological sample at its corresponding location; and providing the adjusted set of display points for display at the adjusted zoom level.

In some aspects of the invention, provided herein are systems comprising: a computing node comprising at least one computer-readable storage medium having program instructions stored thereon, the program instructions executable by at least one processor of the computing node to cause the at least one processor to perform a method comprising: loading a point cloud, each point within the point cloud representing a feature of a biological sample at its corresponding location; determining at least one tile having a two-dimensional area and a zoom level; selecting from the point cloud those points having a location within the two-dimensional area; based on the selected points and the zoom level, determining a set of display points, each point of the set of display points representing a feature of the biological sample at its corresponding location; and displaying, on a display, the set of display points at the zoom level.

In some embodiments, determining the set of display points comprises randomly subsampling the selected points based on the zoom level. In some such embodiments, the randomly subsampling the selected points comprises removing approximately half of the selected points. The randomly subsampling the selected points may comprise removing a portion of the selected points proportionate to the zoom level.

In some embodiments, determining the set of display points comprises; clustering the selected points based on the zoom level, yielding a plurality of clusters; and defining a display point for each of the plurality of clusters. Clustering of the selected points may be done by means known in the art, and may comprise performing DBSCAN clustering, OPTICS clustering, K-Means clustering, or the like.

In some embodiments, defining each point comprises determining a summary statistic for the corresponding cluster. In some such embodiments, the summary statistic comprises a count of the points within the corresponding cluster.

In some embodiments, each display point has a visual attribute corresponding to the summary statistic. Such visual attributes may be a size or color.

Embodiments of the invention further comprise displaying the set of display points on a display. In some such embodiments, displaying the set of display points comprises superimposing the set of display points on an image of the biological sample. Said superimposing may comprise registering the set of display points to the image of the biological sample.

In some embodiments, the set of display points is determined at a server side in response to a request from a remote client, and wherein providing the set of display points for display comprises sending the display points from the server to the remote client.

In some embodiments, the at least one tile comprises a plurality of tiles together defining a display port on a GUI.

Embodiments of the invention my further comprise: receiving an adjusted zoom level; based on the adjusted zoom level, determining at least one additional tile having an adjusted two-dimensional area at the adjusted zoom level; selecting from the point cloud those points having a location within the adjusted two-dimensional area; based on the selected points having a location within the adjusted two-dimensional area and the adjusted zoom level, determining an adjusted set of display points, each point of the adjusted set of display points representing a feature of the biological sample at its corresponding location; and providing the adjusted set of display points for display at the adjusted zoom level.

In other aspects of the invention, provided herein are computer program products comprising a computer readable storage medium having program instructions embodied therewith, the program instructions executable by a processor to cause the processor to perform a method. Said methods may comprise loading a point cloud, each point within the point cloud representing a feature of a biological sample at its corresponding location; determining at least one tile having a two-dimensional area and a zoom level; selecting from the point cloud those points having a location within the two-dimensional area; based on the selected points and the zoom level, determining a set of display points, each point of the set of display points representing a feature of the biological sample at its corresponding location; displaying, on a display, the set of display points at the zoom level.

In various embodiments, determining the set of display points comprises randomly subsampling the selected points based on the zoom level. Said random subsampling of the selected points may comprise removing approximately half of the selected points. In some such embodiments, randomly subsampling the selected points comprises removing a portion of the selected points proportionate to the zoom level.

In some embodiments, determining the set of display points comprises; clustering the selected points based on the zoom level, yielding a plurality of clusters; and defining a display point for each of the plurality of clusters. Clustering of the selected points may be done by means known in the art, and may comprise performing DBSCAN clustering, OPTICS clustering, K-Means clustering, or the like.

In some embodiments, defining each point comprises determining a summary statistic for the corresponding cluster. In some such embodiments, the summary statistic comprises a count of the points within the corresponding cluster.

In various embodiments, each display point has a visual attribute corresponding to the summary statistic. Such visual attributes may include a size or color.

Embodiments of the invention may further comprise displaying the set of display points on a display. Said displaying of the set of display points may comprise superimposing the set of display points on an image of the biological sample. Superimposing may comprise registering the set of display points to the image of the biological sample. In some embodiments, the set of display points is determined at a server side in response to a request from a remote client, and wherein providing the set of display points for display comprises sending the display points from the server to the remote client.

In various embodiments, the at least one tile comprises a plurality of tiles together defining a display port on a GUI.

Embodiments of the invention disclosed herein further comprise receiving an adjusted zoom level; based on the adjusted zoom level, determining at least one additional tile having an adjusted two-dimensional area at the adjusted zoom level; selecting from the point cloud those points having a location within the adjusted two-dimensional area; based on the selected points having a location within the adjusted two-dimensional area and the adjusted zoom level, determining an adjusted set of display points, each point of the adjusted set of display points representing a feature of the biological sample at its corresponding location; and providing the adjusted set of display points for display at the adjusted zoom level.

### Feature Pyramids and Clustering Approaches:

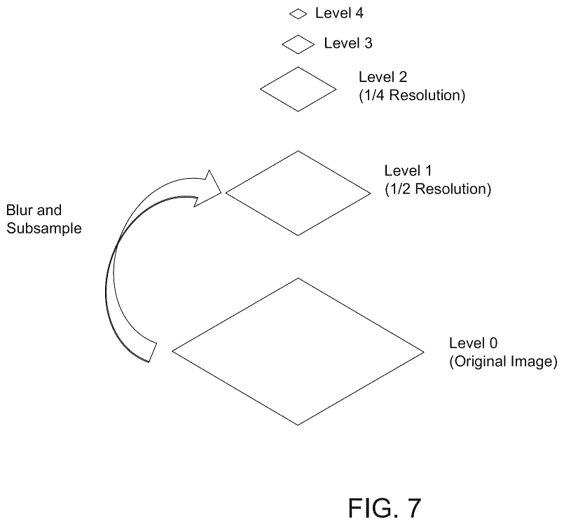

The notion of pyramiding in data is typically associated with images. Progressive jpegs were among some of the first widespread usages of image pyramiding in the 1990s when the internet was connected to via dial-up and DSL. Interlaced gifs worked under a similar premise of progressively loading enough of an image to show the user a representative image, and over time the level of detail has increased. For example, a multiscale image may be progressively subsampled at different levels up to a certain level (or to a point where there is only a 1×1 image and cannot be subsampled any more). As shown in FIG. 7, zooming out of an original image (level 0) to successively lower resolution levels can be achieved by blurring and subsampling the original image (level 0) to a level 1 image (e.g., that is ½ original image resolution), optionally blurring and subsampling the level 1 image to a level 2 image (e.g., that is ¼ original image resolution), optionally blurring and subsampling the level 2 image to a level 3 image (e.g., that is ⅛ original resolution), and optionally blurring and subsampling the level 3 image to a level 4 image (e.g., that is 1/16 original resolution).

While internet speeds have vastly increased, so have the sizes of certain images. For example, cartography, astronomy, and microscopy all involve very large images. To answer the needs of the end user trying to view large amounts of data, image formats and protocols such as DZI, OSM, TMS, Zoomify, and IIIF have emerged. These technologies assume that the end user will not ever be interested in viewing every pixel. Thus, they allow the end user to view a small preview of the whole image and zoom in to what they want to view in detail, and will only deliver the data that the user actually wants to view. The benefit of these multiscale image formats/protocols is in limiting the amount of data that needs to be delivered, allowing a user near instant access to what can be many gigabytes or terabytes of data.

One thing that all of these formats/protocols have in common is that the images are not only split up into pyramids at each level, but that image data is binned such that it is easy to access the data that the user wants to view and not much else. For example, it is not necessary to load every pixel of the top-left part of the image if the user is only interested in the bottom-right. These formats need to be tuned properly, selecting a tile size that will most appropriately fit the needs of the expected use case and size of the image data. Not only is the amount of data transferred limited, but also the number of transfers that need to happen to render that data. One consideration for image data is the expected size of the viewport wherein the end user views the image data.

Feature data, i.e., points at different positions in an image or collection of images, with some data associated with each point, can be visualized by applying the notion of pyramiding. Such feature data may include, without limitation, position data (x,y), Z-slice, decoded feature names (i.e., Acta2, Den, Kcnj8, etc.), radius (x/y), Q-score, and signal-to-noise. A point cloud refers to a group of points, each having a location in two or three dimensions.

Said pyramiding may be deployed through a data analysis pipeline system that proceeds in a step-by-step fashion, in which the inputs to the later steps include (but are not limited to) the outputs from the earlier steps. Some of the steps may be executed concurrently. A pipeline management system comprises all of the functionality that makes such a pipeline (e.g., data analysis pipeline) work, other than the actual software packages that do the processing. This may include execution of the algorithms on the data, but also, and not limited to, such activities as: routing logging messages to the correct destinations; automatically executing the next step when the current step has completed; ensuring that the pipeline does the right thing when an exception occurs; providing a user interface so that operators can control and monitor activities; managing a datastore of inputs and results; and providing persistence for all of the records that need to be preserved across time. In preferred embodiments, such pyramiding and visualization is applied via a data analysis pipeline system that applies pyramiding to feature data to a limited extent. Data are divided into a grid and past a certain zoom level (zoomed-in), for a given x/y target the data for the current grid position are displayed. When zoomed-out far enough, a density view is shown that gives an overview of all feature data. The feature data are loaded on-demand, as needed from Zarr files and density data are precalculated for faster loading. Additionally, in some embodiments, lazy-loading of data in chunks of predetermined size is provided from a “data grid” when zoomed in. In most use cases, there is no point at which an end user will be able to view every feature at once, nor is that necessary because a typical user might be interested in a small region, which they can then zoom in to and view in greater detail. It will be appreciated that while various embodiments employ Zarr, other data formats such as HDF5 are suitable for use as described herein.

### Building a Feature Pyramid:

Disclosed herein is a generalized approach for constructing and employing features pyramids.

### Expressing Feature Data in Tiles:

Beginning at the base of the pyramid, the feature data are split into “tiles” or bins. Briefly, the min/max dimensions of all feature positions are acquired, and an appropriate tile size is selected to create an array of empty tiles. This is iterated over the data and each feature (or an index/reference to it) is binned to a tile position. The tile size can be divided by 2\hat{ }zoomLevel to get the actual size of the bins. This is represented in Javascript as:

```
const currTileSize = tileSize / Math.pow(2, zoomLevel);
const cols = Math.ceil((maxX − minX) / currTileSize);
const rows = Math.ceil((maxY − minY) / currTileSize);
const tiles = getEmptyTiles(rows, cols); // Create an empty 2d array
for (let i = 0; i < featureDataPositions.length; i++) {
  const col = Math.floor((featureDataPositions[i][0] − minX) / currTileSize);
  const row = Math.floor((featureDataPositions[i][1] − minY) / currTileSize);
  tiles[row][col].push({
    position: featureDataPositions[i],
  });
}
```

The result is a two-dimensional array of tiles, such that one can access all of the feature data belonging to a single tile by accessing tiles[y][x] for a tile position x/y. This data can then be rendered using a rendering tool, such as the deck.gl TileLayer.

The binned data of each tile may be stored in storage formats that already exist. In some embodiments, the data are stored as any one of:
DZI: comprising an XML file containing some specifications such as format (i.e. jpg, png, etc.) tile size, overlap, and total size; and a directory of image files stored in the format zoomLevel/tileX_tileY.imageExt, resulting in files such as, “/0/0_0.jpg” or “/11/3_3.png”, etc;
Zoomify: comprising an API to describe the specification and images that are stored in a single directory (i.e., TileGroup0) and named zoomLevel-tileX-tileY.imageExt, resulting in files such as, “/TileGroup0/0-0-0.jpg” or “/TileGroup/4-4-6.jpg”;
OME-ZARR: Information about the OME-ZARR format can be found in Moore, et al., “Next-generation file formats (NGFF),” openmicroscopy.org, Sep. 15, 2023; incorporated herein by reference in its entirety. This format benefits from the fact that the Zarr format is already inherently chunked, and can be done so in an optimal way for a particular size, but also leaves room to experiment with different tile sizes on the client side.

In some embodiments, the preferred format is OME-ZARR (Zarr). For purposes of exemplification, a Python script that will bin some data in connection with the first zoom level (the base of the pyramid) and store it in tiles, following the Zoomify format, can be written as follows:

```
def gen_pyramid0(
  feature_data_path: str = “feature_data.bin.gz”,
  output_dir: str = “out/”,
  tile_size: int = 1024,
):
  # Prepare output directory
  pathlib.Path(output_dir).mkdir(parents=True, exist_ok=True)
  # Load data
  with gzip.open(feature_data_path, “rb”) as f:
    feature_data = np.frombuffer(f.read( ), dtype=“float32”)
  # Get positions from interlaced feature data
  positions = np.column_stack([feature_data[0::6], feature_data[1::6]])
  # Calculate min/max for positions
  x_min = np.min(positions[:, 0])
  x_max = np.max(positions[:, 0])
  y_min = np.min(positions[:, 1])
  y_max = np.max(positions[:, 1])
  # Get the number of rows and columns
  cols = int(np.ceil((x_max − x_min) / tile_size))
  rows = int(np.ceil((y_max − y_min) / tile_size))
  # Make empty tiles
  tiles = [[[ ] for col in range(cols)] for row in range(rows)]
  # Fill the tiles with indices of positions
  for idx, position in enumerate(positions);
    col = int(np.floor((position[0] − x_min) / tile_size))
    row = int(np.floor((position[1] − y_min) / tile_size))
    tiles[row][col].append(idx)
  # For each row/col, collect the positions and output the data to a file
  for row, col in [(row, col) for col in range(cols) for row in range(rows)]:
    print(f“writing [{col}, {row}]”, end=“ ... ”)
    indices = tiles[row][col]
    tile_positions = np.take(positions, indices, axis=0)
    with gzip.open(os.path.join(output_dir, f“0-{row}-{col}.bin.gz”), “wb”) as f:
      f.write(tile_positions.tobytes( ))
    print(“done”)
```

The above function gen_pyramid0 will take an input as a path to some feature data. This is data that has been extracted from sample data and is in an interlaced format where the position data is in the first two indices, resulting in a list of positions after the data is loaded. The min/max for all positions is taken, empty tiles in a 2d array are created, and the tiles are populated with indices of the positions. The result is written to a set of files, one tile (or “bin”) per file, named as 0-{row}-{col}.bin.gz (the naming convention used by Zoomify, for example sake, but could be arbitrarily any format that includes x,y,z in the name). The result is all of the same input data, but in individual tiles.

The data may be stored in the gzip format and the raw bytes tile_positions.tobytes( ) are written to the file handle for each tile position. Accordingly, the data can be panned through, at full zoom, without actually loading all of the data.

Building up from the base of the pyramid involves subsampling at each layer, essentially averaging on groups of four pixels at a time. However, feature data (i.e., points in space) provides other options to consider. In some embodiments, building the next level in the pyramid comprises removing every other point, done recursively for every level, to result in a pyramid where every level contains half as much information as the previous level. This may be represented in Javascript as shown below. In some embodiments, the number of points is reduced by a factor of four per level in order to maintain feature density constant.:

```
  const filterEvens = (v: any, i: number) => i % 2 === 0;
  const rows = Math.ceil(prevZoomLevelData.length / 2);
  const cols = Math.ceil(prevZoomLevelData[0].length / 2);
  const tiles = getEmptyTiles(rows, cols);
  for (let row = 0; row < rows; row++) {
    for (let col = 0; col < cols; col++) {
      const prevRow = row * 2;
      const prevCol = col * 2;
      // Copy approximately half of the data from the previous zoom level
      tiles[row][col] = [
        ...prevZoomLevelData[prevRow][prevCol].filter(filterEvens),
        ...(prevZoomLevelData[prevRow + 1]?.[prevCol] ?? [ ]).filter(filterEvens),
        ...(prevZoomLevelData[prevRow][prevCol + 1] ?? [ ]).filter(filterEvens),
        ...(prevZoomLevelData[prevRow + 1]?.[prevCol + 1] ??
[ ]).filter(filterEvens),
      ];
    }
  }
```

As exemplified in the above Javascript, the previous zoom level's data is being taken and every other point (filterEvens) is being picked out from a set of four tiles that now all exist inside a single tile (i.e., every four tiles from zoom level n−1 become one tile for zoom level n.

The full feature pyramid can be built similar to the Python zoomify-like output, as follows:

```
import gzip
from operator import pos
import os
import pathlib
import fire
import numpy as np
def get_tile_data(positions, tile_size, x_min, x_max, y_min, y_max):
  # Get the number of rows and columns
  cols = int(np.ceil((x_max − x_min) / tile_size))
  rows = int(np.ceil((y_max − y_min) / tile_size))
  # Make empty tiles
  tiles = [[[ ] for col in range(cols)] for row in range(rows)]
  # Fill the tiles with indices of positions
  for idx, position in enumerate(positions):
    col = int(np.floor((position [0] − x_min) / tile_size))
    row = int(np.floor((position[1] − y_min) / tile_size))
    tiles[row][col].append(idx)
  # For each row/col, collect the positions and output the data to a file
  for row, col in [(row, col) for col in range(cols) for row in range(rows)]:
    indices = tiles[row][col]
    tile_positions = np.take(positions, indices, axis=0)
    yield row, col, tile_positions
def gen_pyramids(
  feature_data_path: str = “feature_data.bin.gz”,
  output_dir: str = “out/”,
  max_zoom: int = 0,
  min_zoom: int = −8,
  tile_size: int = 1024,
):
  # Prepare output directory
  pathlib.Path(output_dir).mkdir(parents=True, exist_ok=True)
  # Load data
  with gzip.open(feature_data_path, “rb”) as f:
    feature_data = np.frombuffer(f.read( ), dtype=“float32”)
  # Get positions from interlaced feature data
  positions = np.column_stack([feature_data[0::6], feature_data[1::6]])
  # Calculate min/max for positions
  x_min = np.min(positions[:, 0])
  x_max = np.max(positions[:, 0])
  y_min = np.min(positions[:, 1])
  y_max = np.max(positions[:, 1])
  # Start at the max zoom level and decrease
  for zoom_level in range(max_zoom, min_zoom, −1):
    # Adjust the tile size for the current zoom level
    curr_tile_size = tile_size / np.power(2., zoom_level)
    # Subsample the position data by taking every n'th position, where n =
2\hat{ }(max_zoom − zoom_level)
    curr_positions = positions[::int(np.power(2., max_zoom − zoom_level))]
    print(f“zoom_level={zoom_level} curr_tile_size={curr_tile_size} total
positions sampled={len(curr_positions)}”)
    for row, col, tile_positions in get_tile_data(curr_positions, curr_tile_size,
x_min, x_max, y_min, y_max):
      filename = f“{zoom_level}-{col}-{row}.bin.gz”
      with gzip.open(os.path.join(output_dir, filename), “wb”) as f:
        f.write(tile_positions.tobytes( ))
      print(f“wrote {filename}”, os.path.join(output_dir, filename))
  # Output the width and height for use as metadata
  print(f“width={x_max − x_min} height={y_max − y_min}”)
if _—name_— == “_—main_—”:
  fire.Fire(gen_pyramids)
```

Notably, there are more input parameters this time, i.e., the max_zoom and min_zoom, as well as tile_size. The max_zoom is the level at which the data is completely zoomed in. Whereas at zoom_level of 0 the data will actually be at the chosen tile_size. The process is run as follows:

> time python gen-pyramids.py ../tile-loading-poc/static/12mil_data.bin.gz
../tile-loading-poc/static/tiles/12mil_data --max_zoom=6

The resulting tile data for a data set comprising 12 million points consists of 156,659 files, taking up 641 MB of space. The average file size is around 20K and the largest is 224K.

In some embodiments, building the next level in the pyramid comprises performing clustering algorithm on the previous zoom level to get the average position of the features in the same general neighborhood. With each cluster the count of how many of each feature type are in the cluster is also preserved (i.e., {“Acta2”: 5, “Dcn”: 2, “Kcnj8”: 1}). Other numeric data may also be preserved, (i.e., radius x/y, Q-score, signal-to-noise). Optionally, Z-slice counts may be preserved at discrete z-slice levels. Suitable clustering algorithms include, but are not limited to
DBSCAN: Density-Based Spatial Clustering of Applications with Noise;
OPTICS: Ordering Points to Identify the Clustering Structure; and
K-Means: method of vector quantization, originally from signal processing, that aims to partition n observations into k clusters in which each observation belongs to the cluster with the nearest mean.

### Algorithms:

In image data analysis platforms for biological molecule detection and visualization, various problems exist with the visualization of biological molecules (e.g., DNA, RNA transcripts, proteins, etc.). In some platforms, highly expressed genes are subsampled to a less than desired fidelity, resulting in visualizations that do not provide relevant. Moreover, in some cases, rare genes can be lost completely in lower zoom levels of a visualization. Given that the count of transcripts can be in the hundreds of millions to billions, subsampling becomes necessary to provide a visualization to a user, and an improved analysis pipeline is needed so that important data is not lost during subsampling. In some embodiments, this analysis comprises a subsampling algorithm, an updated transcript storage, and a frontend interface that together presents the data resulting from an in situ analysis run to an end user. In some embodiments, the visualization methods enable the end-user to view all points for rare genes when zoomed out. In some embodiments, the visualization methods enable the end-user to view dense genes as points when zoomed out, with the points of view being representative of transcript density. In some embodiments, the visualization methods prioritize the visualization and performance for a smaller number of genes or transcripts (e.g., less than 100 selected transcripts).

In some embodiments, in an algorithm for subsampling (algorithm A), the transcripts are quartered in quantity at each subsequent zoom level. In some embodiments, the transcripts are quartered proportionally so that, for example, a highly expressed gene is still highly expressed relative to other genes, but without taking location into consideration. In some embodiments, transcripts are randomly chosen to keep from a previous zoom level. In some embodiments, preference is given to highly expressed genes. In some embodiments, such strategies have the benefit of very consistent tile sizes, but rare genes can be lost in subsequent zoom levels. Alternatively, in some embodiments, the algorithm fetches tiles from a more zoomed-in and detailed level, but at the expense of making many more requests.

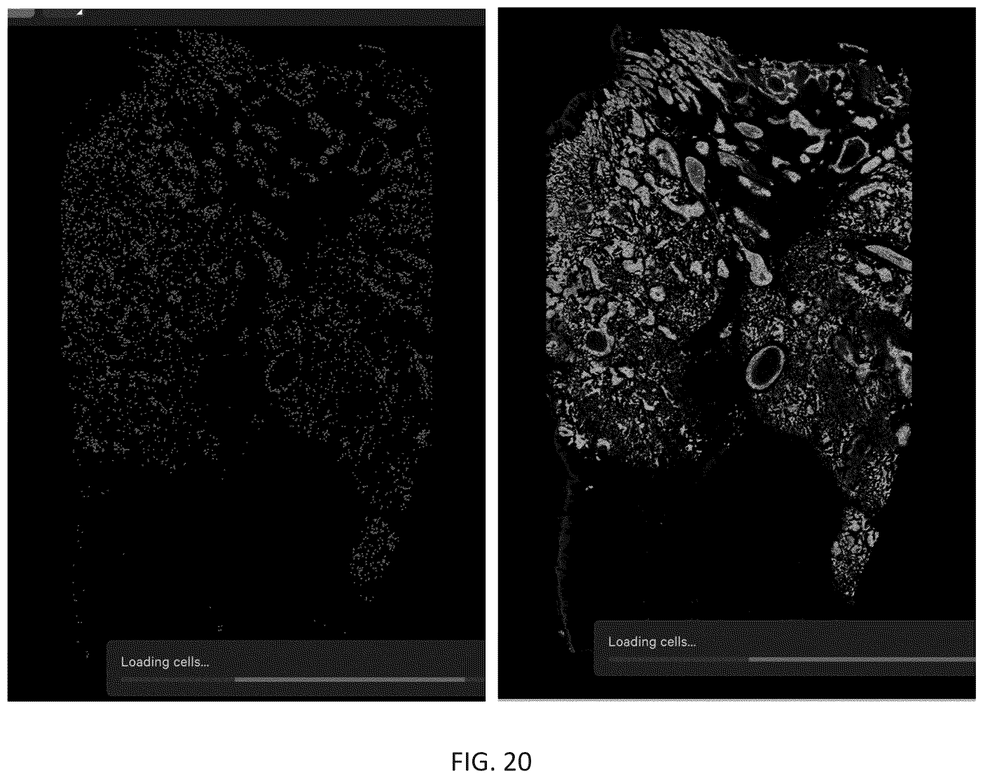

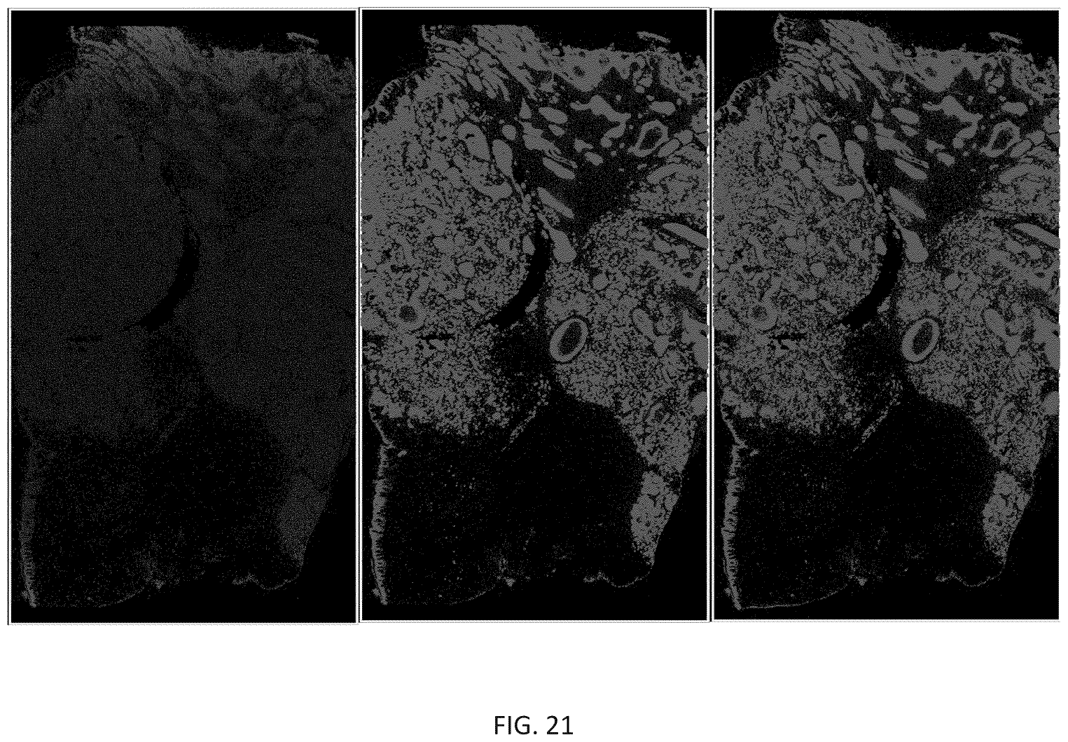

Thus, in some embodiments, a subsampling algorithm that takes spatial locality into consideration is disclosed (e.g., algorithm B). In some embodiments, the subsampling algorithm ensures that rare genes spread across the sample are visualized across zoom levels (e.g., despite being far apart). In some embodiments, transcripts for highly expressed genes are only culled (e.g., combined or removed from a zoom layer) when the highly expressed gene visually become insignificant. As shown in FIG. 20, the left panel illustrates subsampling using Algorithm A while the right panel illustrates subsampling using Algorithm B. In particular, subsampling using Algorithm A results in sparser points being rendered at a low zoom level (e.g., level 0) containing the entire biological sample. Subsampling using Algorithm B results in denser points being rendered at a low zoom level (e.g., level 0) containing the entire biological sample. Thus, the scaled transcript visualization algorithm B clusters transcript data points together based on gene identity and spatial localization. In some embodiments, transcripts that are close together are gathered into a single grouping, e.g., at each zoom level, for each gene, neighboring transcripts are grouped into a single, larger point if they are within an initial pixel radius of each other, such as a 16 pixel radius. In some embodiments, the pixel radius is about 4 pixels to about 1028 pixels (depending on resolution of the image). In some embodiments, the point size is calculated as the square root of the number of transcripts in each aggregate point multiplied by a scaling factor. In some embodiments, each point is labeled with the number of transcripts it represents (e.g., a number of transcripts is associated with the point in metadata). In some embodiments, the grouping count is included for every point, which may be used to improve the visualization. In some embodiments, to calculate the next level of clusters for a given gene, the subsampling algorithm iterates over every transcript and groups transcripts together if they are within a predetermined radius (e.g., 16 pixels). In various embodiments, a predetermined radius is defined for each zoom level. For example, the predetermined radius may double in size as the end-user zooms out (e.g., moving from level 1 to level 0, the pixel radius expands from 64 to 128 pixels). In some embodiments, selecting a suitable starting radius is therefore important for a effective visualization of biological molecules. Defining an initial radius that is too small may cause transcripts to not be grouped (resulting in a crowded visualization at lower zoom levels), while defining a radius that is too large may cause transcript sparsity (resulting in too few transcripts rendered and important information, such as rare transcripts, to be lost in the visualization). In some embodiments, an initial pixel radius (for the highest zoom level) is between 4 pixels and 16 pixels. In some embodiments, the initial pixel radius (for the highest zoom level) is 16 pixels. In some embodiments, the initial pixel radius between 4 pixels and 8 pixels strikes a good balance between data size and visual fidelity. In some embodiments, each subsequent lower zoom level has a pixel radius that is at least twice the previous zoom level. For example, if there are five zoom levels (four levels plus the original image), a pixel radius of 16 pixels is used for zoom level 4, a pixel radius of 32 pixels is used for zoom level 3, a pixel radius of 64 pixels is used for zoom level 2, a pixel radius of 128 pixels is used for zoom level 1, and a pixel radius of 256 pixels is used for zoom level 0 (original image). As illustrated in FIG. 21, transcript visualization density in an image of a biological sample includes grouping selected points based on the zoom level. As explained above, transcripts that are close together are gathered into a single grouping, yielding a plurality of clusters. In FIG. 21, of the original 19 million points each indicating a CD24 transcript; 100,000 display points are rendered in the left image. The center image of FIG. 21 shows the image of the biological sample, but the display points of the CD24 gene transcripts are grouped together if they are within a predetermined radius, as described above. In some embodiments, the predetermined radius is sized proportionally with cluster size. In FIG. 21, the right image shows a rendering of all 19 million points in the image. In some embodiments, transcripts are grouped and/or rendered based on quality score (Q-score). In some embodiments, transcripts are classified into low quality and high quality. For example, quality scores below a threshold of 20 are classified as low quality and quality scores of 20 or higher are classified as high quality. In some embodiments, transcripts with high quality scores are preferentially rendered at all zoom levels. In some embodiments, transcripts with low quality scores are more likely to be grouped with other transcripts at lower zoom levels. In some embodiments, transcripts with low quality scores are not rendered in any zoom level except for the original image (e.g., zoom level 0).

For exemplary purposes, the following pseudocode describes an algorithm (e.g., algorithm B) contemplated herein:

```
def better_subsampling(clusters, radius):
  “““Calculates the next zoom level of clusters for a given gene”””
  # spatial tree helps with quick nearest neighbor search
  tree = kdtree(clusters)
  subsampled_clusters = [ ]
  for cluster in clusters:
    if cluster.processed:
        continue
    # find clusters within some radius from this cluster
    neighbors = tree.within(cluster, radius)
    neighbors = [n for n in neightbors if !n.processed]
      for n in neighbors:
          n.processed = true
    neighbor_count = sum([c.count for c in neighbors])
    # create a new cluster
    next_cluster = Cluster(cluster.x, cluster.y, cluster.count + neighbor_count)
    subsampled_clusters.append(next_cluster)
  return subsampled_clusters
```

In the above, all transcripts of a given gene are clustered regardless of score. This prevents the separation of the visualization and leads to misleading merged values. To correct for this, the transcripts of a given gene are split by score and the resulting two groups are clustered separately. The results may be stored so that they could each be fetched separately. However, the amount of data culled (e.g., grouped and/or selectively not rendered) between zoom levels for a given gene may be less predictable and highly dependent on the density and spatial locality of the gene itself. By way of example, the tables below show how transcript counts of the indicated genes change between zoom levels for the subsampling algorithms contemplated herein (algorithms A and B), using an initial radius of 4 pixels (e.g., at the highest zoom level). For highly expressed genes, the percentage change between levels is fairly similar. As the gene becomes more rare or spread-out, this becomes less and less the case. If the total number of transcripts retained is too large, the starting radius may be increased as explained in more detail above.

| CD24 | Algorithm | Algorithm | Algorithm A | Algorithm B |
|---|---|---|---|---|
| (Highly | A | B | Fraction | Fraction |
| Expressed) Level | Size | Size | Kept | Kept |
| 0 | 34609747 | 34609747 | 1.0 | 1.0 |
| 1 | 8652437 | 10546224 | 0.25 | 0.3047 |
| 2 | 2163105 | 3803391 | 0.2499 | 0.3606 |
| 3 | 540772 | 1316273 | 0.2499 | 0.3461 |
| 4 | 135193 | 478689 | 0.25 | 0.3637 |
| 5 | 33799 | 172547 | 0.2501 | 0.3605 |
| 6 | 8450 | 56265 | 0.2501 | 0.3261 |
| 7 | 2112 | 17036 | 0.2499 | 0.3028 |

| ATF4 (Med-High | Algorithm | | Algorithm A | Algorithm B |
|---|---|---|---|---|
| Expressed) | A | Algorithm B | Fraction | Fraction |
| Level | Size | Size | Kept | Kept |
| 0 | 1842178 | 1842178 | 1.0 | 1.0 |
| 1 | 460544 | 1591782 | 0.2499 | 0.8641 |
| 2 | 115128 | 1349108 | 0.2499 | 0.8475 |
| 3 | 28779 | 938085 | 0.2499 | 0.6953 |
| 4 | 7195 | 493770 | 0.25 | 0.5264 |
| 5 | 1799 | 190854 | 0.25 | 0.3865 |
| 6 | 450 | 59623 | 0.2501 | 0.3124 |
| 7 | 112 | 17170 | 0.2488 | 0.2880 |

| PDHA1 | | | | |
|---|---|---|---|---|
| (Med-low | | | Algorithm A | Algorithm B |
| Expressed) | Algorithm A | Algorithm B | Fraction | Fraction |
| Level | Size | Size | Kept | Kept |
| 0 | 168636 | 168636 | 1.0 | 1.0 |
| 1 | 42165 | 156347 | 0.25 | 0.9271 |
| 2 | 10530 | 153100 | 0.2497 | 0.9792 |
| 3 | 2631 | 145065 | 0.24986 | 0.9475 |
| 4 | 659 | 123722 | 0.25048 | 0.8529 |
| 5 | 166 | 83737 | 0.2519 | 0.6768 |
| 6 | 41 | 40468 | 0.247 | 0.4833 |
| 7 | 10 | 14241 | 0.244 | 0.3519 |

| ACP4 (Low | | | Algorithm A | Algorithm B |
|---|---|---|---|---|
| Expressed) | Algorithm A | Algorithm B | Fraction | Fraction |
| Level | Size | Size | Kept | Kept |
| 0 | 804 | 804 | 1.0 | 1.0 |
| 1 | 142 | 773 | 0.1766 | 0.9614 |
| 2 | 16 | 772 | 0.1126 | 0.9987 |
| 3 | 1 | 771 | 0.0625 | 0.9987 |
| 4 | 0 | 771 | 0.0 | 1.0 |
| 5 | 0 | 766 | — | 0.9935 |
| 6 | 0 | 752 | — | 0.9817 |
| 7 | 0 | 712 | — | 0.9468 |

The following tables show the total number of transcripts retained at each zoom level and statistics of number of transcripts per tile (for algorithm B). In some embodiments, the total number of transcripts retained at the original image zoom level equals the total number of detected molecules from an in situ analysis run. Each table has a different initial radius and shows that increasing initial radius reduces the number of transcripts. Though a smaller initial radius may improve the look and feel of the visualization for the end user, it comes with the cost of slower loading times and a reduced number of genes that we can view at a time.

1px init radius

| ZOOM | TOTAL | TILE_SIZE | NUM_TILES | AVG | P00 |
|---|---|---|---|---|---|
| 0 | 684301756 | 250 | 3484 | 196412.6739 | 1 |
| 1 | 662878552 | 500 | 888 | 746484.8559 | 1 |
| 2 | 613228736 | 1000 | 236 | 2598426.847 | 228 |
| 3 | 541165412 | 2000 | 62 | 8728474.387 | 571 |
| 4 | 475001346 | 4000 | 16 | 29687584.13 | 1960 |
| 5 | 397960617 | 8000 | 6 | 66326769.5 | 8944191 |
| 6 | 303636619 | 16000 | 2 | 151818309.5 | 19256541 |
| 7 | 198844545 | 32000 | 1 | 198844545 | 198844545 |

| ZOOM | P25 | P50 | P75 | P90 | P100 |
|---|---|---|---|---|---|
| 0 | 51695 | 211591 | 301822 | 381367 | 618554 |
| 1 | 219127 | 822793 | 1126323 | 1407840 | 2091545 |
| 2 | 855910 | 2727078 | 3988168 | 4885526 | 6845117 |
| 3 | 4233185 | 9008897 | 13446174 | 15036004 | 2102588 |
| 4 | 14887837 | 31945114 | 43609513 | 56910727 | 63911075 |
| 5 | 15286574 | 53960400 | 115299697 | 162260053 | 162260053 |
| 6 | 19256541 | 284380078 | 284380078 | 284380078 | 284380078 |
| 7 | 198844545 | 198844545 | 198844545 | 198844545 | 198844545 |

2px init radius

| ZOOM | TOTAL | TILE_SIZE | NUM_TILES | AVG | P00 |
|---|---|---|---|---|---|
| 0 | 684301756 | 250 | 3484 | 196412.6739 | 1 |
| 1 | 613917620 | 500 | 888 | 691348.6712 | 1 |
| 2 | 541201185 | 1000 | 236 | 2293225.36 | 227 |
| 3 | 475002857 | 2000 | 62 | 7661336.403 | 570 |
| 4 | 397960675 | 4000 | 16 | 24872542.19 | 1930 |
| 5 | 303636614 | 8000 | 6 | 50606102.33 | 6924139 |
| 6 | 198844544 | 16000 | 2 | 99422272 | 13783141 |
| 7 | 106783603 | 32000 | 1 | 106783603 | 106783603 |

| ZOOM | P25 | P50 | P75 | P90 | P100 |
|---|---|---|---|---|---|
| 0 | 51695 | 211591 | 301822 | 381367 | 618554 |
| 1 | 207051 | 758739 | 1033046 | 1322004 | 1986122 |
| 2 | 773413 | 2450306 | 3514987 | 4359278 | 6193538 |
| 3 | 3829779 | 7815687 | 12025316 | 13356441 | 18560694 |
| 4 | 12613086 | 27007822 | 36396110 | 47252413 | 53014721 |
| 5 | 12332402 | 41064098 | 88780755 | 121316451 | 121316451 |
| 6 | 13783141 | 185061403 | 185061403 | 185061403 | 185061403 |
| 7 | 106783603 | 106783603 | 106783603 | 106783603 | 106783603 |

4px init radius

| ZOOM | TOTAL | TILE_SIZE | NUM_TILES | AVG | P00 | P25 | P50 | P75 | P90 | P100 |
|---|---|---|---|---|---|---|---|---|---|---|
| 0 | 684301756 | 250 | 3484 | 196412.6739 | 1 | 51695 | 211591 | 301822 | 381367 | 618554 |
| 1 | 542849981 | 500 | 888 | 611317.5462 | 1 | 185897 | 656717 | 913651 | 1185559 | 1813959 |
| 2 | 475085291 | 1000 | 236 | 2013073.267 | 227 | 698954 | 2117374 | 3079580 | 3833463 | 5485163 |
| 3 | 397964518 | 2000 | 62 | 6418782.548 | 567 | 3402665 | 6637552 | 10082858 | 11239654 | 15360400 |
| 4 | 303636765 | 4000 | 16 | 18977297.81 | 1900 | 10013626 | 20977684 | 27114246 | 35282123 | 39279376 |
| 5 | 198844563 | 8000 | 6 | 33140760.5 | 4668488 | 9114658 | 26807868 | 59060692 | 76173803 | 76173803 |
| 6 | 106783596 | 16000 | 2 | 53391798 | 8596888 | 8596888 | 98186708 | 98186708 | 98186708 | 98186708 |
| 7 | 47730407 | 32000 | 1 | 47730407 | 47730407 | 47730407 | 47730407 | 47730407 | 47730407 | 47730407 |

8px init radius

| ZOOM | TOTAL | TILE_SIZE | NUM_TILES | AVG | P00 | P25 | P50 | P75 | P90 | P100 |
|---|---|---|---|---|---|---|---|---|---|---|
| 0 | 684301756 | 250 | 3484 | 196412.6739 | 1 | 51695 | 211591 | 301822 | 381367 | 618554 |
| 1 | 477282516 | 500 | 888 | 537480.3108 | 1 | 168102 | 570105 | 799242 | 1047590 | 1614096 |
| 2 | 398080816 | 1000 | 236 | 1686783.119 | 226 | 594719 | 1752199 | 2585667 | 3186268 | 4510885 |
| 3 | 303643076 | 2000 | 62 | 4897468.968 | 565 | 2704431 | 5282717 | 7699031 | 8504398 | 11257868 |
| 4 | 198845005 | 4000 | 16 | 12427812.81 | 1846 | 7200911 | 14117264 | 16944299 | 22276498 | 24363162 |
| 5 | 106783620 | 8000 | 6 | 17797270 | 2626070 | 5970833 | 14261152 | 32297340 | 38411410 | 38411410 |
| 6 | 47730430 | 16000 | 2 | 23865215 | 4570891 | 4570891 | 43159539 | 43159539 | 43159539 | 43159539 |
| 7 | 18948892 | 32000 | 1 | 18948892 | 18948892 | 18948892 | 18948892 | 18948892 | 18948892 | 18948892 |

In the embodiments disclosed herein, where the subsampling algorithm leads to more transcripts overall, safeguards may be introduced to prevent the end-user from both over fetching or over displaying data. In some embodiments, the subsampling algorithm calculates how many transcripts would be rendered before making any requests. In some embodiments, tf a predetermined threshold is exceeded, a density view is shown to prevent making expensive requests. In some embodiments, the subsampling algorithm is provided both a mapping from (tileId, gene) to transcript count and a mapping from gene to chunkId. In some embodiments, the first mapping allows the subsampling algorithm to calculate how many transcripts would be loaded into the visualizer, and also provide a location of where to fetch this data. In some embodiments, an estimation of the actual transcript counts may be used, e.g., using the P90 count per gene per zoom level as an estimate.

In some embodiments, for storing the mapping from gene to chunkId, a fixed mapping that applies to all tiles is used. In some embodiments, the mapping is fetched only once; or a mapping per tile is used, which requires a fetch per tile. In some preferred embodiments, a non-fixed mapping per tile is used. The mapping from geneId to zarr array offsets in each tile .zattrs may be stored.

In some embodiments, each zarr array within a tile may be chunked. In some such embodiments, chunk size in bytes is around 2 MB. With respect to location data, this leads to around 100,000 desired transcripts per chunk. The average or p90 total transcripts per tile can be calculated and divide by 100,000 to determine the appropriate number of chunks. In some embodiments, the transcript data for each gene is contiguous. The data for each gene may be sorted by total count of clusters so that rare genes are chunked together and require less chunks to fetch. In some such embodiments, compression of zarr data is performed using blosc/lz4. In other embodiments, compression is performed using zlib.

Without being bound by theory and for exemplary purposes, the core of the algorithms proposed herein:

1. Divide the transcripts into groups, where each group was separated by Gene and QualityScore. This was the scope that clustering is performed, by gene and if the quality score was high (>20.0) or low (=<20.0).

2. For each one of these groups the clustering algorithm was run.

3. This algorithm iterates over each transcript and groups them with their neighbors if they are close enough (within some radius). For example, ten transcripts may become a single cluster if they are spatially close enough.

4. With each of these clusters a representative location and the count of the number of transcripts that have been merged was keep.

5. The algorithm was run for every zoom level, using the results from the previous level to generate the results of the next. The original data might have one billion points, the next level would have less, and so on. With each level the clustering radius was increased so that more was grouped together as the imaging zoomed out.

6. Each level was stored to a gridded disk system. The user interface (UI) now can ask for only the clusters in a particular region “X”.

The data is grouped by two criteria: by transcript and by distance. This is possible because the data is spatial, thus, it has coordinates in the 2-Dimensional plane. For example, for the following 3 points: (0, 0), (1, 1), (−1, −1), which are associated transcript ‘ABCD’; to group them, first it must be ensured they all belong to ‘ABCD’. Then a distance is selected to group by, such a distance of 5 pixels. Because these points are all within 5 pixels of one another (using the euclidean distance formula), they are all grouped together. If a third point is added, e.g., at (10, 10) but still belonging to the transcript ‘ABCD’, they wouldn't be added to this group because it is greater than 5 pixels away. The data is stored in small chunks (referred to as “tiles”) by transcript and by zoom level. At a high level, one can jump right into the array of data for a given zoom level and grab just the needed pieces. Zoom levels, in this case, are integers. For example, given a range of zoom levels from 13 to 0, there are zoom levels 13, 12, 11, . . . 2, 1, 0. Similarly, grouping by transcript based on the above example, the ‘ABCD’ data is pulled for the transcript ‘ABCD’. Lastly, the data is tiled, wherein “tiles” relate to which area of the viewport is observed in the 2-D plane. For instance, at the pixel (500, 500), the tile for that area can be observed.

To summarize, assuming an exemplary zoom level of 5, at the coordinate (500, 500) in the 2D plane, wherein the ‘ABCD’ transcript data is of interest; based on those inputs the small subset of the entire data can be acquired, ignoring all the other zoom levels, all the other transcripts, and most of the other tiles since they don't match the criteria of the zoom level (5), transcript (‘ABCD’) and tile location coordinate (500, 500).

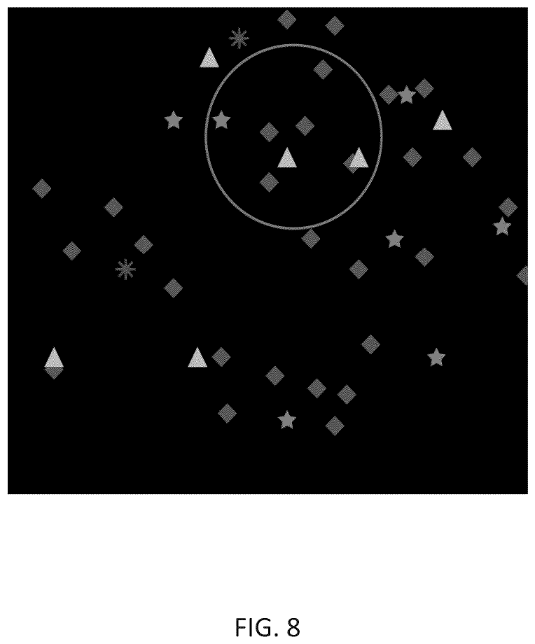

Regardless of the clustering approach, in some embodiments, the position for each point at different zoom levels is determined. In some embodiments, each point additionally contains aggregations for attributes of the data represented by those points (e.g., each point has metadata associated therewith). In some embodiments, certain data (e.g., the decoded feature name, and/or counts) are stored. FIG. 8 illustrates an exemplary point cloud at a first zoom level, where data points representing the different detected biological molecules (e.g., blue diamonds, green stars, yellow triangles, red asterisks, etc.) are aggregated within a fixed region. In various embodiments, the fixed region has a defined shape, such as a circle, square, rectangle, etc. For example, as shown in in FIG. 8, the points within the orange circle are aggregated together to make a single point in the next zoom level. In some embodiments, data associated with the aggregated points is averaged. In some embodiments, a representation of the counts of detected molecules is stored (i.e. {“blue”: 4, “yellow”: 2, “green”: 1}) along with the new point (e.g., a new point for each color and/or icon). For example, at the next zoom level, a single yellow triangle, a single blue diamond, and a single green star are displayed (and each point includes a representation of the counts of each color/icon at the higher zoom levels, as described above). For other numeric data, the counts may be averaged (i.e., Q-score, or signal-to-noise). For attributes such as z-slice, the data may be bucked by specified value and similarly store counts. It will be appreciated that within a given cluster, the data points may be subsampled or summarized in addition to averaging.

### Rendering:

The most straightforward approach to rendering is to simply render a point for each instance at each zoom level. Notably, other options exist that may help convey density in a more meaningful way, such as color representation in heatmaps. Alternatively, point density representations can be used, such as topographical lines, or even a three-dimensional topography can be used to represent density, along with points of different colors or shapes to represent the underlying data.

### Implementation in Deck.gl:

Deck.gl is a WebGL-powered framework for visual exploratory data analysis of large datasets. In deck.gl a “layer” is a packaged visualization type that takes a collection of data points, associates each with positions, colors, extrusions, etc., and renders them on a map. The “TileLayer” is a composite layer that makes it possible to visualize very large datasets. Rather than getting the entire dataset, it only loads and renders what is visible in the current viewport.

```
const layer = new TileLayer({
  data: sampleParams.featureDataSrc,
  getTileData: (tile) => {
    if (tile.signal.aborted) {
      return null;
    }
    // Check that tile is within bounds
    const currTileSize = sampleParams.tileSize / Math.pow(2, tile.z);
    const cols = Math.ceil(sampleParams.width / currTileSize);
    const rows = Math.ceil(sampleParams.height / currTileSize);
    if (tile.x < 0 || tile.y < 0 || tile.x >= cols || tile.y >= rows) {
      return null;
    }
    const getPositions = async ( ) => {
      const buff = await fetch(tile.url)
        .then(handleResponse)
        .catch((err) => console.warn(‘Failed to load ${tile.url}: ${er}‘));
      const arr = new Float32Array(buff);
      const positions = new Array<Position2D>( );
      for (let i = 0; i < arr.length; i += 2) {
        positions.push([arr[i], arr[i + 1]]);
      }
      return positions.map((position) => ({
        color: getColorFromPosition(position),
        position,
      }));
    };
    return getPositions( );
  },
  minZoom: sampleParams.minZoom,
  maxZoom: sampleParams.maxZoom,
  tileSize: sampleParams.tileSize,
  renderSubLayers: ({ data, id }: { data: any; id: string }) => {
    return new ScatterplotLayer<FeatureDatum>({
      id: ‘scatterplot-layer-${id}‘,
      data,
      getPosition: (d) => d.position,
      pickable: true,
      opacity: 0.8,
      stroked: true,
      filled: true,
      radiusScale: 6,
      radiusMinPixels: 2,
      radiusMaxPixels: 14,
      lineWidthMaxPixels: 4,
      lineWidthMinPixels: 1,
      getFillColor: (d) => d.color,
      getLineColor: ( ) => [0, 0, 0],
    });
  },
  updateTriggers: {
    getTileData: [sampleParams],
  },
  });
```

In the implementation provided above, the data prop points to a url template (i.e., “tiles/12mil_data/{z}-{x}-{y}.bin.gz” from the Zoomify format example, but this can be anything containing x, y, and z. In some embodiments, this may point to a server that fetches this data on-demand from a zarr, for example.)

“renderSubLayers” will render a ScatterplotLayer with the incoming data. From this layer, any number of points can be rendered. TileLayer handles the incremental fetching and eventual removal of data as the user pans and zooms.

### Exemplary Image Pyramid:

The following pipeline infrastructure component provides the mechanism by which in situ image data and metadata can be viewed in an interactive web application. In order to load such data, it is written into a compatible image pyramid, along with all necessary metadata. Analysis metadata may include detected feature location and sizes, gene locations, and other such entities. The following describes the files and file formats used in an exemplary embodiment to store the image pyramid data and metadata.

Mapping from Image Coordinates to Physical Coordinates:

Image coordinates have the origin in the top-left corner with y-coordinates increasing from top to bottom (i.e., a cartesian coordinate system. It is often desirable to have the origin of the physical coordinates in the bottom-left corner with y-coordinates increasing from bottom to top. An affine transformation matrix can achieve this. It can also provide an additional translation if the origin of the physical coordinates is not at one of the image corners. For example, with a pixel size of 0.1625 μm and an image size of 8704×8704 pixels, the mapping to physical coordinates with the origin at the bottom-left could be described like this (y-translation and negative y-scale):

```
{“physical”:{
  “transform”:[0.1625,0,0,0,−0.1625,1414.4,0,0,1],
  “unit”:{“x”:“μm”,“y”:“μm”}}}
```

### Storing Tile Information:

To visualize tiles of the stitched image in the viewer, the tile information must be stored. A representation in pixel coordinates of the stitched image could be easily handled in the viewer. Physical coordinates could be handled, too, and would require inverting the transformation matrix discussed above.

### Image Pyramid File:

The image pyramid file is stored as an OME-zarr (OME-NGFF) file.

| Path | Required | Type | Description |
|---|---|---|---|
| / | Y | group | Root of the OME-zarr archive. |
| /0 | Y | array | The highest resolution layer of the |
| | | | image pyramid. |
| /n+ | Y | array | Additional successive layers of the |
| | | | image pyramid. |

A reasonable tile size should be picked. Without compression, a 1024×1024 tile with 2 bytes per sample is 2 MB for each channel. With an image pyramid, on average four tiles are being displayed per channel if the browser window is approximately 1024×1024. Even with two channels, that amounts to 16 MB. While a tile size of 512×512 would quadruple the number of files, it might still be better for viewer performance. With the same browser window size, on average nine tiles would be displayed, reducing the download size by 44%.

### Object Results File:

The analysis results file contains a serialized version of a specific analysis for display in the application, usually overlaying an image pyramid. The analysis results file is a Zarr v2 archive containing the following hierarchical structure. Position and size information located within the /physical and /imaging groups may be in different coordinate systems. The transform matrix object in each group gives the appropriate transform to convert properties in that group to the physical coordinate space.

Optionally, as indicated by the presence of /physical/feature/.zattrs/grid_keys, points may be divided into a grid of physical units. This adds an extra level in the hierarchy consisting of the grid keys. For example, /physical/feature/id would turn into /physical/feature/0, 1/id and /physical/feature/2, 0/id. The same applies to barcodes, e.g., /physical/feature/1,2/barcode/identity. Attributes for those paths are replicated across grid cells. There are attributes for each grid cell, consisting just of number_features: int.

Rendering Output from the Point Cloud Pipeline:

Users can choose to display “detected” features, “inferred” features, both, or neither. Features of both types are to be rendered with the same glyph, based on the barcode identity.
All inferred features are contained in files like {name}_features.zarr.
All detected features are contained in files like {name}_features_detected.zarr
{name} uses the pattern global_{cycle_name}

If detected features are being displayed, and the current cycle is C, there are two display options:
Show all: Render all detected features with /physical/feature/detection[0]>=0
Cycle specific: Only render the features that were detected in this cycle, /physical/feature/detection[0]>0

### Localization Pipeline and Backwards Compatibility

If /physical/feature/inferred is absent, none of the selections above are applicable. All features should be rendered all the time
If /physical/feature/inferred[0]!=−1, the output is from the anchor pipeline. All features should be rendered all the time

| Path | Required | Type | Description |
|---|---|---|---|
| /physical | Y | group | Physical metadata for the analysis results. |
| | | | Valid attributes for the group are described |
| | | | below. |
| /physical/feature | Y | group | Group for feature metadata. Valid attributes for |
| | | | the group are described below. |
| /physical/feature/id | Y | array | An N array of type int giving the id of the |
| | | | feature. The array is sorted in increasing order. |
| /physical/feature/inferred | Y | array | An N array of type int giving the feature ID of |
| | | | the inferred feature this detected feature was |
| | | | assigned to. If this feature is an inferred |
| | | | feature, this value should be −1 |
| /physical/feature/location | Y | array | An N × 3 array of type float giving the physical |
| | | | location of each feature. Columns are: |
| | | | x_position, y_position, and z_position of the |
| | | | feature. |
| /physical/feature/boundary | Y | array | An N × C × 6 array of type float giving the |
| | | | physical boundaries of each feature as a rotated |
| | | | three dimensional ellipsoid in each of the C |
| | | | channels. Columns are: x_axis_radius, |
| | | | y_axis_radius, z_axis_radius, z_axis_rotation, |
| | | | y_axis_rotation, and x_axis_rotation (in |
| | | | degrees using a right-hand convention so that |
| | | | counter-clockwise is positive.) |
| /physical/feature/intensity | Y | array | An N × C × 8 array of type float giving the |
| | | | intensity properties of each feature in each of |
| | | | the C channels. Columns are: |
| | | | background_intensity, integrated_intensity, |
| | | | mean_intensity, min_intensity, max_intensity, |
| | | | std_intensity, circularity, and tail_probability. |
| /physical/feature/transform | Y | array | A 4 × 4 homogenous transform matrix taking |
| | | | coordinates from the coordinate space used in |
| | | | this feature group to the physical coordinate |
| | | | space. (For final pipeline outputs this will be |
| | | | an identity matrix, but for intermediate pipeline |
| | | | outputs it will not be.) |
| /physical/feature/exemplar_codeword_index | Y | array | An array of type int64 of length equal to the |
| | | | number of codewords in the full codeword set, |
| | | | W (including basic codewords and derived |
| | | | codewords). Basic codewords are identical to |
| | | | the “barcodes” defined elsewhere. Derived |
| | | | codewords are defined in the description for |
| | | | ‘full_codeword_identity’. Element i maps |
| | | | codeword i to a representative codeword j |
| | | | which must be a basic codeword. |
| /physical/feature/codeword_parents_row | Y | array | Defines a sparse boolean matrix mapping |
| | | | derived codewords to their parent basic |
| | | | codewords and basic codewords to themselves. |
| | | | This array and the ‘cols’ array below specify |
| | | | the indices of the non-zero elements of the |
| | | | matrix. The underlying matrix is of dimension |
| | | | W × W where W is the number of codewords in |
| | | | the “full” set (basic and derived, described |
| | | | elsewhere). Element x_ij is True if codeword i |
| | | | was computed from codeword j. For any basic |
| | | | codeword i, element x_ii is always True. |
| /physical/feature/codeword_parents_col | Y | array | [see above] |
| /physical/feature/barcode | Y | group | Group for barcode related metadata of features. |
| /physical/feature/barcode/identity | Y | array | An N × 2 array type int16 giving the barcode |
| | | | index for each feature. Barcode indices are |
| | | | zero based and reference the barcode_names |
| | | | attribute attached to the barcode parent group. |
| | | | Unknown barcodes are given by −1. Columns |
| | | | are: initial_call, corrected_call. |
| /physical/feature/barcode/full_codeword_identity | Y | array | An N-length array type int32 giving the index |
| | | | into the full codewode list, including derived |
| | | | codewords. Derived codewords are additional |
| | | | codewords created by summing subsets of |
| | | | codewords that are expected to spatially |
| | | | overlap. Unknown codewords are given by −1. |
| | | | Note that the term “barcode” used elsewhere in |
| | | | this document is superceded by “codeword” |
| | | | here. |
| /physical/feature/barcode/score | Y | array | An N × 3 array of type float32 giving the |
| | | | barcode scoring properties of each feature. |
| | | | Columns are: initial_q_score, |
| | | | corrected_q_score, |
| | | | number_corrected_positions. |
| /physical/feature/barcode/part | Y | array | An N × 2 array of type int16 giving the barcode |
| | | | part index for the feature. Part indices are zero |
| | | | based and reference the barcode_sequences |
| | | | attribute attached to the barcode parent group. |
| | | | Unknown parts are given by −1. Columns are: |
| | | | initial_call, corrected_call. |
| /physical/feature/detection | | array | An N × 4 array of type int8. |
| | | | Column 0: The channel of detection, a 1- |
| | | | based index into |
| | | | /physical/feature/channel_names |
| | | | attributes) |
| | | | In <= v2.1.1: A value of 0 indicates |
| | | | the feature was not detected in this |
| | | | cycle. In >= v2.2, this does not hold, |
| | | | use the cycle of detection explicitly |
| | | | A value −1 indicates non- |
| | | | applicability of detection to this |
| | | | feature (either an inferred feature, or a |
| | | | feature from the anchor pipeline) |
| | | | Column 1: The cycle of detection, 1- |
| | | | indexed. Will be −1 for anchor pipeline |
| | | | analysis, and for inferred feature zarrs, |
| | | | where the concept of detection does not |
| | | | apply. Corresponds to |
| | | | /physical/feature/barcode.barcode_sequence_{—} |
| | | | position + 1, i.e., only the decoding cycle |
| | | | position |
| | | | Column 2: The FOV row of detection |
| | | | Column 3: The FOV col of detection |
| /physical/feature/physical_size | N | array | An M × C × 22 array of type float32 containing |
| | | | physical sizing details for features (RCPs). |
| /physical/feature/density/q20/indices | N | array | A uint16 array of length NNZ (non-zero |
| | | | entries) containing the column indices referred |
| | | | to in the corresponding values array. The array |
| | | | should be stored in chunks of 50,000 (or |
| | | | 100,000). |
| /physical/feature/density/q20/indptr | N | array | A uint32 array of length ((num_features + 1) * |
| | | | num_density_rows) + 1, containing indices |
| | | | into indices and values where given rows start. |
| | | | “Unknown” is not counted by num_features |
| | | | but added as the last feature. The array should |
| | | | not be chunked. |
| /physical/feature/density/q20/data | N | array | A uint16 array of length NNZ containing the |
| | | | counts of feature points contained in a density |
| | | | grid cell. The array should be stored in chunks |
| | | | of 50,000 (or 100,000). |

Valid attributes for the /physical group.

Group/physical Attributes

| | Re- | | |
|---|---|---|---|
| Field | quired | Type | Description |
| unit | Y | dict | A mapping of the physical dimension |
| | | | units for the x and y dimensions: e.g., |
| | | | {“x”: “μm”, “y”: “μm”, “z”: “μm”}. |
| pixel_{—} | Y | float | The size of a pixel in terms of the |
| size | | | specified physical units. |
| z_step_{—} | Y | float | The size of a z-step in terms of the |
| size | | | specified physical units. |

Valid attributes for the /physical/features groups and arrays.

Group/physical/feature Attributes

| Field | Required | Type | Description |
|---|---|---|---|
| version | Y | str | The version of this specification the data |
| | | | follows. Currently “2.2.0”. |
| feature_type | Y | str | A string describing the feature type of these |
| | | | data, e.g., “rca_nanoball”, “spot”, “bead”, etc. |
| number_features | Y | int | The number of features in the analysis. |
| channel_names | Y | list[str] | Names of the channels. |
| channel_intensity_units | Y | list[str] | The intensity units for each channel. |
| grid_size | N | float | The size of the grid in physical units for |
| | | | splitting up feature points into a grid |
| grid_keys | N | list[str] | The grid keys “0, 0”, “0, 1”, etc., for the cells |
| | | | that contain points. |
| codeword_parents_shape | Y | list[int] | Defines the shape of the codeword_parents |
| | | | sparse matrix described elsewhere. |

Group/physical/feature/location Attributes

| Field | Required | Type | Description |
|---|---|---|---|
| column_names | Y | list[str] | Names of the columns. |
| column_descriptions | Y | list[str] | Human readable descriptions for the |
| | | | columns. |

Group/physical/feature/boundary Attributes

| Field | Required | Type | Description |
|---|---|---|---|
| column_names | Y | list[str] | Names of the columns. |
| column_descriptions | Y | list[str] | Human readable descriptions for the |
| | | | columns. |

Group/physical/feature/intensity Attributes

| Field | Required | Type | Description |
|---|---|---|---|
| column_names | Y | list[str] | Names of the columns. |
| column_descriptions | Y | list[str] | Human readable descriptions for the |
| | | | columns. |

Group/physical/feature/barcode Attributes

| Field | Required | Type | Description |
|---|---|---|---|
| barcode_set_name | Y | str | The name of the barcode set. |
| barcode_count | Y | int | The number of barcodes in the set. |
| barcode_length | Y | int | The length of each barcode. |
| barcode_names | Y | list[str] | Names of the barcodes. |
| barcode_sequences | Y | list[list[int]] | Composition of each barcode given as a list |
| | | | of expected part indices. |
| barcode_sequence_position | Y | int | The index/position of this feature data set in |
| | | | the barcode, i.e., the sequence base number. |

Group/physical/feature/barcode/identity Attributes

| Field | Required | Type | Description |
|---|---|---|---|
| column_names | Y | list[str] | Names of the columns. |
| column_descriptions | Y | list[str] | Human readable descriptions for the |
| | | | columns. |

Group/physical/feature/barcode/score Attributes

| Field | Required | Type | Description |
|---|---|---|---|
| column_names | Y | list[str] | Names of the columns. |
| column_descriptions | Y | list[str] | Human readable descriptions for the |
| | | | columns. |

Group/physical/feature/barcode/parts Attributes

| Field | Required | Type | Description |
|---|---|---|---|
| column_names | Y | list[str] | Names of the columns. |
| column_descriptions | Y | list[str] | Human readable descriptions for the |
| | | | columns. |

Group/physical/feature/density Attributes

| Field | Required | Type | Description |
|---|---|---|---|
| group_names | Y | list[str] | The available groups for Q-score bands, e.g., |
| | | | [“q0”, “q10”, “q20”]. |
| min_q_scores | Y | list[float] | The minimum Q-scores for each band, e.g., |
| | | | [0, 10, 20] |
| max_q_scores | Y | list[float] | The maximum Q-scores for each band, e.g., |
| | | | [10, 20, 81]. |

Group/physical/feature/density/q20 Attributes

| Field | Required | Type | Description |
|---|---|---|---|
| number_features | Y | int | The number of features in the analysis. This |
| | | | does not include “Unknown” that is added as |
| | | | the last feature. |
| number_rows | Y | int | The number of rows in the density grid. |
| number_columns | Y | int | The number of columns in the density grid. |
| grid_size | Y | float | The size of the grid in physical units for |
| | | | splitting up feature point density into a grid |
| | | | (expected to be 10 μm). |
| min_q_score | N | float | The minimum Q-score for features to be |
| | | | counted (default: 20). |
| max_q_score | N | float | The maximum Q-score for features to be |
| | | | counted (exclusive). |

### Feature Density:

Feature density is stored as a compressed sparse row (CSR) matrix under/physical/feature/density. The matrix has three dimensions, (number_features+1)*number_rows*number_columns but the first two dimensions are collapsed. The “Unknown” feature has an extra entry at the end of features. Only features with a Q-score≥20 are counted. The grid is supposed to be 10×10 μm\hat{ }2 but another grid size may be specified in the attributes.

### Analysis of Histology Images:

### Workflow:

Images from biological samples were prepared for viewing in a multi-resolution image pyramid stored on a server. Point features were detected and cell boundaries were defined. Multi-resolution image tiles were loaded on demand using a web-based viewer, e.g., GPU rendering via WebGL. Colors and intensity ranges could be adjusted in the browser. Detected features are overlayed on the images (e.g., icons, ellipses, density gradient, cell boundaries, and cell-gene counts), disclosed herein as Stardust feature layers.

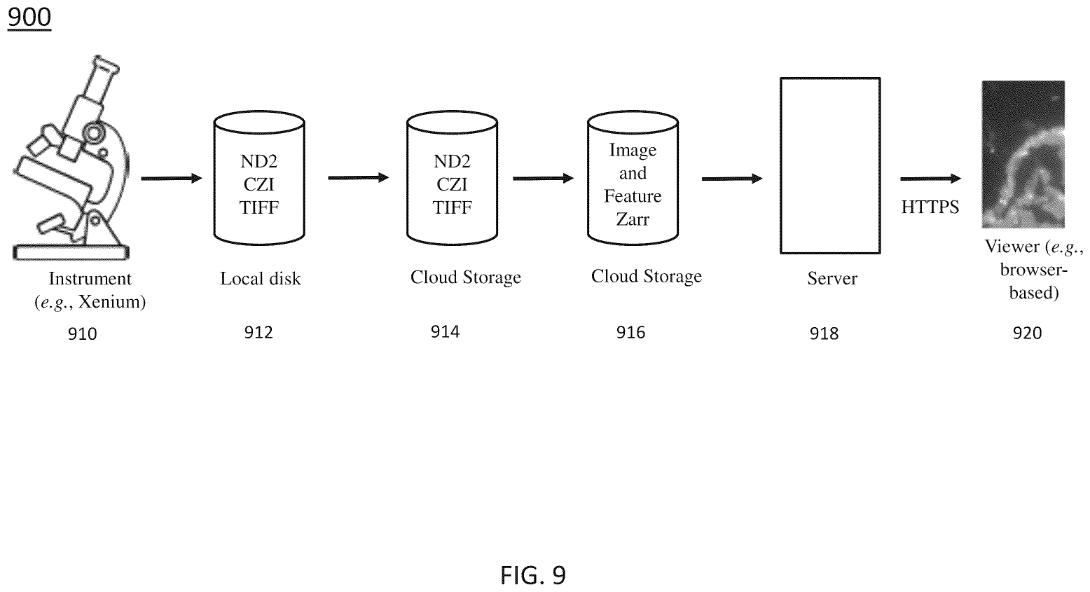

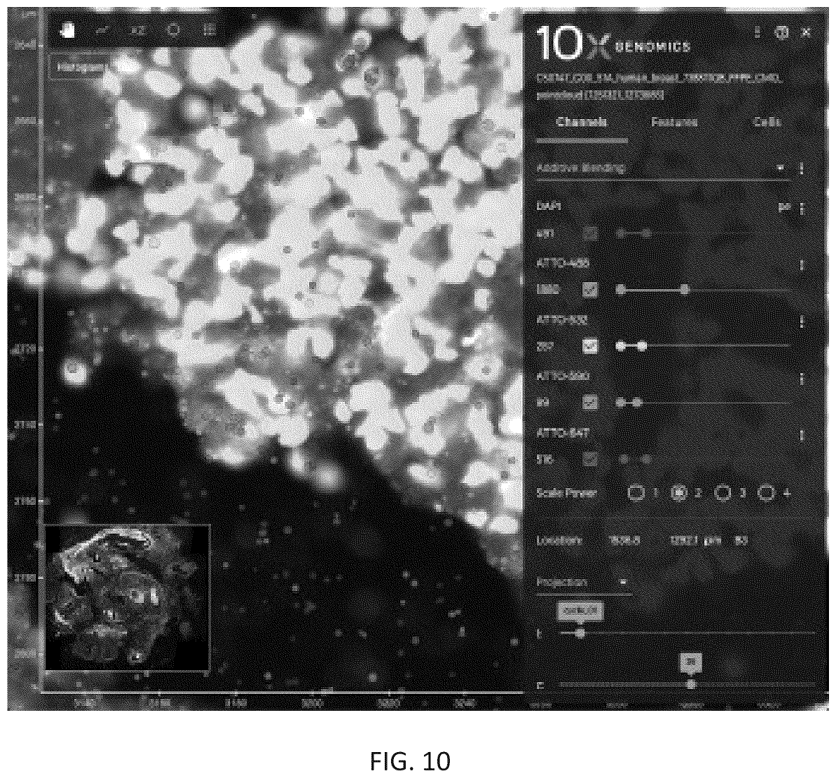

FIG. 9 shows a diagram 900 of how data from the instrument may be processed, stored, and subsequently used by a viewer, in accordance with various embodiments. In various embodiments, at 910, an instrument may capture images of a biological sample. These images may be stored in one or more files in an image file format (e.g., ND2, CZI, TIFF, etc.), to a local disk at 912. At 914, the one or more files may then be transmitted and stored in a cloud-based storage system in the same image format. At 916, the one or more files may be converted from the image file format to one or more files in a multi-resolution hierarchical file format (e.g., Zarr, HDF5, etc.), which includes tiles, as described herein. At 918, the files in a multi-resolution hierarchical file format may be transmitted and/or stored on a visualization/visualization tool server, which may be requested and accessed by a remote visualization client, for example in a web browser at 920. FIG. 10 shows an exemplary visualization tool for visualizing three-dimensional point cloud data and the visualization tool is accessible via a web browser.

### Components:

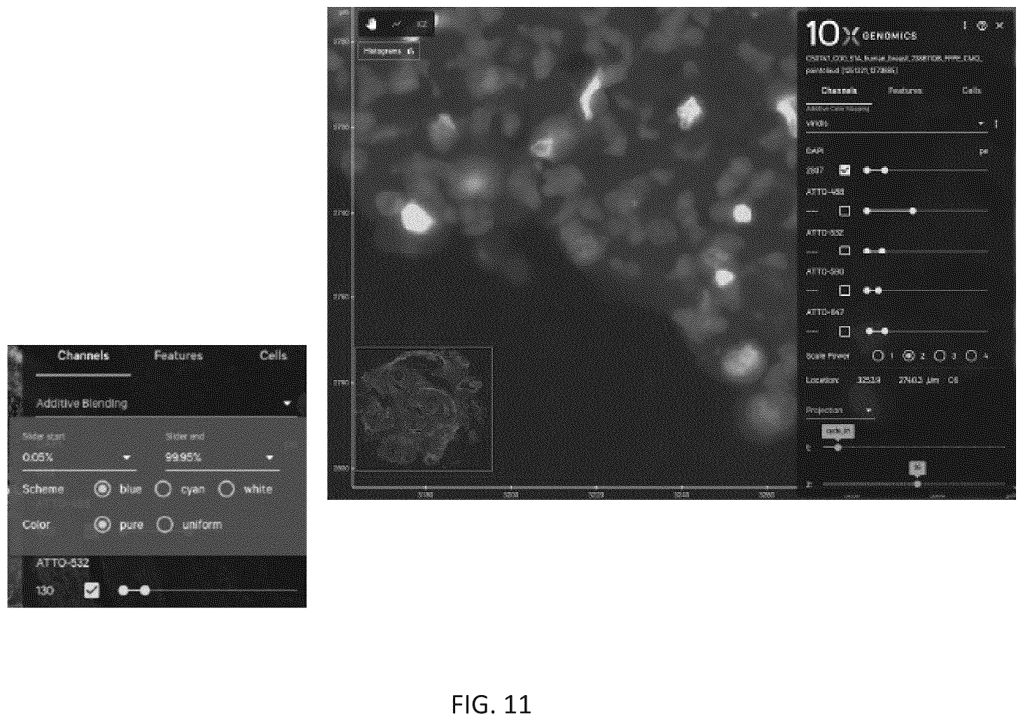

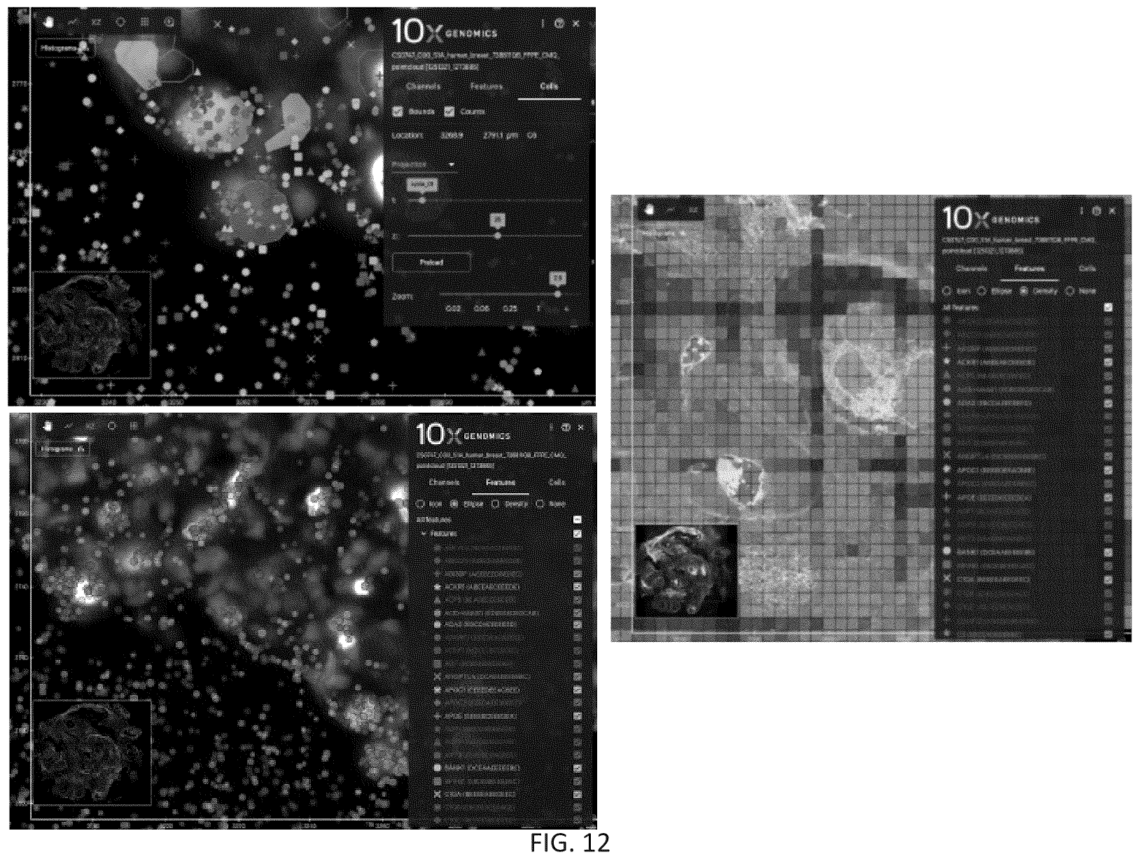

In various embodiments, the feature data is loaded on-demand, keeping browser memory usage manageable. FIG. 11 shows a multi-resolution image viewer for auto-levelling, uniform palette, colormaps, and preloading. In various embodiments, additional windows can provide, e.g., histograms, galleries, and/or vertical slice data. As shown in FIG. 12, image overlays provide representation of data features as icons, ellipses, density maps/gradients, and can also visualize cell boundaries and cell-gene counts. In various embodiments, the image overlays are rendered over one or more images of a sample (e.g., biological tissue sample). In various embodiments, the one or more images of the sample include H&E stain image, DAPI stain image, brightfield image, darkfield image, etc.

The number of genes to be analyzed by the methods and instrumentation disclosed herein continues to increase (e.g., 50-plex, 150-plex, 400-plex), employing hundreds of dummy variables and External RNA Control Consortium (ERCC) controls for over 2,000 in total. This necessitates dynamic adjustments for the layers and the user interface.

Because the contemplated data sets (e.g., in situ data from biological samples) may comprise millions of detected feature points, loading times may take too long as the browser memory is pushed past its limits. Thus, contemplated herein are adjustments to make layers more memory efficient, the spatial grid for feature points to load features on-demand, and automatic switching to density layer when zooming out.

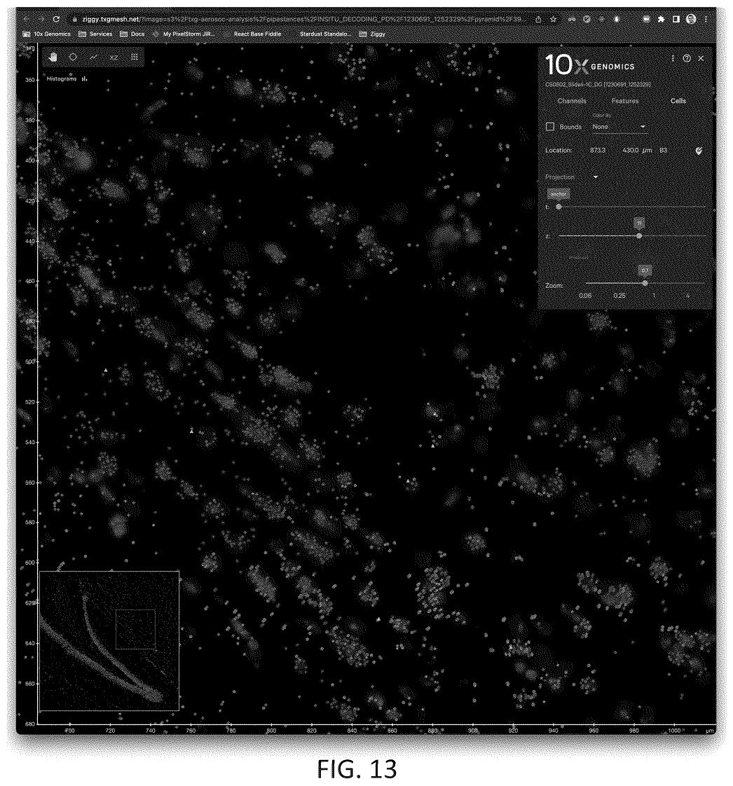

FIG. 13 shows an example of a visualization generated with a visualization tool. The visualization shown in FIG. 13 may display features of a sample, such as a biological sample. The visualization and/or visualization tool may be referred to as a graphical user interface (GUI), which may be a displayed interactive visual interface. For example, the visualization may display a projection of one or more images taken of the biological sample, at one or more FOVs, on an x-y plane. In various embodiments, the visualization and an associated tool may be used to view data, such as in-situ data. The in-situ data may include features of a sample, such as a biological sample. Such features may include metabolic properties, gene expression, protein expression, and/or morphologic features associated with the cells within the sample. Cell features may also include intracellular analytes, such as proteins, protein modifications (e.g., phosphorylation status or other post-translational modifications), nuclear proteins, nuclear membrane proteins, any combination thereof, and/or the like. The data may be stored on a cloud-hosted data storage, a storage local to the visualization tool, a remote storage, a local or remote distributed storage, and/or the like.

In various embodiments, the visualization tool may operate as or at a server application that may respond to web browser requests and a client application, which may operate entirely within a web browser. In various embodiments, the visualization tool may operate as an application on a computing node, as described herein. In various embodiments, the visualization tool may operate as a portion, module, and/or component of the instrument, as described herein.

In various embodiments where the visualization tool may operate as or at a server application, a client application may first initiate a request to a running instance of the visualization server. This may occur by entering a web address being entered, a link that's clicked within a browser, following a workflow within an instrument interface, and/or the like. The visualization server, which may be operating in or as a part of the cloud, may then provide the browser with the client-side code to load. Depending on the parameters of the initial request, the server response may include settings or other information derived from the parameters, such as identifying information and the location of the desired dataset, the version of the client-side code to load, other metadata, and/or the like.

Once the client-side code is loaded, the client may make requests to the visualization server for images. The images may be primarily used to display microscopy-based morphological data related to a sample, such as a biological sample. Images may be stored in a pyramidal format, whereby different files may be stored for different resolutions. These images can be stored in the cloud, locally on a high-capacity computer, within a shared networked filesystem, such as a cloud-based storage. There may be multiple sets of images, each corresponding to a different wavelength, time interval, z-slice, iteration of the in-situ instrument's imaging/probing cycle, and/or other characteristic of the sample and/or images of the sample. In this manner, these images can capture aspects of the sample, such as the presence or absence of proteins that may label cell boundaries, nuclear and cytoplasmic boundaries, the presence or absence of targeted proteins, and/or other morphological or fine-grained molecular information. This image data may be single or multi-channeled, such as 8-bit or 16-bit single channel images, 8 bpp/16 bpp multichannel RGBA images, and/or the like. Images may be stored natively in TIFF or any other image formats.

In various embodiments, a visualization may be generated within a web-based image visualization tool. Images displayed by the visualization may include multiple channels that are colored and blended. These images may be stitched from multiple fields of view (FOVs) in a pipeline. For example, the images may me RGB Hematoxylin and Eosin stain (H&E) images. The images may be from multiple cycles (e.g., different times) and/or z-slices (e.g., different focus points). The images may be stored on a cloud platform, such as S3, and/or on mounted disks. The feature and/or cell data in the images may be stored in parallel directories. Images may be viewed in the visualization. The images may be prepared for viewing before being displayed in the visualization tool. The images may be stored in one or more files that are in a multi-resolution hierarchical, such as image pyramid, file format. The images may include and/or the visualization tool may detect features and cell boundaries. The images, their attributes, and/or the features may be stored as multi-resolution tiles. The tiles may be loaded and displayed, such as on a display of a computing node or the instrument, by the visualization tool on-demand. For example, such displays may be made using one or more GPUs that renders via WebGL. The colors and/or intensity of what is displayed by the visualization tool may be adjusted within the web browser. In various embodiments, particular features, such as detected features, and/or data related to the features may be overlaid on the displayed images. For example, icons, ellipses, density, cell boundaries, cell-gene counts, and/or any other image-related data may be overlaid on the displayed images.

For example, an instrument may capture images of a biological sample, which may be stored in one or more files in an image file format (e.g., ND2, CZI, TIFF, etc.), to a local disk. The one or more files may be transmitted and stored in a cloud-based storage system in the same image format. The one or more files may be converted from the image file format to one or more files in a multi-resolution hierarchical file format (e.g., Zarr, HDF5, etc.), which includes tiles, as described herein. The files in a multi-resolution hierarchical file format may be transmitted and/or stored on a visualization/visualization tool server, which may be accessed by a visualization client, for example in a web browser.

As described herein, the visualization tool may load and display image tiles on-demand. For example, if the visualization tool is operating in a web browser client, this may allow for the usage of memory by the web browser to be kept manageable. The visualization tool may be a multi-resolution image viewer with a viewport and may be capable of auto-leveling, may have a uniform palette, may have a color map, and may be capable of preloading images and/or image tiles. The visualization may have popups, such as those capable of producing histograms, galleries, vertical slices, lasso selection statistics, and/or the like. In various embodiments, a spatial grid of tiles, as described herein, may be used to load features on-demand within the visualization tool. In various embodiments, the visualization tool may automatically switch to a density layer to display features or related data when images are zoomed out. In various embodiments, the visualization tool may automatically switch to displaying features or related data when an option to show features is selected and when images are zoomed in.

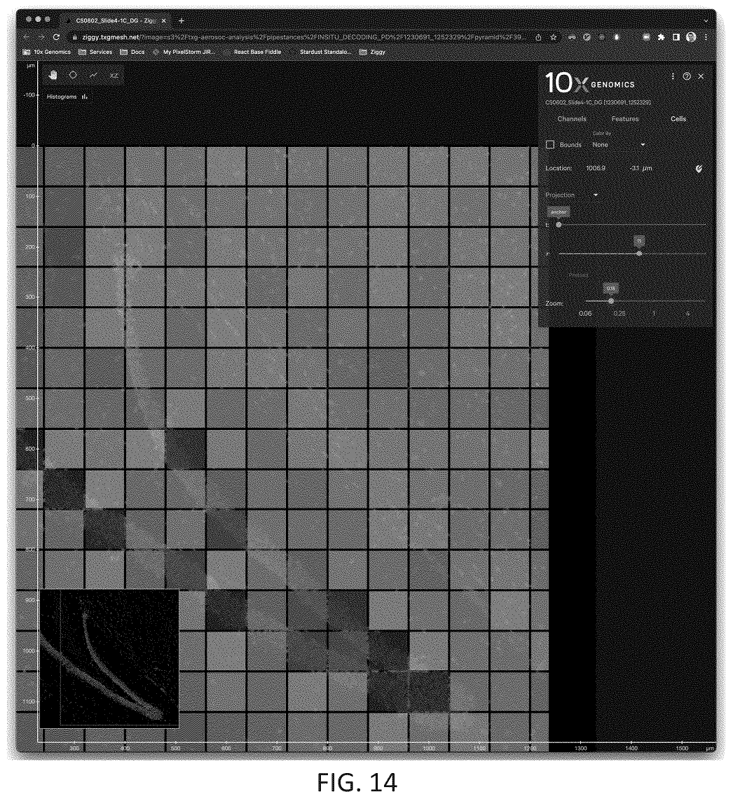

In addition to underlying image data, the client application may make requests for the files that may drive data overlays atop the morphological data. FIG. 14 shows an overlay of tiles atop morphological and feature data. In particular, FIG. 14 shows a density view, which may provide an overview of where different data may be found. For example, a heatmap of data may be provided with colors corresponding to different densities of where different data may be found.

These overlays may include quantitative per-cell information, such as the number of molecules per gene per cell, cluster membership information, per-cell protein or other gene marker statistics, cell type identification, morphological tissue boundaries, and/or the like. This data may also be stored in a pyramidal format to allow the client to selectively load information, for example, information for a small subset of the active dataset, and/or as complete tracks for the entire experiment. The server and the client may transform the data from its at-rest format in storage to an in-memory format suitable for the visualization tool. The in-memory format may include, for example, arrays of colors, polygons, or shading parameters. The visualization user interface may then be used to control which overlays are active, to tune those overlays, and/or allow a user to more easily explore and characterize phenomena found in their in-situ data.

The primary role of the in-situ visualization may be to provide the mechanisms that allow users to interactively explore data overlays, representing quantitative and qualitative information, atop the images representing the morphological structure of the underlying sample, such a biological sample.

In various embodiments, data may be loaded from an image file format in the visualization tool. In various embodiments, the image data may be converted to a hierarchical file format, such as an image pyramid file format. In particular, the image data from the image formatted file may be written into a compatible image pyramid, along with all necessary metadata. Analysis metadata may include detected feature location and sizes, gene locations, and/or other such entities. In some examples, the hierarchical formatted file, such as image pyramid file, may be stored as an OME-zarr (OME-NGFF) file.

In various embodiments, image coordinates may be mapped to physical coordinates. In various embodiments, image coordinates may have the origin in the top-left corner with y-coordinates increasing from top to bottom. It may be desirable to have the origin of the physical coordinates in the bottom-left corner with y-coordinates increasing from bottom to top. An affine transformation matrix may be able to achieve this. Such a transformation matrix can also provide an additional translation if the origin of the physical coordinates is not at one of the image corners. For example, with a pixel size of 0.1625 μm and an image size of 8704×8704 pixels, the mapping to physical coordinates with the origin at the bottom-left could be described as follows (y-translation and negative y-scale):

```
{“physical”:{
  “transform”:[0.1625,0,0,0,−0.1625,1414.4,0,0,1],
  “unit”:{“x”:“μm”,“y”:“μm”}}}
```

In various embodiments, a reasonable tile size may be selected for the tiles stored within the hierarchical formatted file. For example, without compression, a 1024×1024 tile with 2 bytes per sample may be 2 MB for each channel. With an image pyramid, on average four tiles may be displayed per channel if the browser window is approximately 1024×1024. Even with two channels, that could amount to 16 MB. For example, while a tile size of 512×512 would quadruple the number of files, it may still be better with regards to visualization tool and/or viewer performance. With the same browser window size, on average nine tiles would be displayed, reducing the download size by approximately 44%. In various embodiments, the storage, such as the cloud-based storage, used to store the image files and/or hierarchical format files and corresponding tiles may be the deciding factor in selecting a tile size. For example, S3 performance may be the deciding factor. While this may depend to some extent on the local network, the cloud storage may perform better with larger objects than with smaller objects. For example, S3 performs better with 2 MB objects than with 0.5 MB objects. Therefore, as one example, 1024×1024 may be the chosen tile size.

In various embodiments, to visualize tiles of the stitched image in the visualization tool and/or viewport of the viewer, the tile information may need to be stored. A representation in pixel coordinates of the stitched image may be easily handled in the viewer. Physical coordinates may be handled, too, and may require inverting the transformation matrix referred to above. In various embodiments, a JSON or other similar manifest file may list the set of files to be loaded by the visualization tool and/or the viewer.

In various embodiments, an analysis results file may contain a serialized version of a specific analysis for display in the visualization tool application, usually overlaying the hierarchical image, such as an image pyramid. For example, the analysis results file may be a

Zarr v2 archive containing the following hierarchical structure. Within this file, the position and size information located within the physical and imaging groups may be in different coordinate systems. A transform matrix object in each group may give the appropriate transform to convert the properties in that group to the physical coordinate space.

In various embodiments, points may be divided into a grid of physical units. This may add an extra level in the hierarchy consisting of the grid keys. For example, the attribute path /physical/feature/id would turn into /physical/feature/0,1/id and /physical/feature/2,0/id. The same may apply to barcodes, e.g., /physical/feature/1,2/barcode/identity. Attributes for those paths may be replicated across grid cells. There may be attributes for each grid cell, consisting of, e.g., number_features: int.

In various embodiments, the visualization tool may render output from a point cloud pipeline. In particular, in various embodiments within the visualization tool, users can choose to display “detected” features, “inferred” features, both, or neither. Features of both types may be rendered with the same glyph, based on the barcode identity. In various embodiments, all inferred features may be contained in files like {name}_features.zarr, all detected features may be contained in files like {name}_features_detected.zarr, and {name} may use the pattern global_{cycle_name}. For example, if detected features are being displayed, and the current cycle is C, there may be two display options: Show all: Render all detected features with /physical/feature/detection[0]>=0; and/or Cycle specific: Only render the features that were detected in this cycle, /physical/feature/detection[0]>0. In various embodiments, to accommodate the localization pipeline and backwards compatibility: If /physical/feature/inferred is absent, none of the aforementioned selections may be applicable, and all features should be rendered all the time; and If /physical/feature/inferred[0]!=−1, the output may be from the anchor pipeline, and all features should be rendered all the time.

In various embodiments, feature density may be stored as a compressed sparse row (CSR) matrix, such as under the path/physical/feature/density. The CSR matrix may have three dimensions. The size of the dimensions may correspond to (number_features+1)*number_rows*number_columns. In various embodiments, the first two dimensions may be collapsed. In various embodiments, an “Unknown” feature may have an extra entry at the end of the features. In various embodiments, only features with a Q-score≥20 may be counted. In various embodiments, the grid may be be 10×10 μm\hat{ }2, but another grid size may be specified in the attributes.

### Dynamic Fetch of In-Situ Data Dependent on Viewport:

It may not be advisable due to memory and compute performance to load complete cellular or molecular information from an entire in situ dataset all at once, when an end-user is viewing the dataset at a zoomed-out low resolution, e.g., in a web browser. This data may include, without limitation, the X-Y-Z physical location of molecules, boundaries of cells, cluster memberships, cell-gene matrix value, and quantitative protein data. Thus, it is infeasible to load the full-resolution image data for a dataset (e.g., a dataset comprising a plurality of microscopy images) when zoomed out at full resolution.

Accordingly, provided herein are methods of context-aware loading of overlay molecular and cellular information, not just image data, at different zoom levels. For example, information that may be selectively stored at varying resolutions and fetched dynamically at high resolution includes cell boundary polygons, cell-gene matrix information, annotations, X-Y-Z feature locations, quantitative protein information, and other metadata. This information will be stored in a pyramidal format, in order to support organization and representation and encoding of data at different resolutions, and the browser/application client will fetch similar subsets of the data as images when higher-resolution data is displayed.

At rest, this overlay data may be stored on a cloud storage. For most or each type of molecular or cellular data, an individual file may be stored per region per level of resolution. These files form a “pyramid”, where at highest resolution, there will be N tiles spanning the entire dataset, and at lower resolution, there will be N/x tiles, each spanning a progressively larger area of the dataset at lower resolutions. At some resolutions, the data may not be available, or an aggregate, lower-resolution representation of the data may be stored. As a non-limiting example the centroid (X,Y) locations of cell boundaries may be stored at very low resolution instead of individual vertices of cell boundaries. This leads to a more efficient transfer of data of hundreds of thousands of cells at a time, as the size of the cell projection at low resolution may be smaller than a pixel.

In other embodiments, instead of storing the data in different files per different level of resolution, all the data for a particular property (such as cell boundaries or z-position) may be concatenated into a single file, with distinct sections of the file for each level of resolution. In such a scheme, there may also be an index and metadata for each file indicating the file offset of the nth entry in the dataset, such that a client may request a subset of the data in order to load the information relevant to the active field of view (FOV). This scheme may be more efficient for schemes where there is a high cost to storing and managing the metadata of potentially hundreds of thousands of pyramid tiles, or the data is of fairly low density.

### Dynamic Display of Cell Representations Dependent on Zoom Level:

It may not be advisable due to memory and compute performance to show complete cell boundaries of large datasets when viewing the entire section. In cases where there can be hundreds of thousands of cells in a capture area the collective number of vertices in the shapes representing visible cell or nuclear boundaries may exceed the millions when an end-user zooms out to see the entire dataset, when the actual representation of a cell at that level may be single pixels or even subpixels. It may still be useful to indicate the location of individual cells, and be able to visualize information about those cells in a whole-tissue context, including cluster membership, gene count per cell, etc.

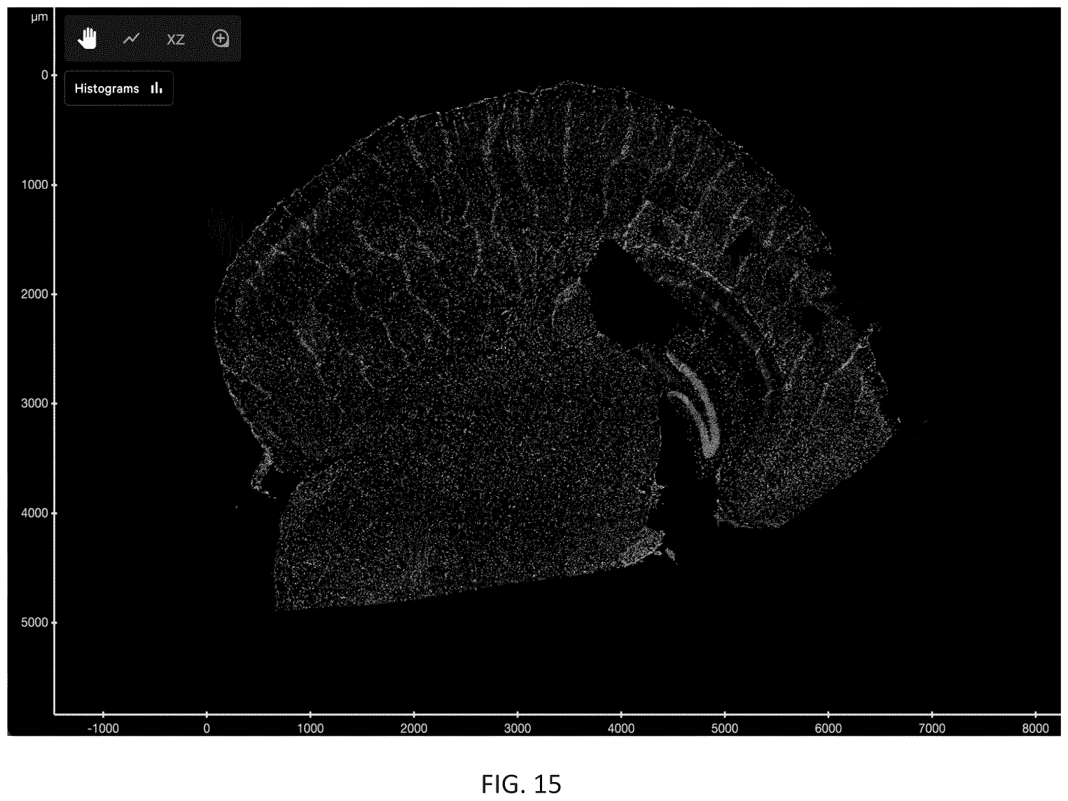

To correctly balance performance with data, in various embodiments, the representation of cells is dependent on zoom context. When zoomed out past a certain level, the centroids (or corners) of cells may be represented as single points, circles, or other icons. When an end-user zooms in to see regions of a tissue (e.g., a micrograph of a biological sample) at higher resolution, cell segmentation boundaries become visible. Both the lower-resolution representations and higher-resolution representations of cells may be colored by cluster membership, per-cell gene count, or per-cell protein quantitative information. To aid in the visualization when zoomed out, these single points may be highlighted, change in size, or be represented by different icons. Said zoomed-out representations may apply to both nuclear and cytoplasmic cell boundaries. As shown in FIG. 15, nuclear locations are represented as spots in a zoomed-out image showing a full tissue slice.

In various embodiments, a visualization includes cell segmentation boundaries and/or nuclear segmentation boundaries. Various systems and methods to determine cell membrane boundaries and nuclear boundaries are described in U.S. patents application Ser. Nos. 18/807,093, 63/625,132, 63/566,088, and 63/570,399, each of which is incorporated by reference herein in its entirety. In various embodiments, cell segmentation boundaries and/or nuclear segmentation boundaries are represented via a plurality of polygons. In various embodiments, cell segmentation polygons are rendered using a maximum #of vertices regardless of zoom level. However, this level of detail may become less useful when zooming out and either one polygon cannot be distinguished from the next and/or its overall shape cannot be determined. In some embodiments, cell segmentation polygons are rendered with a reduced vertex count that is associated with the zoom level, e.g., zoom level 0 (fully zoomed in) uses all of the vertices, and the number of vertices used is reduced with each level zoomed out. By way of example and without limitation, at starting zoom level 0, a cell segmentation polygon having 32 vertices (verts) are rendered at zoom level 0 (the original image) and the number of polygons is reduced to 24 verts at zoom level x (i.e. remove 1 out of every 4 verts); 16 verts at zoom level y (i.e., remove 1 out of every 2 verts); 8 verts at zoom level z (i.e., remove 3 out of every 4 verts or keep 1 out of every 4 verts).

### Dynamic Display of Molecular Information Dependent on Zoom Level:

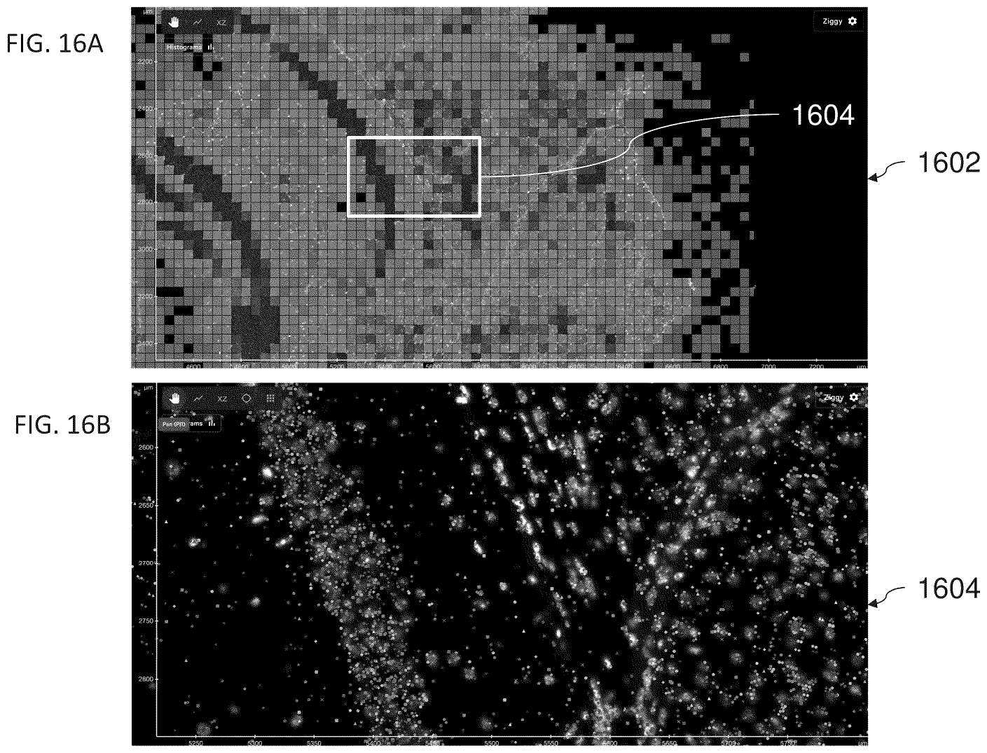

In various embodiments, showing (e.g., rendering) the location information of all detected molecules may be difficult when viewing an entire section, or even a large-enough subsection of a tissue sample. For a full dataset, there may be tens of millions to hundreds of millions of individual target molecules detected. In various embodiments, the number of detected target molecules exceeds the number of pixels visible in an end user's viewport, and/or overburdens a computer processor and/or GPU. Thus, as contemplated herein, when zoomed out to visualize subsections of a tissue sample (e.g., an entire tissue sample), the visualization switches from rendering spots or icons at the location of individual molecules, to alternate representations of feature density, which are disclosed herein. FIG. 16A shows one method to visually represent transcript data at lower zoom levels. In particular, the visualization 1602 in FIG. 16A shows a plot of density of feature data per spatial bin, independent of cell boundaries (e.g., some bins may extend outside of cell boundaries and include regions that are empty). In various embodiments, the plot of density features is overlaid on top of spatial data showing spots representing target molecules detected. In various embodiments, the spatial bin has fixed dimensions in a visualization plane. In various embodiments, the spatial bin extends through the entire imaging volume. For example, each spatial bin may be visually represented as square that extends in the z-direction through the entire imaging volume (i.e., the spatial bin is a cube) such that all target molecules detected in the volume defined by the cube are assigned to that spatial bin. In various embodiments, each spatial bin is color coded. For example, in FIG. 16A, redder regions indicate areas where high numbers of target molecules were detected while light yellow regions indicate areas where low numbers of target molecules were detected. FIG. 16B shows a zoomed in portion 1604 of the visualization 1602 shown in FIG. 16A. In various embodiments, when zooming into portion 1604 of visualization 1602, the plot of density of feature data is removed to allow for clear visualization of higher resolution feature data (e.g., target molecules) For example, the area of portion 1604 represents about 5× resolution of the upper panel showing visualization 1602 (e.g., 300×600 μm vs 1500×3000 μm), and the density plot that aggregates marker density per spatial bin has been removed so that individual markers of target molecules can be visualized, with each icon and/or color combination representing a distinct gene. The zoomed-out visualization may depend on queries against higher-level tiles of the pyramid as described in the dynamic fetch claim, or compute aggregate representations of the data by processing the complete corpus of data on the client side. In some embodiments, the client makes the determination of which representation to show the user based on the active zoom level. In some embodiments, it can also make that determination dynamically based on the total number of features in the dataset (which may enable showing more detailed information at lower levels of zoom if data is sparse), or some other heuristic.

### Dynamic, Binned Visualization of Spatial RNA Density:

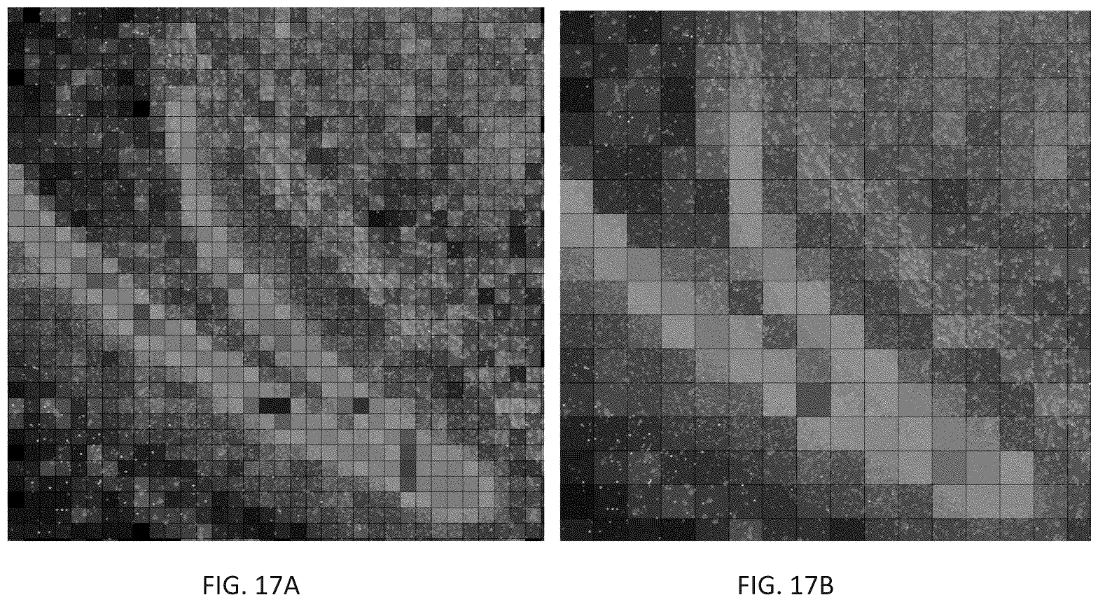

In various embodiments, a visualization shows RNA transcript counts by spatial aggregation (bins) to allow users to view spatial patterns of gene expression without loading a potentially large amount of data. Disclosed herein is an example of changing bin sizes dynamically in response to user feedback, with the detected molecule locations shown underneath. As shown in FIG. 17A, a first plot of RNA count per spatial bin is overlaid on top of detected molecule locations. In particular, FIG. 17A illustrates a first plurality of spatial bins having a first size. FIG. 17B illustrates the same image of detected molecules with a second plot of RNA count per spatial bin overlaid on top of the detected molecules. In particular, FIG. 17B illustrates a second plurality of spatial bins having a second size that is larger than the first size (i.e., the second plurality of spatial bins has a lower resolution than the first plurality of spatial bins). In various embodiments, the spatial bin is a square shape. In various embodiments, the size of each spatial bin can be about 0.1 μm to about 20 μm. In various embodiments, the spatial bin extends through the entire imaging volume to thereby define a three-dimensional subvolume into which any detected molecules within that three-dimensional subvolume are binned. In various embodiments, these spatial bins are dynamically sized on demand. In various embodiments, the spatial bins have dynamic color and opacity (e.g., based on user settings). In various embodiments, the color scale is dynamic depending on the distribution of counts per spatial bin across all spatial bins. In some embodiments, a client can either precompute the number of counts per spatial bin by loading the entire dataset into memory, or the per-bin counts can be processed on the server and transmitted to the client.

### Dynamic, Binned Visualization of Spatial Protein Density:

In a manner similar to the binning of RNA data above, it is possible to calculate and visualize normalized protein stain intensity per bin. e.g., the image may be divided into multiple bins, and a per-bin statistic would be either computed dynamically on the client, or drawn from a server. In some embodiments, a bin overlay atop an underlying morphological or protein stain may allow the end user to compare and contrast protein expression at a high level with other stains or data. Such data visualization may be useful in heavily multiplexed protein panels, where showing multiple high-resolution image stains concurrently in different colors at high resolution would quickly overwhelm the user. A binned average of multiple related proteins or protein families may quickly identify functional regions of interest. In some embodiments, similar statistics may be computed and visualized for individual cell boundaries to provide additional precision.

Visualization of Protein Quantitation within Cell Segmentation Boundaries:

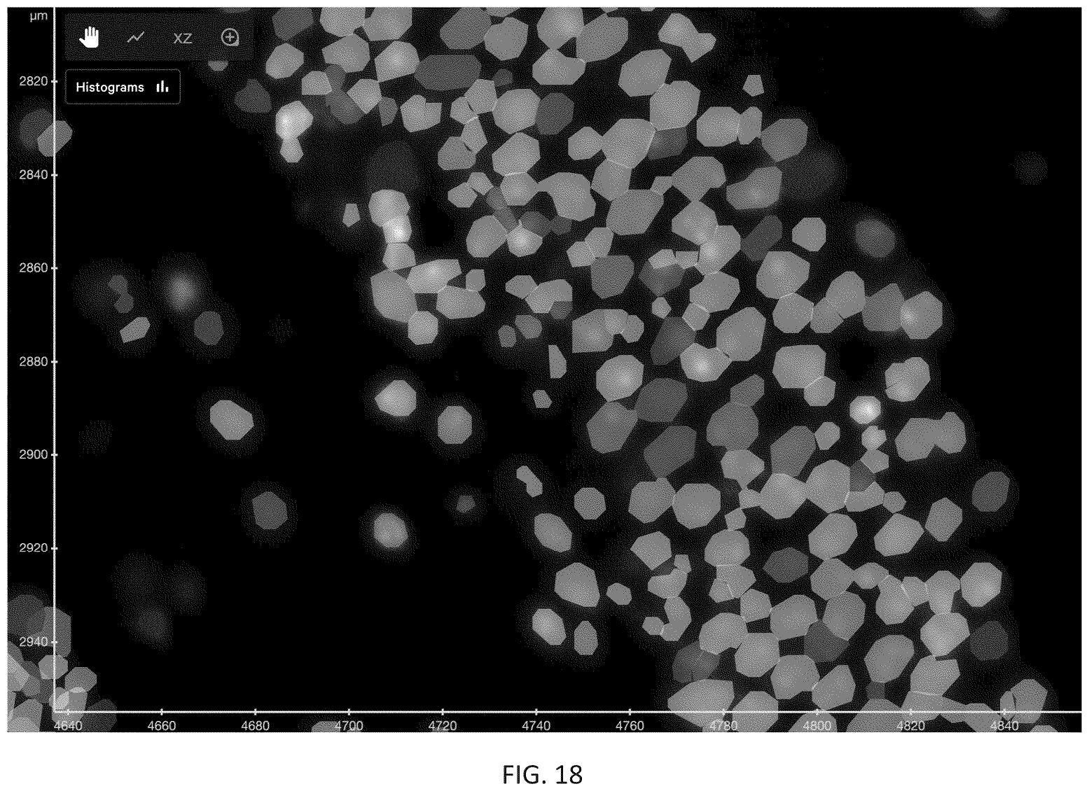

In some embodiments, rather than regularly shaped bins as the quanta by which aggregate counts or other statistics are displayed, quantitative protein information on a per-cell basis may be displayed using the computed boundaries of each cell or nucleus as the bounds for each quanta. Without being bound by theory or methodology, a statistic may be computed within the bounds of each cell, such as the normalized underlying pixel intensity of a particular protein stain, e.g., a cell surface marker. The relative statistic per cell is displayed as distinctly colored polygons. In some embodiments, as shown in FIG. 18, each polygon is displayed on top of the detected bounds of a cell (e.g., bounds of a cell may be detected using a cell membrane segmentation algorithm, as described herein). The disclosed visualization may be similarly applied to other data and statistics pertaining to each cell in the visualization, including but not limited to, RNA expression, detected clonotypes, ATAC (assay for transposase-accessible chromatin) fragments per cell, and other markers.

Exemplary embodiments also include the combination of overlaying the cell-specific quantitative protein statistics on top of a morphology stain, or other qualitative protein stain. Similar to binning disclosed herein, this may allow rapid investigation of multiplexed quantitative protein data on top of more qualitative stains.

### Interactive Gating, Selection and Highlighting of Cell Boundaries by Arbitrary Criteria:

Contemplated herein are a variety of selection tools to highlight and show cells within their morphological context in a dataset by arbitrary criteria. For example and without limitation, Loupe Browser (10× Genomics; CA, USA) allows selection of arbitrary cells or tissue spots either by selecting in a 2-dimensional (2D) feature plot (where one axis is the expression of one analyte, and the other axis is expression of another analyte), or by boolean filtering rules, which can be arbitrarily complex. Thus, in some embodiments of the invention, the selections in a 2D gating feature space or generated by complex boolean logic is highlighted in morphological context. The outlines of cells that meet these criteria may be highlighted, such that the end user may still see additional information about each cell, such as its membership in a cluster, or the total number of molecules detected or relative protein stain intensity within the highlighted cell(s). Said search criteria or sub-selections may be saved, such that they may be reused within an individual dataset, or even exported and imported into another dataset. Such gates and boolean logic could then be used, for example, to facilitate cell type identification, to allow for rapid identification of regions of interest by analyte/function within morphological context.

### Specialized Methods for 2.5D Projection of Features and Cells:

In the execution of the contemplated in situ assays (e.g., by instrumentation disclosed herein), multiple images will be taken of the biological sample (e.g., a tissue section), at differing depths and focal lengths (slices) of several microns. The detected centroids of molecular features or individual cells could span the depth of the measured slices (e.g., Z-slices). In some embodiments, data is visualized on 2D screens (e.g., a LED display), thus, some visualization is necessary to indicate whether or not cells and features are centered on the active 2D focal plane.

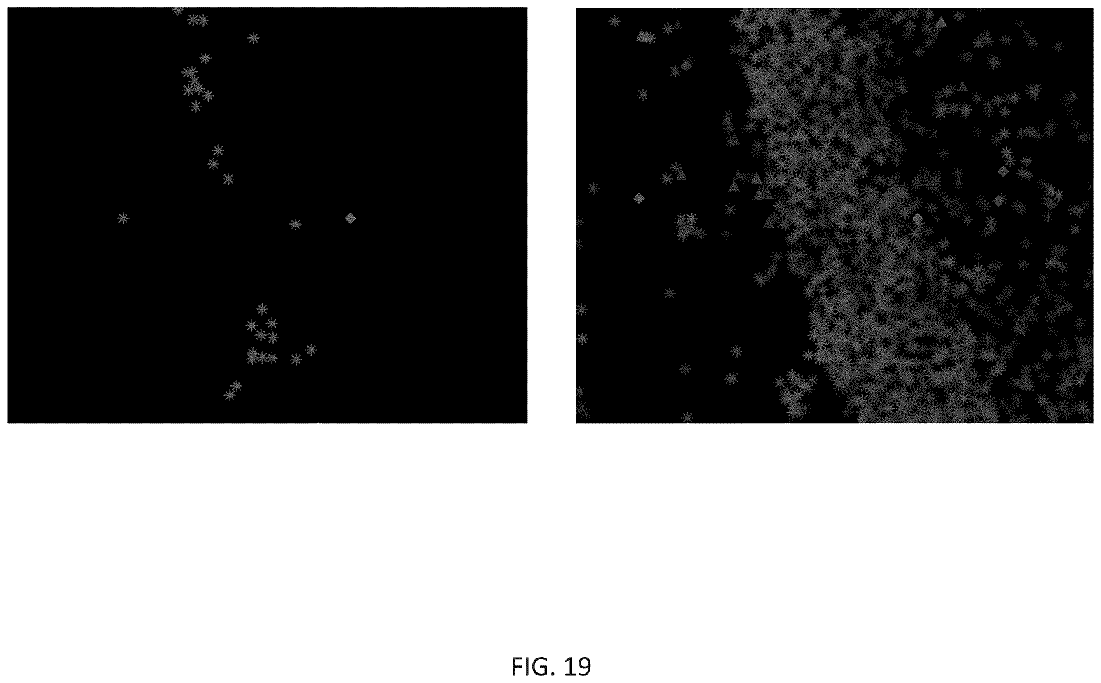

In some embodiments, the opacity of a feature or cell is modified depending on the focal plane distance from the active plane to the focal plane of the cell center or detected molecule. As depicted in FIG. 19 (left panel), the locations of detected molecules are visible on the current focal plane, with molecules on other focal planes not visible. As shown in FIG. 19 (right panel), molecules centered at other depths can be made visible, though with decreasing opacity depending on the distance between that molecule's center and the current focal plane. Similar visualization could be used to display dynamic maximum intensity projections, or a more revealing volumetric projection of protein stains.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
loading a point cloud, each point within the point cloud representing a feature of a biological sample at its corresponding location;
determining at least one tile having a two-dimensional area and a zoom level;
selecting from the point cloud those points having a location within the two-dimensional area;
based on the selected points and the zoom level, determining a set of display points, each point of the set of display points representing a feature of the biological sample at its corresponding location;
providing the set of display points for display at the zoom level.

2. The method of claim 1, wherein determining the set of display points comprises randomly subsampling the selected points based on the zoom level.

3. The method of claim 2, wherein the randomly subsampling the selected points comprises removing approximately half of the selected points.

4. The method of claim 2, wherein the randomly subsampling the selected points comprises removing a portion of the selected points proportionate to the zoom level.

5. The method of claim 1, wherein determining the set of display points comprises:
clustering the selected points based on the zoom level, yielding a plurality of clusters; and
defining a display point for each of the plurality of clusters.

6. The method of claim 5, wherein clustering the selected points comprises performing DBSCAN clustering, OPTICS clustering, or K-Means clustering.

7. The method of claim 5, wherein defining each point comprises determining a summary statistic for the corresponding cluster.

8. The method of claim 7, wherein the summary statistic comprises a count of the points within the corresponding cluster.

9. The method of claim 8, wherein each display point has a visual attribute corresponding to the summary statistic.

10. The method of claim 9, wherein the visual attribute is a size or color.

11. The method of claim 1, further comprising displaying the set of display points on a display.

12. The method of claim 11, wherein displaying the set of display points comprises superimposing the set of display points on an image of the biological sample.

13. The method of claim 12, wherein superimposing comprises registering the set of display points to the image of the biological sample.

14. The method of claim 1, wherein the set of display points is determined at a server side in response to a request from a remote client, and wherein providing the set of display points for display comprises sending the display points from the server to the remote client.

15. The method of claim 1, wherein the at least one tile comprises a plurality of tiles together defining a display port on a GUI.

16. The method of claim 1, further comprising:
receiving an adjusted zoom level;
based on the adjusted zoom level, determining at least one additional tile having an adjusted two-dimensional area at the adjusted zoom level;
selecting from the point cloud those points having a location within the adjusted two-dimensional area;
based on the selected points having a location within the adjusted two-dimensional area and the adjusted zoom level, determining an adjusted set of display points, each point of the adjusted set of display points representing a feature of the biological sample at its corresponding location;
providing the adjusted set of display points for display at the adjusted zoom level.

17. A system comprising:
a computing node comprising at least one computer-readable storage medium having program instructions stored thereon, the program instructions executable by at least one processor of the computing node to cause the at least one processor to perform a method comprising:
loading a point cloud, each point within the point cloud representing a feature of a biological sample at its corresponding location;
determining at least one tile having a two-dimensional area and a zoom level;
selecting from the point cloud those points having a location within the two-dimensional area;
based on the selected points and the zoom level, determining a set of display points, each point of the set of display points representing a feature of the biological sample at its corresponding location;
displaying, on a display, the set of display points at the zoom level.

18-32. (canceled)

33. A computer program product comprising a computer readable storage medium having program instructions embodied therewith, the program instructions executable by a processor to cause the processor to perform a method comprising:
loading a point cloud, each point within the point cloud representing a feature of a biological sample at its corresponding location;
determining at least one tile having a two-dimensional area and a zoom level;
selecting from the point cloud those points having a location within the two-dimensional area;
based on the selected points and the zoom level, determining a set of display points, each point of the set of display points representing a feature of the biological sample at its corresponding location;
displaying, on a display, the set of display points at the zoom level.

34-45. (canceled)

46. The computer program product of claim 33, wherein the set of display points is determined at a server side in response to a request from a remote client, and wherein providing the set of display points for display comprises sending the display points from the server to the remote client.

47. (canceled)

48. The computer program product of claim 33, further comprising:
receiving an adjusted zoom level;
based on the adjusted zoom level, determining at least one additional tile having an adjusted two-dimensional area at the adjusted zoom level;
selecting from the point cloud those points having a location within the adjusted two-dimensional area;
based on the selected points having a location within the adjusted two-dimensional area and the adjusted zoom level, determining an adjusted set of display points, each point of the adjusted set of display points representing a feature of the biological sample at its corresponding location;
providing the adjusted set of display points for display at the adjusted zoom level.
